(19) United States
(12) Patent Application Publication
(10) Pub. No.: US 2007/0194882 A1
(43) Pub. Date: Aug. 23, 2007

(54) Authentication system and authentication apparatus

(75) Inventors: Kaoru Yokota, Hyogo (JP); Natsume Matsuzaki, Osaka (JP); Masao Nonaka, Osaka (JP); Mitsuhiro Inoue, Osaka (JP); Akio Higashi, Osaka (JP); Tohru Nakahara, Osaka (JP)

Correspondence Address: WENDEROTH, LIND & PONACK L.L.P., 2033 K. STREET, NW, SUITE 800, WASHINGTON, DC, 20006, US

(73) Assignee: KONINKLIJKE PHILIPS ELECTONICS N.V., EINDHOVEN NETHERLAND (NL)

(21) Appl. No.: 10/590,898

(22) PCT Filed: Mar. 9, 2005
(86) PCT No.: PCT/JP05/04581

§ 371 Date: Aug. 28, 2006

(30) Foreign Application Priority Data
Mar. 10, 2004 (JP) 2004-067846

(51) Int. Cl. G06F 1/00; G05B 19/00

(52) U.S. Cl. 340/5.61; 340/10.1; 713/186; 340/5.52

(57) ABSTRACT

An authentication system that permits the user to use a function by authenticating the user in a more reliable manner than conventional technologies. The authentication system 1 includes a user terminal 10, an authentication recording medium 20, and wireless ID tags 31, 32, 33, 34, 35, . . . 36. Upon receiving from a user an instruction to activate a function provided by the authentication system for which the access by the user is limited, the user terminal 10 collects ID codes from the wireless ID tags 31, 32, 33, 34, 35, . . . 36, and judge whether or not a level of match between the collected ID codes and the ID codes stored beforehand in the authentication recording medium 20 satisfies a predetermined condition. If the level of match satisfies the predetermined condition, the user terminal 10 activates the designated function.

### TECHNICAL FIELD

The present invention relates to a technology for authenticating users of a terminal apparatus.

### BACKGROUND ART

Mobile devices such as mobile phones, when they are in use, store information concerning privacy of the user such as telephone numbers, e-mail addresses, dial record, and schedule. For this reason, such mobile devices are provided with a function for authenticating the users to prevent such private information from being accessed by strangers.

For example, Document 1, which is identified below, discloses a personal authentication system that uses two ID tags. In this personal authentication system, the identification apparatus reads ID (identification) codes respectively from the two ID tags, judges whether or not the read two ID codes have been registered with a database, which is embedded in the identification apparatus, in correspondence with the user, and if it judges that the read two ID codes have been registered with the database, recognizes that the user is the authenticate user.

[Document 1]

Japanese Laid-Open Patent Application No. 2002-123803

However, the above-mentioned personal authentication system does not recognize the user as the authenticate user unless it judges that the two ID codes read from the ID tags completely match two ID codes having been registered with the database. This forces the user to always carry the two ID tags. This is because, for example, if the user leaves one of the two ID tags at home, the user cannot be recognized as the authenticate user when the user is away from home. Also, since the transmission and reception of information between the identification apparatus and each ID tag are performed through radio communications, even if the user has the two ID tags, transmission of an ID code from an ID tag to the identification apparatus may fail due to a large distance between them or an interference from other ID tags, which prevents the user from being recognized as the authenticate user.

### DISCLOSURE OF THE INVENTION

It is therefore an object of the present invention to provide an authentication system, authentication apparatus, authentication method, authentication program, and program recording medium that permit the user to use a function by authenticating the user in a more reliable manner than conventional technologies.

The above object is fulfilled by an authentication system including a plurality of wireless IC tags and an authentication apparatus which permits a user to use a function provided by the authentication apparatus if authenticity of the user is certified by authentication, the authentication apparatus comprising: a tag verification information storage unit operable to store a plurality of pieces of tag verification information for identifying the plurality of wireless IC tags respectively; a receiving unit operable to wirelessly receive, from wireless IC tags attached to objects carried by the user, a plurality of pieces of tag certification information for identifying the wireless IC tags attached to the objects respectively; a tag judgment unit operable to judge whether or not a level of match between the plurality of pieces of tag verification information and the plurality of pieces of tag certification information satisfies a predetermined condition; and a permission unit operable to permit a use of the function if the tag judgment unit judges that the level of match satisfies the predetermined condition, and each of the plurality of wireless IC tags comprising: a tag certification information storage unit operable to store a piece of tag certification information for identifying a wireless IC tag storing the piece of tag certification information; and an output unit operable to output wirelessly the piece of tag certification information.

With the above-stated construction of the authentication system in which the tag judgment unit judges whether or not a level of match between the plurality of pieces of tag verification information and the plurality of pieces of tag certification information satisfies a predetermined condition, the authentication apparatus permits the user to use the function if the tag judgment unit judges that the level of match satisfies the predetermined condition. That is to say, even if all the stored pieces of tag verification information do not match any of the received pieces of tag certification information, the user is permitted to use the function if the predetermined condition is satisfied. This enables the authenticate user to use the function provided in the authentication apparatus in a more reliable manner than in conventional systems.

The above object is also fulfilled by an authentication apparatus which permits a user to use a function provided by the authentication apparatus if authenticity of the user is certified by authentication, the authentication apparatus comprising: a tag verification information storage unit operable to store a plurality of pieces of tag verification information for identifying a plurality of wireless IC tags respectively; a receiving unit operable to wirelessly receive, from wireless IC tags attached to objects carried by the user, a plurality of pieces of tag certification information for identifying the wireless IC tags attached to the objects respectively; a tag judgment unit operable to judge whether or not a level of match between the plurality of pieces of tag verification information and the plurality of pieces of tag certification information satisfies a predetermined condition; and a permission unit operable to permit a use of the function if the tag judgment unit judges that the level of match satisfies the predetermined condition.

With the above-stated construction in which the tag judgment unit of the authentication apparatus judges whether or not a level of match between the plurality of pieces of tag verification information and the plurality of pieces of tag certification information satisfies a predetermined condition, the authentication apparatus permits the user to use the function if the tag judgment unit judges that the level of match satisfies the predetermined condition. That is to say, even if all the stored pieces of tag verification information do not match any of the received pieces of tag certification information, the user is permitted to use the function if the predetermined condition is satisfied. This enables the authenticate user to use the function provided in the authentication apparatus in a more reliable manner than in conventional systems.

The above-described authentication apparatus may further comprise: an identification information storage unit operable to store first identification information; and a user judgment unit operable to, if the tag judgment unit judges that the level of match does not satisfy the predetermined condition, receive second identification information and judges whether or not the first identification information matches the received second identification information, wherein the permission unit permits the use of the function if the tag judgment unit judges that the level of match does not satisfy the predetermined condition, and if the user judgment unit judges that the first identification information matches the received second identification information.

With the above-stated construction of the authentication apparatus, if the tag judgment unit provides a negative judgment result, the user judgment unit judges whether or not the first identification information matches the second identification information, and the permission unit permits the use of the function if either the tag judgment unit judges that the level of match satisfies the predetermined condition, or the user judgment unit judges that the first identification information matches the second identification information. With this construction, if the tag judgment unit provides a negative judgment result in relation to an authenticate user, the user judgment unit provides an affirmative judgment result in relation to the authenticate user, and the authenticate user is permitted to use the function provided in the authentication apparatus. That is to say, an authentication system having the authentication apparatus permits authenticate users to use functions provided in the authentication apparatus in a more reliable manner than conventional systems.

In the above-described authentication apparatus, the first identification information may be either (i) first character information being a combination of one or more numerals and/or one or more alphabets and/or one or more signs or (ii) first biological information indicating biological characteristics of the user, the second identification information is either (i) second character information being a combination of one or more numerals and/or one or more alphabets and/or one or more signs or (ii) second biological information indicating biological characteristics of the user, if the user judgment unit receives the second character information, the user judgment unit judges whether or not the first character information matches the received second character information, and if the user judgment unit receives the second biological information, the user judgment unit judges whether or not the first biological information and the received second biological information correspond to a same user.

With the above-stated construction, the first identification information is either the first character information or the first biological information, and the second identification information is either the second character information or the second biological information. For example, the password authentication can be performed to judge whether or not the first character information matches the second character information, and the fingerprint authentication can be performed to judge whether or not the first biological information and the second biological information correspond to a same user.

In the above-described authentication apparatus, the plurality of pieces of tag verification information may be a plurality of verification ID codes for identifying the plurality of wireless IC tags respectively, the plurality of pieces of tag certification information are a plurality of certification ID codes for identifying the wireless IC tags attached to the objects respectively, and the authentication apparatus may further comprise an update unit operable to, if a predetermined condition for update is satisfied, acquire at least two certification ID codes out of the plurality of certification ID codes received by the receiving unit, and update contents of the tag verification information storage unit by storing the at least two acquired certification ID codes into the tag verification information storage unit as verification ID codes.

With the above-stated construction, if the predetermined condition for update is satisfied, the update unit of the authentication apparatus acquire at least two certification ID codes out of the plurality of received certification ID codes, and updates contents of the tag verification information storage unit by storing the at least two acquired certification ID codes into the tag verification information storage unit as verification ID codes. This enables the user to change the certification ID codes in accordance with the plurality of objects the user has, if the predetermined condition for update is satisfied.

The above-described authentication apparatus may further comprise: an identification information storage unit operable to store first identification information; and a user judgment unit operable to receive second identification information and judge whether or not the first identification information matches the received second identification information, wherein the predetermined condition for update is that the first identification information matches the second identification information, and the update unit updates the contents of the tag verification information storage unit if the first identification information matches the second identification information.

With the above-stated construction, if the user judgment unit judges that the first identification information matches the second identification information, the update unit of the authentication apparatus updates contents of the tag verification information storage unit by storing the at least two acquired certification ID codes into the tag verification information storage unit as verification ID codes.

The above-described authentication apparatus may further comprise: a distance calculating unit operable to calculate a distance between the authentication apparatus and each of the wireless IC tags from which the plurality of certification ID codes have been received, wherein the update unit acquires at least two certification ID codes for which values of the calculated distance are each equal to or lower than a predetermined value, from the plurality of received certification ID codes.

With the above-stated construction, the update unit acquires at least two certification ID codes from the locations within a predetermined distance. This enables the authentication apparatus to acquire at least two certification ID codes from the locations within a predetermined distance, which ensures a safe acquisition of the certification ID codes, and store the acquired certification ID codes as verification ID codes.

In the above-described authentication apparatus, each of the plurality of certification ID codes contains a type code indicating a type of an object to which a wireless ID tag identified by the certification ID code is attached, wherein the update unit acquires at least two certification ID codes containing a predetermined type code, from the plurality of certification ID codes received by the receiving unit.

With the above-stated construction, the update unit acquires at least two certification ID codes containing a predetermined type code. This enables the certification ID codes containing the predetermined type code to be stored as verification ID codes.

The above-described authentication apparatus may further comprise: a priority level storage unit operable to store a plurality of priority levels with a plurality of type codes corresponding thereto, wherein the predetermined type code is correlated with priority levels that are equal to or higher than a priority-level threshold value, and the update unit acquires at least two certification ID codes that have priority levels that are equal to or higher than the priority-level threshold value, from the plurality of certification ID codes received by the receiving unit, and updates contents of the tag verification information storage unit by storing the at least two acquired certification ID codes into the tag verification information storage unit as verification ID codes by priority.

With the above-stated construction, the update unit acquires at least two certification ID codes containing type codes that have priority levels being equal to or higher than a predetermined priority level, from the plurality of received certification ID codes. This enables the certification ID codes containing type codes that have high priority levels to be stored as verification ID codes.

The above-described authentication apparatus may further comprise: a priority level update unit operable to receive a type code and a priority level, and update the priority level storage unit by replacing a priority level, which is stored in the priority level storage unit in correspondence with the received type code, with the received priority level.

With the above-stated construction, the authentication apparatus can change the priority levels stored therein.

The above-described authentication apparatus may further comprise: a point storage unit operable to store a plurality of point values with a plurality of type codes corresponding thereto, wherein the predetermined type codes are correlated with point values that are equal to or higher than a point-value threshold value, and the update unit acquires at least two certification ID codes that have point values that are equal to or higher than the point-value threshold value, from the plurality of certification ID codes received by the receiving unit, and updates contents of the tag verification information storage unit by storing the at least two acquired certification ID codes into the tag verification information storage unit as verification ID codes by priority.

With the above-stated construction, the update unit acquires at least two certification ID codes containing type codes that have point values being equal to or higher than a predetermined point value, from the plurality of received certification ID codes. This enables the certification ID codes containing type codes that have high point values to be stored as verification ID codes.

The above-described authentication apparatus may further comprise: a point update unit operable to receive a type code and a point value, and update the point storage unit by replacing a point value, which is stored in the point storage unit in correspondence with the received type code, with the received point value.

With the above-stated construction, the authentication apparatus can change the priority levels stored therein.

In the above-described authentication apparatus, the plurality of pieces of tag verification information may be a plurality of pieces of unique authentication data for verification assigned by the authentication apparatus, the plurality of pieces of tag certification information are a plurality of pieces of unique authentication data for certification assigned by the authentication apparatus, the receiving unit wirelessly receives, from the wireless IC tags attached to the objects, a plurality of ID codes for identifying the wireless IC tags attached to the objects respectively; the authentication apparatus further comprises: an update unit operable to, if a predetermined condition for update is satisfied, generate a different piece of authentication data for each ID code received by the receiving unit, acquire at least two pieces of authentication data from pieces of generated authentication data, and update contents of the tag verification information storage unit by storing the at least two pieces of acquired authentication data into the tag verification information storage unit as authentication data for verification; and a transmission unit operable to transmit, for each piece of authentication data for verification having been updated by the update unit, a piece of authentication data for verification as a piece of authentication data for certification, to a wireless IC tag having an ID code corresponding to the piece of authentication data for verification.

With the above-stated construction, if the predetermined condition for update is satisfied, the update unit of the authentication apparatus acquire at least two pieces of authentication data corresponding to certification ID codes out of the plurality of received certification ID codes, and updates contents of the tag verification information storage unit by storing the acquired at least two pieces of authentication data into the tag verification information storage unit as verification ID codes, and the transmission unit transmits, for each piece of updated authentication data for verification, a piece of authentication data for verification as a piece of authentication data for certification, to a wireless IC tag having an ID code corresponding to the piece of authentication data for verification. This enables the user to change the certification ID codes in accordance with the plurality of objects the user has if the predetermined condition for update is satisfied.

The above-described authentication apparatus may further comprise: an identification information storage unit operable to store first identification information; and a user judgment unit operable to receive second identification information and judge whether or not the first identification information matches the received second identification information, wherein the predetermined condition for update is that the first identification information matches the second identification information, and if the first identification information matches the second identification information, the update unit updates the contents of the tag verification information storage unit, and the transmission unit transmits, for each piece of authentication data for verification having been updated by the update unit, a piece of authentication data for verification as apiece of authentication data for certification, to a wireless ID tag having an ID code corresponding to the piece of authentication data for verification.

With the above-stated construction, if the user judgment unit judges that the first identification information matches the second identification information, the update unit of the authentication apparatus updates contents of the tag verification information storage unit by storing the acquired at least two pieces of authentication data into the tag verification information storage unit as verification ID codes, and the transmission unit transmits pieces of authentication data for certification to wireless IC tags having corresponding ID codes if the user judgment unit judges that the first identification information matches the second identification information.

The above-described authentication apparatus may further comprise: a distance calculating unit operable to calculate a distance between the authentication apparatus and each of the wireless IC tags from which the plurality of ID codes have been received, wherein the update unit acquires at least two pieces of authentication data corresponding to ID codes for which values of the calculated distance are each equal to or lower than a predetermined value, among the plurality of received ID codes.

With the above-stated construction, the update unit acquires, as authentication data for verification, at least two pieces of authentication data corresponding to ID codes received from the locations within a predetermined distance,

In the above-described authentication apparatus, each of the plurality of ID codes may contain a type code indicating a type of an object to which a wireless IC tag identified by the ID code is attached, wherein the update unit acquires at least two pieces of authentication data corresponding to ID codes that include a predetermined type code among the plurality of ID codes received by the receiving unit.

With the above-stated construction, the update unit acquires at least two pieces of authentication data corresponding to certification ID codes containing a predetermined type code. This enables the authentication data corresponding to certification ID codes containing the predetermined type code to be stored as authentication data for verification.

The above-described authentication apparatus, each of the plurality of pieces of tag certification information may contain a type code indicating a type of an object to which a wireless IC tag identified by the piece of tag certification information is attached, wherein the tag judgment unit judges whether or not a level of match between the plurality of pieces of tag verification information and one or more pieces of tag certification information, which remain after excluding, from the plurality of pieces of tag certification information received by the receiving unit, pieces of tag certification information that contain a predetermined type code, satisfies a predetermined condition.

With the above-stated construction, the authentication apparatus can judge whether or not the level of match between the plurality of pieces of tag verification information and one or more pieces of tag certification information, which remain after excluding, from the plurality of pieces of tag certification information received by the receiving unit, pieces of tag certification information that contain a predetermined type code, satisfies a predetermined condition.

In the above-described authentication apparatus, the tag verification information storage unit may further store expiration date/time information that indicates an expiration date/time of each piece of tag verification information, and the authentication apparatus further comprises a control unit operable to, if having judged that any expiration date/time of the plurality of pieces of tag verification information has not been reached, control the receiving unit to receive the plurality of pieces of tag certification information.

With the above-stated construction, the receiving unit can receive the plurality of pieces of tag certification information if any expiration date/time of the plurality of pieces of tag verification information has not been reached.

In the above-described authentication apparatus, the tag judgment unit may judge whether or not a ratio of (i) a number of pieces of tag verification information that, among the plurality of pieces of tag verification information, match any of the plurality of pieces of tag certification information to (ii) a total number of the plurality of pieces of tag verification information stored in the tag verification information storage unit is equal to or higher than a standard value.

With the above-stated construction, the tag judgment unit judges whether or not a ratio of matching pieces of tag verification information to the total pieces of tag verification information is equal to or higher than a standard value. With such a construction, even if all the stored pieces of tag verification information do not match any of the received pieces of tag certification information, the user is permitted to use the function if the ratio of matching pieces of tag verification information to the total pieces of tag verification information is equal to or higher than the standard value. This enables the authenticate user to use the function provided in the authentication apparatus in a more reliable manner than in conventional systems.

In the above-described authentication apparatus, the tag verification information storage unit may further store point values indicating weights assigned to the plurality of pieces of tag verification information, in correspondence with the plurality of pieces of tag verification information, and the tag judgment unit judges whether or not a ratio of (i) an acquired point value that is obtained by adding up point values corresponding to pieces of tag verification information that, among the plurality of pieces of tag verification information, match any of the plurality of pieces of tag certification information to (ii) a total point value that is obtained by adding up point values corresponding to the plurality of pieces of tag verification information stored in the tag verification information storage unit is equal to or higher than a standard value.

With the above-stated construction, the tag judgment unit judges whether or not a ratio of the acquired point value to the total point value is equal to or higher than a standard value. With such a construction, even if all the stored pieces of tag verification information do not match any of the received pieces of tag certification information, the user is permitted to use the function if the ratio of the acquired point value to the total point value is equal to or higher than the standard value. This enables the authenticate user to use the function provided in the authentication apparatus in a more reliable manner than in conventional systems.

In the above-described authentication apparatus, the tag verification information storage unit is a portable recording medium, and the portable recording medium is inserted in the authentication apparatus.

With the above-stated construction, a portable recording medium can be used as the tag verification information storage unit.

### BRIEF DESCRIPTION OF THE DRAWING

FIG. 1 shows an outline of the authentication system 1.

FIG. 2 is a block diagram showing the construction of the user terminal 10.

FIG. 3 is a block diagram showing the construction of the standard information storage unit 102.

FIG. 4 shows the data structure of the type code table T100 included in the type code storage unit 133.

FIG. 5 shows the data structure of the authentication standard code table T101 included in the authentication information storage unit 134.

FIG. 6 is a block diagram showing the construction of the tag reading unit 109.

FIG. 7 shows the sync signal transmission period and the ID code collection period.

FIG. 8 is a block diagram showing the construction of the authentication recording medium 20.

FIG. 9 shows the data structure of the ID tag information table T200 included in the ID tag information storage unit 202.

FIG. 10 shows the appearance of the wireless ID tag 30.

FIG. 11 is a block diagram showing the construction of the IC chip unit 301 of the wireless ID tag 30.

FIG. 12 shows one example of the power circuit included in the power unit 311.

FIG. 13 is a flowchart showing the outline of the operation of registering an ID code with the ID tag information storage unit 202 of the authentication recording medium 20 in the authentication system 1.

FIG. 14 is a flowchart showing the operation of the ID code registration process in the authentication system 1.

FIG. 15 is a flowchart showing the operation of the ID code collection process in the authentication system 1.

FIG. 16 is, continued from FIG. 15, a flowchart showing the operation of the ID code registration process in the authentication system 1.

FIG. 17 is a flowchart showing the operation of the ID code writing process in the authentication system 1.

FIG. 18 is a flowchart showing the operation of the individual registration process in the authentication system 1.

FIG. 19 is a flowchart showing the operation of the authentication method registration process in the authentication system 1.

FIG. 20 is a flowchart showing the operation of the authentication process in the authentication system 1.

FIG. 21 is a flowchart showing the operation of the ID tag authentication process in the authentication system 1.

FIG. 22 shows an outline of the authentication system 1A.

FIG. 23 is a block diagram showing the construction of the user terminal 10A.

FIG. 24 is a block diagram showing the construction of the standard information storage unit 102A.

FIG. 25 is a block diagram showing the construction of the tag reading unit 109A.

FIG. 26 is a block diagram showing the construction of the authentication recording medium 20A.

FIG. 27 shows the data structure of the ID tag information table T300 included in the ID tag information storage unit 202A.

FIG. 28 is a block diagram showing the construction of the IC chip unit 301A of the wireless ID tag 30A.

FIG. 29 is a flowchart showing the outline of the operation of registering authentication data with the ID tag information storage unit 202A of the authentication recording medium 20A in the authentication system 1A.

FIG. 30 is a flowchart showing the operation of the authentication data registration process in the authentication system 1A.

FIG. 31 is a flowchart showing the operation of the authentication data writing process in the authentication system 1A.

FIG. 32 is a flowchart showing the operation of the individual registration process in the authentication system 1A.

FIG. 33 is a flowchart showing the operation of the authentication data transmission process in the authentication system 1A.

FIG. 34 is a flowchart showing the operation of the authentication process in the authentication system 1A.

FIG. 35 is a flowchart showing the operation of the authentication data collection process in the authentication system 1A.

FIG. 36 is, continued from FIG. 35, a flowchart showing the operation of the authentication data collection process in the authentication system 1A.

FIG. 37 is a flowchart showing the operation of the ID tag authentication process in the authentication system 1.

FIG. 38 is a block diagram showing the construction of the ATM terminal 50B.

FIG. 39 is a flowchart showing the operation of the authentication process when the ATM terminal 50B is used.

### BEST MODE FOR CARRYING OUT THE INVENTION

### 1. Embodiment 1

1.1 Outline of Authentication System 1

The following describes an authentication system 1 in Embodiment 1 of the present invention.

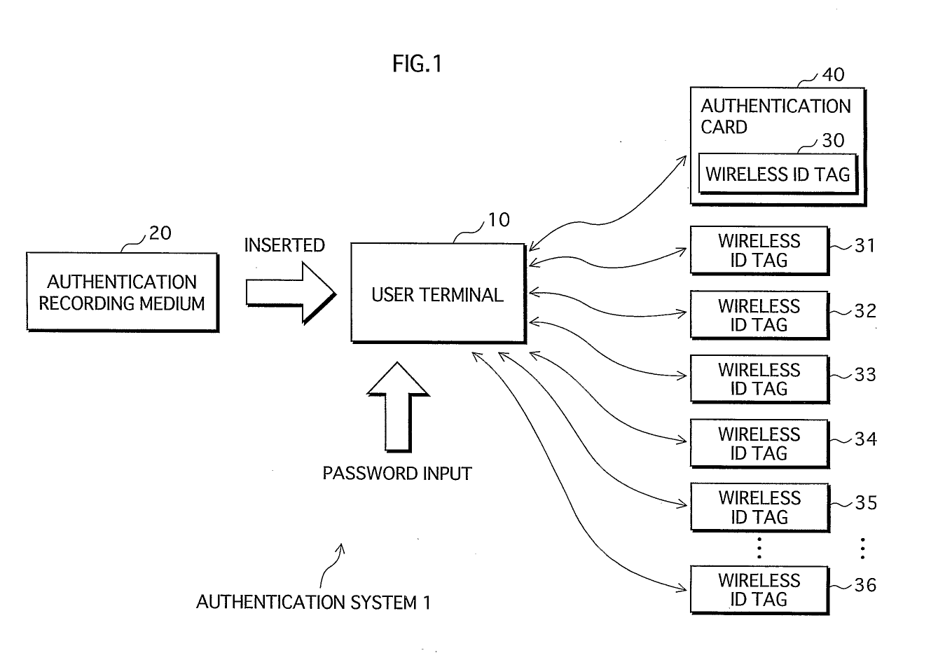

The authentication system 1 includes, as shown in FIG. 1, a user terminal 10, an authentication recording medium 20, wireless ID tags 31, 32, 33, 34, 35, . . . 36, and an authentication card 40. The wireless ID tags 31, 32, 33, 34, 35, . . . 36 are embedded in clothes, accessories, paper moneys or the like users wear or carry. The wireless ID tag 30 is embedded in the authentication card 40. The authentication recording medium 20 is inserted into the user terminal 10 for use.

In the authentication system 1, when a user requests to use a function of the user terminal 10 for which the access by the user is limited, the user terminal 10 reads ID codes for identifying wireless ID tags from the wireless ID tag 30 embedded in the authentication card 40 carried by the user and from the wireless ID tags 31, 32, 33, 34, 35, . . . 36 embedded in objects (clothes, accessories, paper moneys or the like) worn or carried by the user, performs an authentication using the read ID codes and ID codes that have been registered with the authentication recording medium 20 beforehand, and if the authenticity of the user is certified by the authentication, the function, for which the access by the user is limited, is activated. If the authenticity of the user is not certified by the authentication, the user terminal 10 performs an authentication using a password, and if the authenticity of the user is certified by the authentication, the function is activated.

It should be noted here that the ID code is composed of, for example, eight numerals. Of these eight numerals, the first three numerals form a type code for identifying the type of product, and the remaining five numerals form a product code, where each type of product has a set of different product codes.

1.2 User Terminal 10

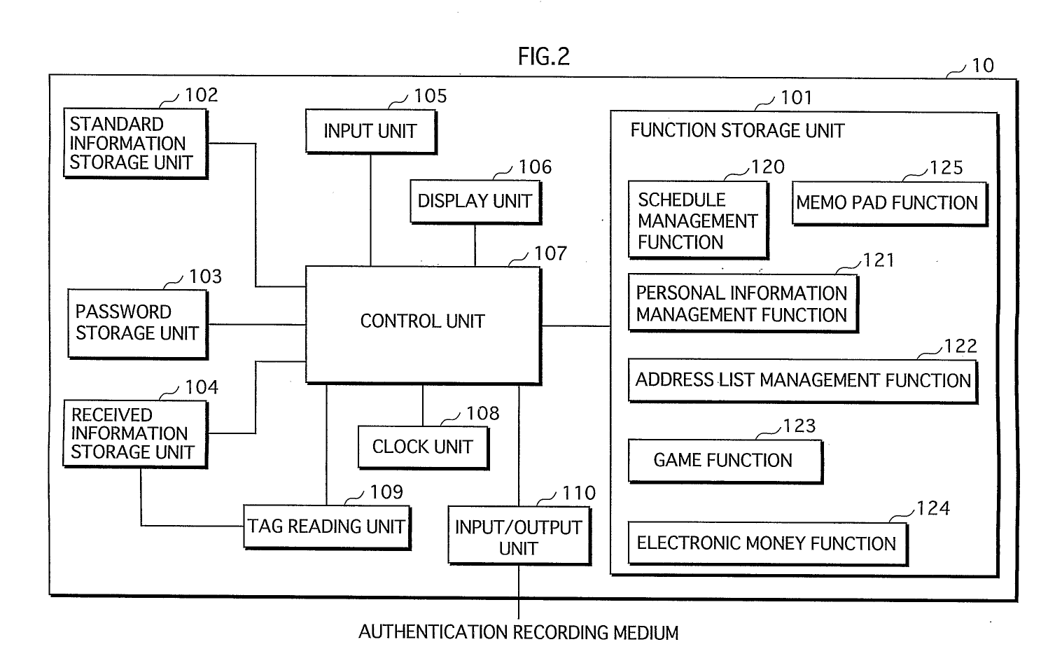

The construction of the user terminal 10 will be described. The user terminal 10, as shown in FIG. 2, includes a function storage unit 101, a standard information storage unit 102, a password storage unit 103, a received information storage unit 104, an input unit 105, a display unit 106, a control unit 107, a clock unit 108, a tag reading unit 109, and an input/output unit 110.

The user terminal 10 is more specifically a computer system including a microprocessor, a ROM, a RAM, a hard disk unit, a display unit and the like. A computer program is recorded in the ROM or the hard disk unit. The user terminal 10 achieves its functions as the microprocessor operates in accordance with the computer program.

The user terminal 10 is, for example, a PDA (Personal Digital Assistant).

(1) Function Storage Unit 101

The function storage unit 101, as shown in FIG. 2, includes a schedule management function 120, a personal information management function 121, an address list management function 122, a game function 123, an electronic money function 124, and a memo pad function 125.

The schedule management function 120 is a function for registering and managing schedules of users. The personal information management function 121 is a function for registering and managing information of users. The address list management function 122 is a function for registering and managing information of addresses, phone numbers and the like in relation to users. The game function 123 is a function for playing games. The electronic money function 124 is a function for doing shopping using electronic money that represents money values by digital data. The memo pad function 125 is, for example, a word-processing function for creating and managing texts or the like.

(2) Standard Information Storage Unit 102

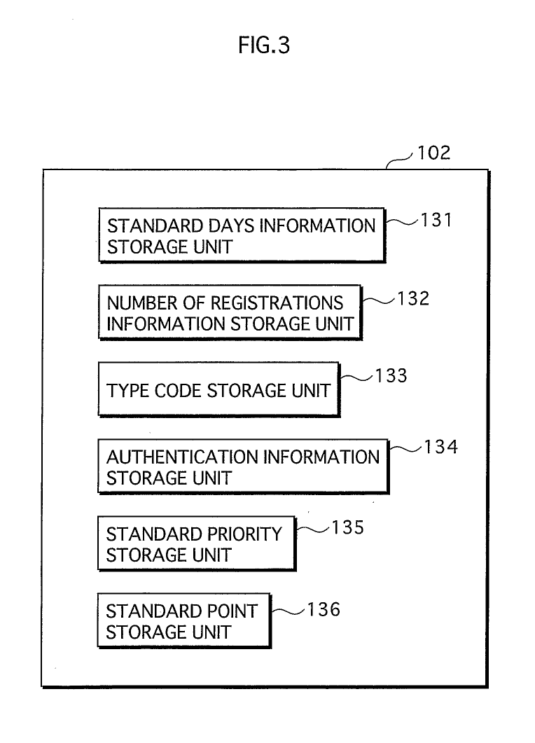

The standard information storage unit 102, as shown in FIG. 3, includes a standard days information storage unit 131, a number of registrations information storage unit 132, a type code storage unit 133, an authentication information storage unit 134, a standard priority storage unit 135, and a standard point storage unit 136.

(A) Standard Days Information Storage Unit 131

The standard days information storage unit 131 stores the number of days (for example, “3” for three days) that is used as a standard when an expiration date/time of an ID code, which is registered with the authentication recording medium 20, is calculated.

(B) Number of Registrations Information Storage Unit 132

The number of registrations information storage unit 132 stores the upper limit (for example, “5”) of an ID code that is registered with the authentication recording medium 20.

(C) Type Code Storage Unit 133

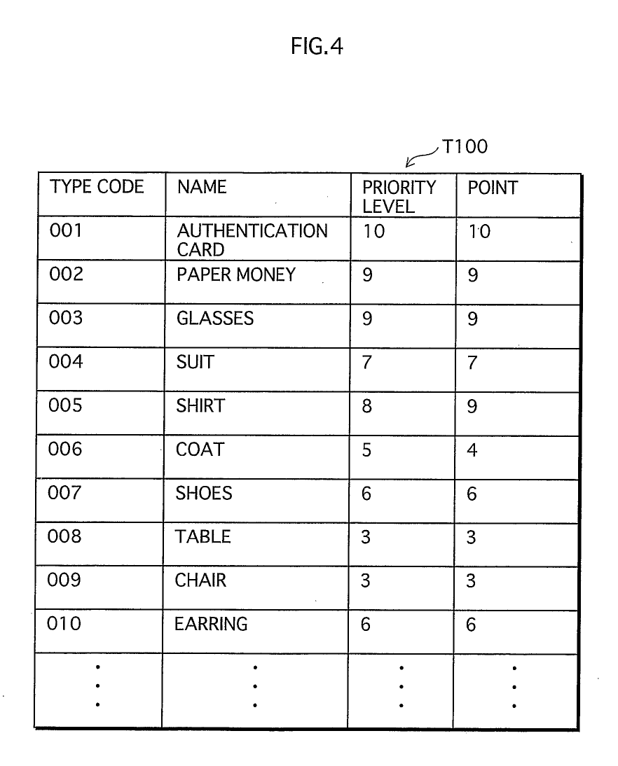

The type code storage unit 133 includes a type code table T100, an example of which is shown in FIG. 4.

The type code table T100 stores one or more sets of a type code, a name, a priority level, and a point.

The type code is a code for identifying a type of a product that has a wireless ID tag.

The name in the table is a type name that is correlated with a type code. For example, in FIG. 4, the type code “001” is correlated with the type name “authentication card”.

The priority level is a numeral indicating a priority level that is used in the registration with the authentication recording medium 20. In the present embodiment, the priority levels are indicated by, for example, numerals “1” to “10”, where numeral “1” indicates the lowest priority level and the higher the numeral is, the higher the priority level is.

The point in the table indicates a point that is assigned to an ID code when the ID codes are used as points. In the present embodiment, each type code is assigned with one of numerals “1” to “10” as the point.

(D) Authentication Information Storage Unit 134

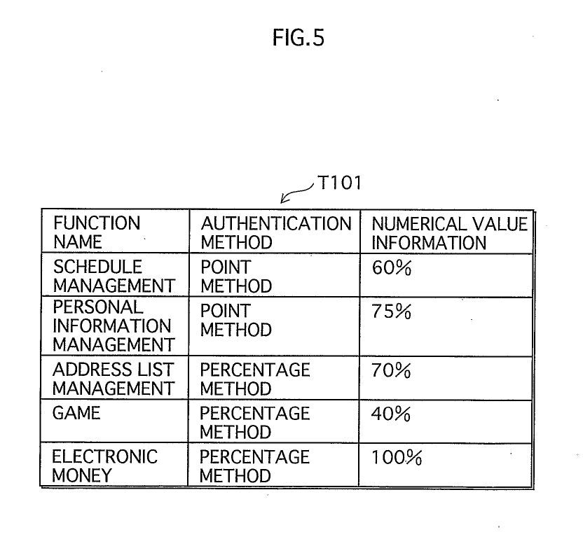

The authentication information storage unit 134 includes an authentication standard code table T101, an example of which is shown in FIG. 5.

The authentication standard code table T101 stores one or more sets of a function name, an authentication method, and numerical information. The authentication standard code table T101 stores the stated sets for all functions for which accesses are limited.

The function name is a name of a function for which accesses are limited. For example, the function name “schedule management” indicates the schedule management function 120, the function name “personal information management” indicates the personal information management function 121, the function name “address list management” indicates the address list management function 122, the function name “game” indicates the game function 123, and the function name “electronic money function” indicates the electronic money function 124.

The authentication method in this example indicates either a point method or a percentage method. With the point method, if there are matches between the ID codes acquired in an authentication and the ID codes having been registered with the authentication recording medium 20, the matched ID codes are replaced with corresponding points, and the points are used for the authentication. With the percentage method, a ratio of (i) the number of ID codes, among those acquired in an authentication, matching ID codes having been registered with the authentication recording medium 20 to (ii) the number of ID codes having been registered with the authentication recording medium 20 is used for the authentication.

The numerical information indicates a percentage used as a standard value when certifying the authenticity of a user. When the point method is used in the authentication, the numerical information indicates a standard value of a ratio of (i) the points corresponding to the acquired ID codes that match ID codes having been registered beforehand to (ii) the total points corresponding to the ID codes having been registered with the authentication recording medium 20 beforehand. When the percentage method is used in the authentication, the numerical information indicates a standard value of the ratio of (i) the number of ID codes, among those acquired in an authentication, matching ID codes having been registered with the authentication recording medium 20 to (ii) the total number of ID codes having been registered with the authentication recording medium 20.

For example, suppose that five ID codes and a total of 20 points have been registered with the authentication recording medium 20. The table shown in FIG. 5 indicates that for the schedule management, the point method is used for the authentication, and the numerical information is 60%. This indicates that in such a case, the points required to certify the authenticity of a user who requests to use the schedule management function 120 is “12”, that is, 60% of the total of 20 points. Also, the table shown in FIG. 5 indicates that for the game, the percentage method is used for the authentication, and the numerical information is 40%. This indicates that in such a case, the standard for certifying the authenticity of a user who requests to use the game function 123 is “2”, which means that if two out of the registered ID codes match, the authenticity of the user is certified. It should be noted here that if the value used as a standard in the authentication has a decimal fraction, the decimal fraction is rounded up.

(E) Standard Priority Storage Unit 135

The standard priority storage unit 135 stores a standard priority level (for example, “5”) that is used when the ID codes to be registered with the authentication recording medium 20 are refined.

(F) Standard Point Storage Unit 136

The standard point storage unit 136 stores a standard point value (for example, “5”) that is used when the ID codes to be registered with the authentication recording medium 20 are refined.

(3) Password Storage Unit 103

The password storage unit 103 stores passwords used as a standard in the authentication that uses a password. Each password is, for example, one or more characters that are alphanumeric characters and/or signs.

(4) Received Information Storage Unit 104

The received information storage unit 104 includes 50 information storage areas each of which stores a set of an ID code that was read from one of the wireless ID tags 30, 31, 32, 33, 34, 35, . . . 36 during an ID tag authentication, and a name, a priority level, and a point that correspond to the read ID code.

(5) Clock Unit 108

The clock unit 108 is a clock that measures time.

(6) Input Unit 105

The input unit 105, upon receiving from a user a designation to start to register an ID code, outputs an ID code registration instruction, which instructs to register the ID code, to the control unit 107.

The input unit 105 also receives a password from a user, and outputs the received password to the control unit 107.

Upon receiving from a user a designation to write an ID code displayed by the display unit 106, the input unit 105 outputs a registration instruction, which instructs to register the displayed ID code, to the control unit 107. Upon receiving from a user a designation not to write an ID code displayed by the display unit 106, the input unit 105 outputs a no-registration instruction, which instructs not to register the displayed ID code, to the control unit 107.

Upon receiving from a user a designation to register a function for which the access by the user is limited, or a designation to change the contents of registration of a function for which the access by the user is limited, the input unit 105 generates name information indicating the name of the function specified by the designation, outputs a name registration instruction, which instructs to register with the authentication standard code table T101, and the generated name information to the control unit 107.

Upon receiving, from a user, method information specifying either the point method or the percentage method as the authentication method to be used for a function to register or change the contents of registration, outputs the received method information to the control unit 107. Also, upon receiving, from a user, numerical information indicating a numerical value, which is to be used as a standard when performing an authentication for the function to register or change the contents of registration, outputs the received numerical information to the control unit 107.

Upon receiving from a user a designation to activate a function stored in the function storage unit 101, the input unit 105 generates activation function information indicating the name of the function to be activated, outputs an activation instruction instructing to activate, and the generated activation function information to the control unit 107.

The input unit 105 also receives a designation or information in relation to the activated function. Upon receiving such a designation, the input unit 105 outputs an instruction corresponding to the received designation to the control unit 107. Upon receiving such information, the input unit 105 outputs the received information to the control unit 107.

(7) Display Unit 106

The display unit 106, upon receiving, from the control unit 107, password request information requesting to input a password, displays the received password request information and urges the user to input the password.

The display unit 106, upon receiving, from the control unit 107, an ID code, and in correspondence with the ID code, a name, a point, and a remaining number of registrations that indicates the number of registrations that can be registered yet, displays the received ID code, name, point, and remaining number of registrations, and urges the user to determine whether or not to write the displayed ID code.

Upon receiving, from the control unit 107, method request information requesting to input method information, the display unit 106 displays the received method request information and urges the user to input the method information.

Upon receiving, from the control unit 107, numerical value request information requesting to input a numerical value to be used as a standard in the authentication, the display unit 106 displays the received numerical value request information and urges the user to input the numerical value.

Upon receiving, from the control unit 107, information in relation to each function stored in the function storage unit 101, the display unit 106 displays the received information.

(8) Tag Reading Unit 109

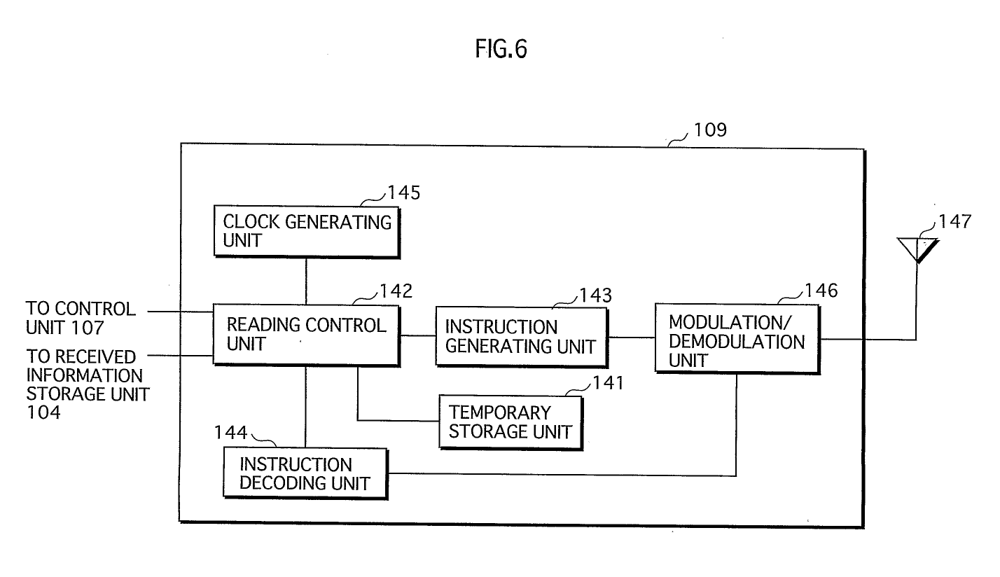

The tag reading unit 109 can read information in relation to up to 50 wireless ID tags in a same time period. As shown in FIG. 6, the tag reading unit 109 includes a temporary storage unit 141, a reading control unit 142, an instruction generating unit 143, an instruction decoding unit 144, a clock generating unit 145, a modulation/demodulation unit 146, and an antenna unit 147.

(A) Temporary Storage Unit 141

The temporary storage unit 141 includes 50 ID code areas each of which temporarily stores an ID code for identifying a wireless ID tag.

(B) Reading Control Unit 142

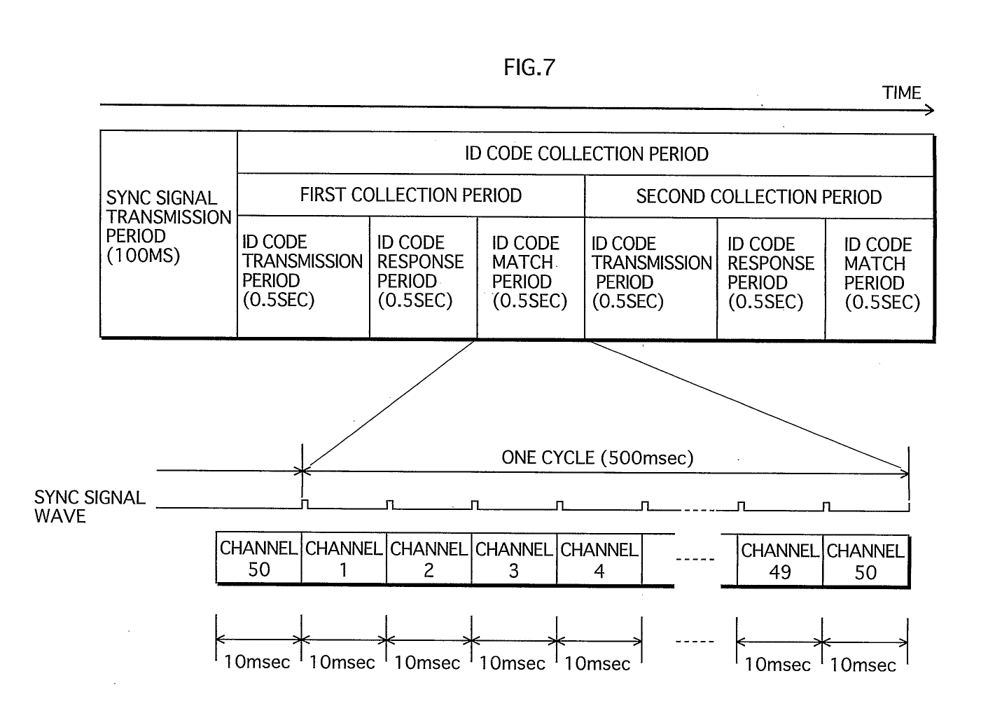

The reading control unit 142 controls transmission of a sync signal in a sync signal transmission period, and controls collection of ID codes in an ID code collection period. FIG. 7 shows one example of such controls. In FIG. 7, the horizontal axis is a time axis.

The sync signal transmission period is adjacent to the ID code collection period on the time axis.

The ID code collection period is divided into a first collection period and a second collection period. Each of the first and second collection periods is composed of an ID code transmission period, an ID code response period, and an ID code match period. The ID code transmission period, ID code response period, and ID code match period form one cycle of, for example, 500 msec.

One cycle is equally divided into 50 sections of 10 msec. Each section of 10 msec is referred to as channel. The 5 channels in one cycle are referred to as, in order of time, channel 1, channel 2, channel 3, . . . channel 50. The 50 channels are identified by the channel numbers.

<Outputting Instructions>

The reading control unit 142, upon receiving from the control unit 107 an ID code read start instruction to start reading ID codes of the wireless ID tags so as to register the ID codes with the authentication recording medium 20, outputs to the instruction generating unit 143 a sync signal transmission instruction to transmit a sync signal, and an ID code collection instruction to collect the ID codes of the wireless ID tags, in the stated order.

<Collecting ID Codes>

After outputting the ID code collection instruction to the instruction generating unit 143, the reading control unit 142 collects the ID codes in the ID code collection period of three seconds, which will be described in detail later. After the ID code collection period passes over, the reading control unit 142 determines that the ID codes of all the wireless ID tags have been collected, and ends the ID code collection. As stated earlier, the ID code collection period is divided into the first collection period and the second collection period, and in each of the first and second collection periods, the reading control unit 142 controls the ID code transmission, ID code response, and ID code match. The reason why the ID code collection period is divided into the first collection period and the second collection period will be described later.

The reading control unit 142 receives the ID code transmission instruction, an ID code, and a channel number in the ID code transmission period. Upon receiving the ID code transmission instruction, the reading control unit 142 writes the received ID code into an ID code area in the temporary storage unit 141 indicated by the received channel number.

The reading control unit 142 receives the standard clock from the clock generating unit 145, and based on the received standard clock, generates a sync signal wave that repeatedly includes a sync signal composed of one pulse signal per 10 msec, and outputs the generated sync signal wave to the instruction generating unit 143 for 100 msec.

As shown in FIG. 7, one cycle of the sync signal wave is 500 msec. As stated earlier, one cycle is equally divided into 50 sections of 10 msec, and each section of 10 msec is referred to as channel.

The reading control unit 142 selects a channel having the received channel number, and outputs the received ID code and an ID code response instruction, which instructs to transmit an ID code, to the instruction generating unit 143 in the ID code response period using the selected channel.

As apparent from the above description, since the reading control unit 142 selects a channel having the received channel number, there is a possibility that it selects the same channel for different wireless ID tags. When this happens, the ID codes of such wireless ID tags are not collected in the first collection period. Then, in the second collection period, ID codes of wireless ID tags are collected. In the second collection period, there is smaller possibility that the same channel is selected for different wireless ID tags.

The reading control unit 142 waits for the selected channel in the ID code match period to come to receive the ID code match instruction and an ID code from the instruction decoding unit 144. Upon receiving the ID code match instruction and an ID code from the instruction decoding unit 144 in the selected channel in the ID code match period, the reading control unit 142 recognizes that an ID code stored in an ID code area in the temporary storage unit 141 corresponding to the selected channel is the ID code for correctly identifying a wireless ID tag, and reads the ID code from the ID code area in the temporary storage unit 141, and writes the read ID code into the received information storage unit 104. It should be noted here that a name, a priority level, and a point value corresponding to the ID code have not been written at this point in time.

After the ID code collection period of three seconds passes over, the reading control unit 142 outputs an ID code read completion instruction, which indicates that the reading of the ID code is completed, to the control unit 107.

(C) Instruction Generating Unit 143

The instruction generating unit 143 receives from the reading control unit 142 the sync signal transmission instruction, the ID code collection instruction, and a pair of the ID code response instruction and an ID code.

Upon receiving the sync signal transmission instruction from the reading control unit 142, the instruction generating unit 143 generates a pulse signal wave based on the received sync signal transmission instruction, and outputs the generated pulse signal wave to the modulation/demodulation unit 146. The instruction generating unit 143 then receives a sync signal wave from the reading control unit 142, generates a pulse signal wave based on the received sync signal wave for 100 msec, and outputs the generated pulse signal wave to the modulation/demodulation unit 146.

Upon receiving the ID code collection instruction or the ID code response instruction from the reading control unit 142, the instruction generating unit 143 generates pulse signal waves based on the received instructions, respectively, and outputs the generated pulse signal waves to the modulation/demodulation unit 146.

Upon receiving the ID code response instruction and an ID code from the reading control unit 142, the instruction generating unit 143 outputs a pulse signal wave in accordance with the ID code response instruction, and then generates a pulse signal wave based on the received ID code, and outputs the generated pulse signal wave to the modulation/demodulation unit 146.

(D) Clock Generating Unit 145

The clock generating unit 145 repeatedly generates a standard clock that indicates a standard time, and outputs the generated standard clock to the reading control unit 142.

(E) Instruction Decoding Unit 144

The instruction decoding unit 144 receives a pulse signal wave from the modulation/demodulation unit 146. The instruction decoding unit 144 then decodes the received pulse signal wave and extracts an instruction and information from the pulse signal wave.

The instruction extracted by the instruction decoding unit 144 here is either the ID code transmission instruction or the ID code match instruction.

If the extracted instruction is the ID code transmission instruction, the instruction decoding unit 144 extracts a channel number and an ID code as the information. The instruction decoding unit 144 outputs the extracted channel number and ID code to the reading control unit 142.

If the extracted instruction is the ID code match instruction, the instruction decoding unit 144 extracts an ID code as the information. The instruction decoding unit 144 outputs the extracted ID code to the reading control unit 142.

(F) Modulation/Demodulation Unit 146

The modulation/demodulation unit 146, upon receiving a pulse signal wave from the instruction generating unit 143, changes the amplitude of a carrier wave based on the received pulse signal wave as a modulation signal, and outputs the carrier wave with the changed amplitude to the antenna unit 147.

Also, the modulation/demodulation unit 146 receives a power signal from the antenna unit 147, demodulates the received power signal, extracts a pulse signal wave from the signal resulted from the demodulation, and outputs the extracted pulse signal wave to the instruction decoding unit 144.

(G) Antenna Unit 147

The antenna unit 147 includes a transmission antenna and a reception antenna.

The transmission antenna, which is, for example, a directional antenna that radiates radio waves in a specific direction, receives a carrier wave with the changed amplitude from the modulation/demodulation unit 146, and radiates the received carrier wave into the air as a radio wave.

The reception antenna receives a radio wave, converts the received radio wave into an electric signal, and outputs the electric signal to the modulation/demodulation unit 146.

(9) Control Unit 107

The control unit 107 controls (i) registration of an ID code with the authentication recording medium 20, (ii) registration of the authentication method, and (iii) the authentication.

<ID Code Registration Control>

The control unit 107, upon receiving the ID code registration instruction from the input unit 105, generates the password request information, and outputs the generated password request information to the display unit 106. The control unit 107 then receives a password from the input unit 105, and judges whether or not the received password matches a password stored in the password storage unit 103. If the passwords do not match, the control unit 107 stops the registration of the ID code.

If the passwords match, the control unit 107 outputs the ID code read start instruction to the tag reading unit 109.

Upon receiving the ID code read completion instruction from the tag reading unit 109, the control unit 107 performs the following operations.

The control unit 107 acquires, from the type code table T100, a name, a priority level, and a point value corresponding to the ID code stored in an information storage area in the received information storage unit 104, and stores the acquired name, priority level, and point value into the information storage area in the received information storage unit 104 in which the ID code is stored. This operation is performed for each ID code stored in the received information storage unit 104.

The control unit 107 then confirms whether or not there are ID codes, among those stored in the information storage areas in the received information storage unit 104, that overlap each other. If there are overlapping ID codes, the control unit 107 subtracts a predetermined value (for example, “2”) from each point value corresponding to the overlapping ID codes, and replaces the point values stored in the information storage areas with the point values after the subtraction. If there is no overlapping ID code, the point values are stored as they are. It should be noted here that if the subtraction results in “0” or lower, a value “1” is stored as the point value after the subtraction.

The control unit 107 then confirms whether or not the number of ID codes stored in the received information storage unit 104 is equal to or lower than an upper limit stored in the number of registrations information storage unit 132.

If it judges that the number of ID codes stored in the received information storage unit 104 is equal to or lower than the upper limit, the control unit 107 deletes the contents of the ID tag information storage unit 202 in the authentication recording medium 20 that will be described later, and writes an ID code stored in the received information storage unit 104 and a point value corresponding to the ID code into the ID tag information storage unit 202 via the input/output unit 110. The control unit 107 performs the writing operation after the deletion of the contents of the ID tag information storage unit 202, for each ID code stored in the received information storage unit 104, namely as many times as the number of ID codes stored in the received information storage unit 104.

If it judges that the number of ID codes stored in the received information storage unit 104 is higher than the upper limit, the control unit 107 compares the priority level of the ID code stored in the received information storage unit 104 with the standard priority level stored in the standard priority storage unit 135. If the priority level is lower than the standard priority level, the control unit 107 deletes the ID code, and the name, priority level, and point value corresponding to the ID code. The control unit 107 performs this operation for each ID code stored in the received information storage unit 104, then judges for the second time whether or not the number of ID codes stored in the received information storage unit 104 is equal to or lower than the upper limit stored in the number of registrations information storage unit 132.

If it judges that the number of ID codes stored in the received information storage unit 104 is equal to or lower than the upper limit, the control unit 107 deletes the contents of the ID tag information storage unit 202, and writes an ID code stored in the received information storage unit 104 and a point value corresponding to the ID code into the ID tag information storage unit 202 via the input/output unit 110. The control unit 107 performs the writing operation after the deletion of the contents of the ID tag information storage unit 202, for each ID code stored in the received information storage unit 104, namely as many times as the number of ID codes stored in the received information storage unit 104.

If it judges that the number of ID codes stored in the received information storage unit 104 is higher than the upper limit, the control unit 107 compares the point value of the ID code stored in the received information storage unit 104 with the standard point value stored in the standard point storage unit 136. If the point value is lower than the standard point value, the control unit 107 deletes the ID code, and the name, priority level, and point value corresponding to the ID code. The control unit 107 performs this operation for each ID code stored in the received information storage unit 104, then judges again whether or not the number of ID codes stored in the received information storage unit 104 is equal to or lower than the upper limit stored in the number of registrations information storage unit 132.

If it judges that the number of ID codes stored in the received information storage unit 104 is equal to or lower than the upper limit, the control unit 107 deletes the contents of the ID tag information storage unit 202, and writes an ID code stored in the received information storage unit 104 and a point value corresponding to the ID code into the ID tag information storage unit 202 via the input/output unit 110. The control unit 107 performs the writing operation after the deletion of the contents of the ID tag information storage unit 202, for each ID code stored in the received information storage unit 104, namely as many times as the number of ID codes stored in the received information storage unit 104.

If it judges that the number of ID codes stored in the received information storage unit 104 is higher than the upper limit, the control unit 107 deletes the contents of the ID tag information storage unit 202. The control unit 107 then reads an ID code, and the name and point value corresponding to the ID code from the received information storage unit 104, and outputs the read ID code, name, and point value, and the remaining number of registrations to the display unit 106. It should be noted here that the initial value of the remaining number of registrations is set to the upper limit of the number of registrations. In this example, the initial value of the remaining number of registrations is “5”. The control unit 107 then receives the registration instruction or the no-registration instruction from the input unit 105. Upon receiving the registration instruction, the control unit 107 writes a pair of the read ID code and point value into the ID tag information storage unit 202 in the authentication recording medium 20 via the input/output unit 110, subtracts “1” from the remaining number of registrations, and replaces the remaining number of registrations with the result of the subtraction. Upon receiving the no-registration instruction, the control unit 107 does not write the acquired ID code and point value, but repeats the operation after the deletion of the contents of the ID tag information storage unit 202 until the remaining number becomes zero, or as many times as the number of ID codes stored in the received information storage unit 104.

The control unit 107 then acquires the current date/time from the clock unit 108, and acquires the standard days “3” from the standard days information storage unit 131. The control unit 107 calculates the expiration date/time using the acquired current date/time and standard days, and writes the calculated expiration date/time into the expiration date information storage unit 203, which will be described later, in the authentication recording medium 20 via the input/output unit 110. For example, if the control unit 107 acquires a current date/time “February 1, 2004, 17:18”, the control unit 107 obtains “February 4, 2004, 17:18” as the expiration date/time by adding “3” (standard days) to the acquired current date/time.

The control unit 107 further deletes the contents of the received information storage unit 104.

<Authentication Method Registration Control>

The control unit 107, upon receiving the name registration instruction and the name information from the input unit 105, temporarily stores the received name information. The control unit 107 then generates the password request information, and outputs the generated password request information to the display unit 106. The control unit 107 then receives a password from the input unit 105, and judges whether or not the received password matches a password stored in the password storage unit 103. If the passwords do not match, the control unit 107 deletes the temporarily stored name information and stops the registration of the authentication method.

If the passwords match, the control unit 107 generates the method request information, and outputs the generated method request information to the display unit 106. The control unit 107 then receives from the input unit 105 the method information specifying either the point method or the percentage method. The control unit 107 generates the numerical value request information, and outputs the generated numerical value request information to the display unit 106. The control unit 107 then receives the numerical information from the input unit 105. The control unit 107 writes the temporarily stored name information and the method information and the numerical information received from the input unit 105 into the authentication standard code table T101 as a set. In doing this, if it judges that the name information has already been stored in the authentication standard code table T101, the control unit 107 overwrites each piece of stored information.

<Authentication Control>

The control unit 107, upon receiving the activation instruction and the activation function information from the input unit 105, judges by referring to the authentication standard code table T101 whether or not the access by the user to the function corresponding to the received activation function information is limited. More specifically, if the function name indicated by the received activation function information is found in the authentication standard code table T101, the control unit 107 judges that the access by the user to the function indicated by the received activation function information is limited; and if the function name is not found in the authentication standard code table T101, the control unit 107 judges that the access to the function is not limited.

If it judges that the access is not limited, the control unit 107 activates the function indicated by the received activation function information.

If it judges that the access is limited, the control unit 107 acquires the expiration date/time stored in the expiration date information storage unit 203 in the authentication recording medium 20 and the current date/time from the clock unit 108, and judges whether or not the current date/time is before the expiration date/time.

If it judges that the current date/time is not before the expiration date/time, the control unit 107 generates the password request information and outputs the generated password request information to the display unit 106. The control unit 107 then receives a password from the input unit 105, and judges whether or not the received password matches the password stored in the password storage unit 103. If the passwords do not match, the control unit 107 does not activate the function indicated by the received activation function information. If the passwords match, the control unit 107 outputs the ID code read start instruction to the tag reading unit 109, performs the same operations as it does after it outputs the ID code read start instruction in the above-described ID code registration control, re-registers the ID code, and after this, activates the function indicated by the received activation function information.

If it judges that the current date/time is before the expiration date/time, the control unit 107 outputs the ID code read start instruction to the tag reading unit 109. Upon receiving the ID code read completion instruction from the tag reading unit 109, the control unit 107 acquires, from the authentication standard code table T101, the authentication method and the numerical information corresponding to the function name indicated by the received activation function information. The control unit 107 then judges whether or not the received authentication method is the point method or the percentage method.

If it judges that the received authentication method is the point method, the control unit 107 calculates total points by adding up the points for all the ID codes stored in the ID tag information storage unit 202 in the authentication recording medium 20. The control unit 107 further calculates acquired points by adding up the points for the ID codes that match the ID codes stored in the received information storage unit 104. The control unit 107 calculates a ratio of the acquired points to the total points, and judges whether or not the calculated ratio is equal to or higher than the value indicated by the numerical information acquired from the authentication standard code table T101. If it judges that the calculated ratio is equal to or higher than the value indicated by the numerical information, the control unit 107 activates the function indicated by the received activation function information. If it judges that the calculated ratio is lower than the value indicated by the numerical information, the control unit 107 generates the password request information and outputs the generated password request information to the display unit 106. The control unit 107 then receives a password from the input unit 105, and judges whether or not the received password matches the password stored in the password storage unit 103. If the passwords do not match, the control unit 107 does not activate the function indicated by the received activation function information. If the passwords match, the control unit 107 registers the ID code acquired by the tag reading unit 109. The registration of the ID code is the same as the registration after the ID code read completion instruction is received, in the above-described ID code registration control, and the description thereof is omitted here. After the registration of the ID code, the control unit 107 activates the function indicated by the received activation function information.

If it judges that the received authentication method is the percentage method, the control unit 107 calculates the total number of ID codes stored in the ID tag information storage unit 202 in the authentication recording medium 20. The control unit 107 further calculates the number of acquired ID codes, the number being equal to the number of ID codes that match the ID codes stored in the received information storage unit 104. The control unit 107 calculates a ratio of the number of acquired ID codes to the total number of ID codes, and judges whether or not the calculated ratio is equal to or higher than the value indicated by the numerical information acquired from the authentication standard code table T101. If it judges that the calculated ratio is equal to or higher than the value indicated by the numerical information, the control unit 107 activates the function indicated by the received activation function information. If it judges that the calculated ratio is lower than the value indicated by the numerical information, the control unit 107 operates the same as it does when it judges that the calculated ratio with the point method is lower than the value indicated by the numerical information.

After it activates the function indicated by the activation function information received from the input unit 105, the control unit 107 controls the activated function based on the instruction received from the input unit 105 regarding the activated function. For example, if it receives an instruction regarding display, the control unit 107 outputs information of the contents stored in the activated function to the display unit 106. Also, if it receives an instruction regarding registration, the control unit 107 registers information received from the input unit 105.

(10) Input/Output Unit 110

The input/output unit 110 performs data input/output between the control unit 107 and the authentication recording medium 20.

1.3 Authentication Recording Medium 20

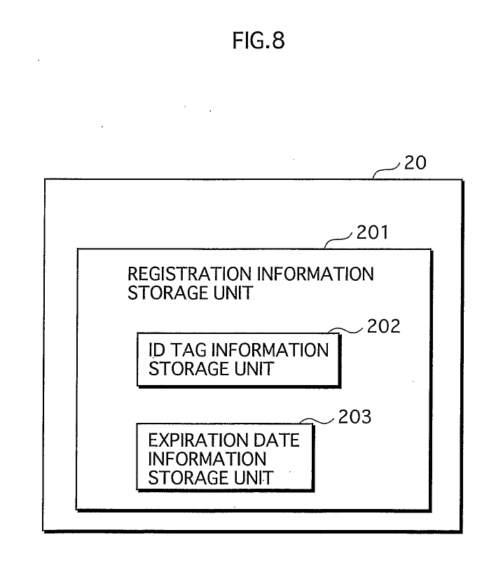

The authentication recording medium 20 is a portable recording medium, and as shown in FIG. 8, includes a registration information storage unit 201, which include an ID tag information storage unit 202 and an expiration date information storage unit 203.

(1) ID Tag Information Storage Unit 202

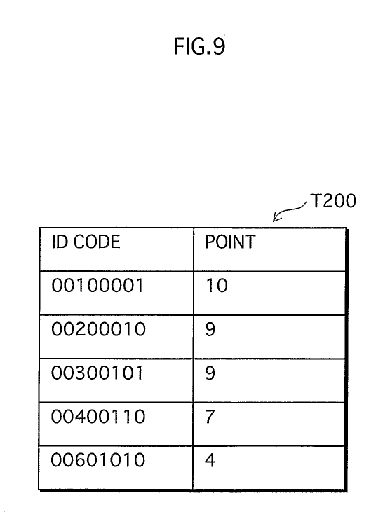

The ID tag information storage unit 202 includes an ID tag information table T200. FIG. 9 shows one example of the ID tag information table T200.

The ID tag information table T200 has storage areas that can store up to five pairs of an ID code and a point value.

In the table, each ID code identifies a wireless ID tag, and has a point value corresponding thereto.

The pairs of an ID code and a point value are written to the table by the control unit 107 of the user terminal 10. The ID tag information table T200 shown in FIG. 9 indicates a state after the data is written by the control unit 107.

(2) Expiration Date Information Storage Unit 203

The expiration date information storage unit 203 has storage areas that can store expiration dates/times that are used in the authentication of the one or more pairs of an ID code and a point value stored in the ID tag information storage unit 202. The expiration dates/times are written by the control unit 107 of the user terminal 10.

1.4 Wireless ID Tag 30

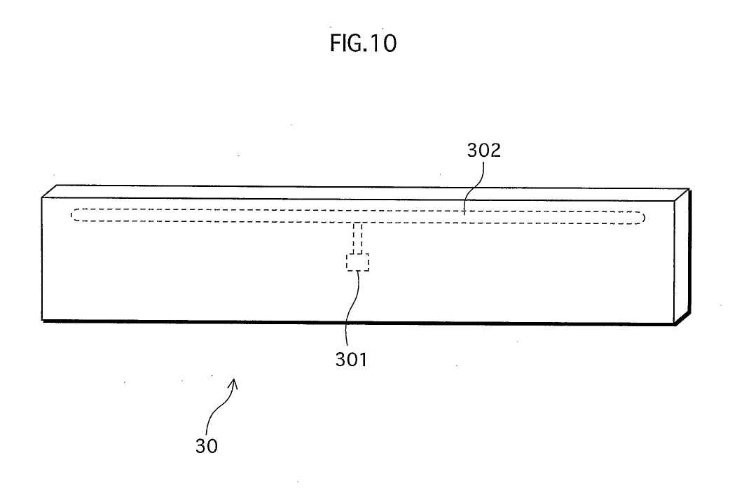

As stated earlier, the wireless ID tag 30 is embedded in the authentication card 40. As shown in FIG. 10, the wireless ID tag 30 is in a plate-like shape, and includes an IC chip unit 301 and an antenna unit 302 inside thereof.

The distance of communication for the wireless ID tag 30 is approximately within one meter, and the communication speed is 10-20 byte/msec. It is possible to read each of 50 or less stacked wireless ID tags 30 (multi-reading).

The wireless ID tag 30 is more specifically a computer system including a microprocessor, a ROM, a RAM and the like. A computer program is recorded in the ROM. The wireless ID tag 30 achieves its functions as the microprocessor operates in accordance with the computer program.

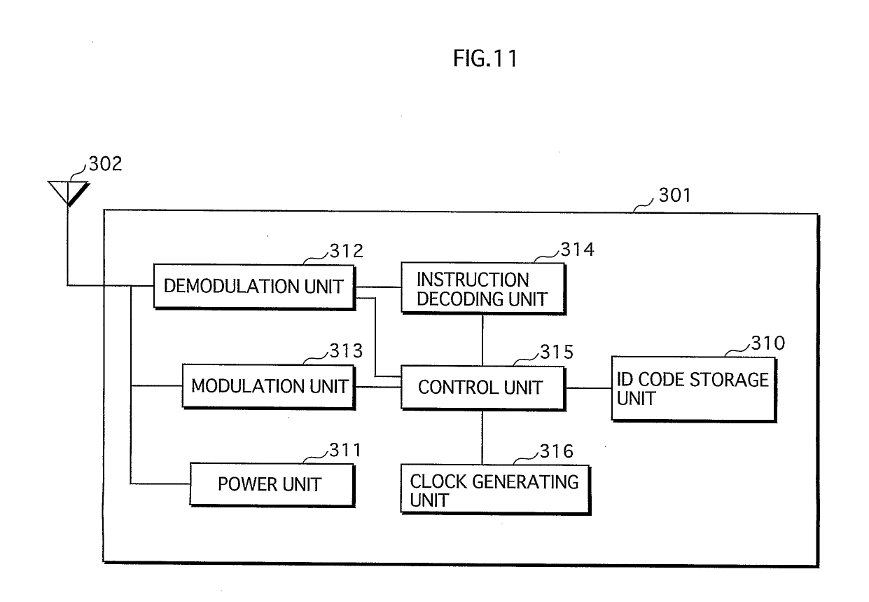

As shown in FIG. 11, the IC chip unit 301 includes an ID code storage unit 310, a power unit 311, a demodulation unit 312, a modulation unit 313, an instruction decoding unit 314, a control unit 315, and a clock generating unit 316. It should be noted here that the wireless ID tags 31, 32, 33, 34, 35, . . . 36 have the same construction as the wireless ID tag 30, and the description thereof is omitted.

(1) ID Code Storage Unit 310

The ID code storage unit 310 stores ID codes for identifying each of the wireless ID tags 30.

(2) Power Unit 311

The power unit 311, which is connected to the antenna unit 302, receives power signals from the antenna unit 302, and stores the received power signals as electric charges. The power unit 311 also supplies power to each component of the wireless ID tag.

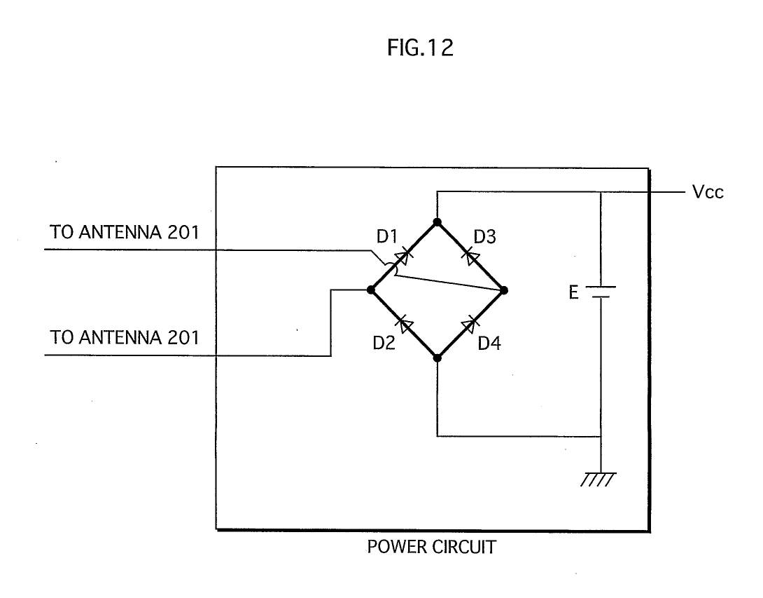

FIG. 12 shows one example of the power circuit included in the power unit 311. The power circuit shown in FIG. 12 includes diodes D1-D4 and a battery E. The diodes D1-D2 are connected in series in the same direction, and diodes D3-D4 are connected in series in the same direction. The diodes D1-D2 and the diodes D3-D4 are connected in parallel in the same direction. One end of the antenna unit 302 is connected to an intermediate point between the diodes D1 and D2, and the other end of the antenna unit 302 is connected to an intermediate point between the diodes D3 and D4. One end of the power E is connected to an intermediate point between the diodes D1 and D3, and the other end of the power E is connected to an intermediate point between the diodes D2 and D4.

(3) Demodulation Unit 312

The demodulation unit 312, which is connected to the antenna unit 302, receives power signals from the antenna unit 302, demodulates the received power signals, extracts pulse signal waves from the demodulated power signals, and outputs the extracted pulse signal waves to the instruction decoding unit 314.

(4) Instruction Decoding Unit 314

The instruction decoding unit 314 receives the pulse signal waves from the demodulation unit 312, decodes the received pulse signal waves to extract instructions, and outputs the extracted instructions to the control unit 315. The instructions extracted by the instruction decoding unit 314 include the sync signal transmission instruction, ID code collection instruction, and ID code response instruction.

If it extracts the ID code response instruction, the instruction decoding unit 314 further extracts an ID code as information, and outputs the extracted ID code to the control unit 315.

(5) Control Unit 315

The control unit 315 receives instructions from the instruction decoding unit 314. The instructions received from the instruction decoding unit 314 include the sync signal transmission instruction, ID code collection instruction, and ID code response instruction. If it receives the ID code response instruction, the control unit 315 further receives an ID code as information.

Upon receiving the sync signal transmission instruction from the instruction decoding unit 314, the control unit 315 further receives a sync signal wave from the demodulation unit 312, extracts a sync signal from the received sync signal wave, receives the standard clock from the clock generating unit 316, and based on the received standard clock, generates a sync signal wave that includes repeatedly a sync signal that synchronizes with the extracted sync signal.

Upon receiving the ID code collection instruction, the control unit 315 selects one numeral out of numerals “1” to “50” at random, and reads an ID code from the ID code storage unit 310. The control unit 315 then selects a channel whose channel number matches the numeral selected at random, and outputs the read ID code, the channel number of the selected channel, and the ID code transmission instruction to the modulation unit 313 in the ID code transmission period using the selected channel. Upon receiving the ID code response instruction in the ID code response period via the selected channel, the control unit 315 further receives an ID code, and compares the received ID code with the ID code read from the ID code storage unit 310. If the ID codes match, the control unit 315 outputs the ID code and the ID code match instruction to the modulation unit 313 in the ID code match period using the selected channel. If the ID codes do not match, the control unit 315 repeats the above-descried operation, starting with the selection of one numeral out of numerals “1” to “50” at random.

(6) Modulation Unit 313

The modulation unit 313 receives an instruction and information from the control unit 315, generates a bit sequence composed of the received instruction and information, and changes the impedance of the antenna unit 302 in accordance with the bits (each of which represents “0” or “1”) contained in the generated bit sequence. More specifically, the modulation unit 313 sets the impedance to the first value in correspondence with bit “1” in the bit sequence, and sets the impedance to the second value in correspondence with bit “0” in the bit sequence. With this arrangement, it is possible to transmit information by changing the amplitude and phase of the radio wave radiated from the antenna unit 302.

The instructions received from the control unit 315 include the ID code transmission instruction and the ID code match instruction. If it receives the ID code transmission instruction, the modulation unit 313 further receives a channel number and an ID code as information. If it receives the ID code match instruction, the modulation unit 313 further receives an ID code as information.

(7) Clock Generating Unit 316

The clock generating unit 316 generates the standard clock indicating the standard time, and outputs the generated standard clock to the control unit 315.

(8) Antenna Unit 302

The antenna unit 302, being a receiving antenna, receives radio waves, converts the received radio waves into power signals, and outputs the power signals to the demodulation unit 312 and the power unit 311. The antenna unit 302 also reflects (re-radiates) the received radio waves.

1.5 Outline of Operation of ID Code Registration

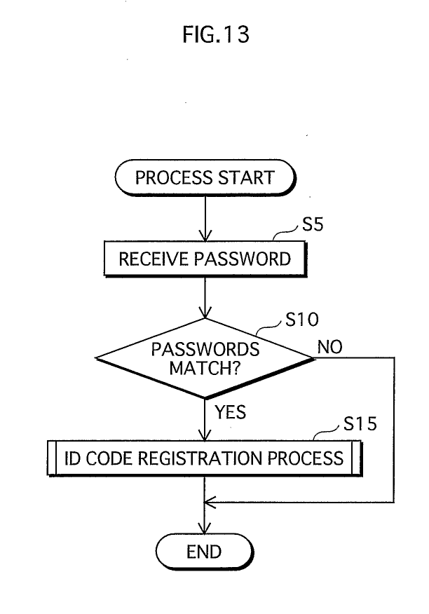

Here, an outline of the operation of registering an ID code with the ID tag information storage unit 202 of the authentication recording medium 20 will be described with reference to the flowchart shown in FIG. 13.

Upon receiving the ID code registration instruction from the input unit 105, the control unit 107 of the user terminal 10 outputs the password request information to the display unit 106, and receives a password from the input unit 105 (step S5).

The control unit 107 judges whether or not the received password matches a password stored in the password storage unit 103 (step S10). If the passwords match (“Yes” in step S10), the control unit 107 performs the ID code registration process to register the ID code of the collected wireless ID tag with the ID tag information storage unit 202 of the authentication recording medium 20 (step S15).

If the passwords do not match (“No” in step S10), the control unit 107 ends the process.

1.6 Operation of ID Code Registration Process

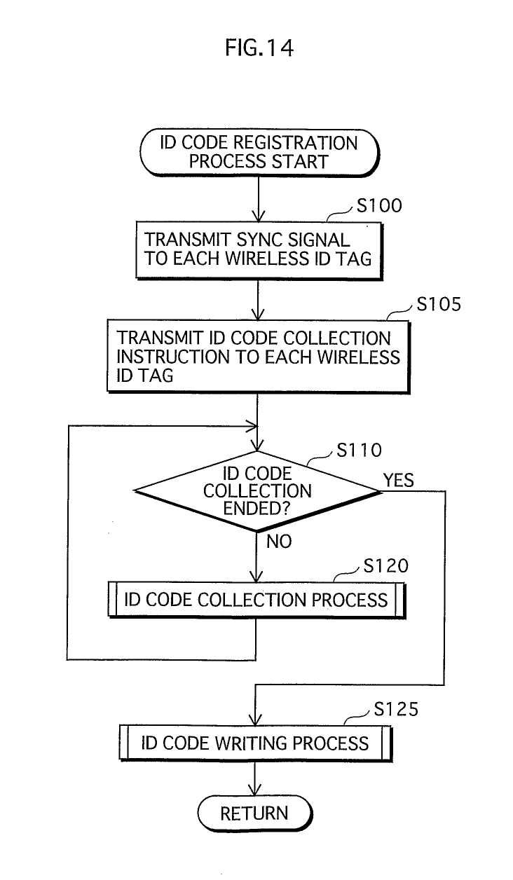

Here, the operation of the ID code registration process will be described with reference to the flowchart shown in FIG. 14.

The control unit 107 outputs the ID code read start instruction to the reading control unit 142 of the tag reading unit 109. Upon receiving the ID code read start instruction, the reading control unit 142 outputs the sync signal transmission instruction in the sync signal transmission period, and generates and outputs a sync signal wave. Upon receiving the sync signal transmission instruction from the reading control unit 142, the instruction generating unit 143 generates a pulse signal wave based on the received sync signal transmission instruction, and outputs the generated pulse signal wave to the modulation/demodulation unit 146. The modulation/demodulation unit 146 changes the amplitude of a carrier wave based on the received pulse signal wave, and outputs the carrier wave with the changed amplitude to the antenna unit 147. The antenna unit 147 radiates the received carrier wave into the air as a radio wave. The control unit 315 receives the sync signal transmission instruction via the antenna unit 302, the demodulation unit 312, and the instruction decoding unit 314, further receives a sync signal wave, extracts a sync signal, and generates a sync signal wave that includes repeatedly a sync signal that synchronizes with the extracted sync signal (step S100).

The reading control unit 142 outputs the ID code collection instruction. The instruction generating unit 143 generates a pulse signal wave based on the received ID code collection instruction, and outputs the generated pulse signal wave to the modulation/demodulation unit 146. The modulation/demodulation unit 146 changes the amplitude of a carrier wave based on the received pulse signal wave, and outputs the carrier wave with the changed amplitude to the antenna unit 147. The antenna unit 147 radiates the received carrier wave into the air as a radio wave. The control unit 315 receives the ID code collection instruction via the antenna unit 302, the demodulation unit 312, and the instruction decoding unit 314 (step S105).

The reading control unit 142 monitors the progress of the three-second ID code collection period (step S110), and in the three-second ID code collection period (“No” in step S110), performs the ID code collection process for collecting ID codes from each wireless ID tag (step S120).

After the ID code collection period passes over (“Yes” in step S110), the reading control unit 142 determines that the ID code collection process ended, and outputs the ID code read completion instruction to the control unit 107. Upon receiving the ID code read completion instruction, the control unit 107 performs the ID code writing process to register the ID code with the ID tag information storage unit 202 (step S125).

1.7 Operation of ID Code Collection Process

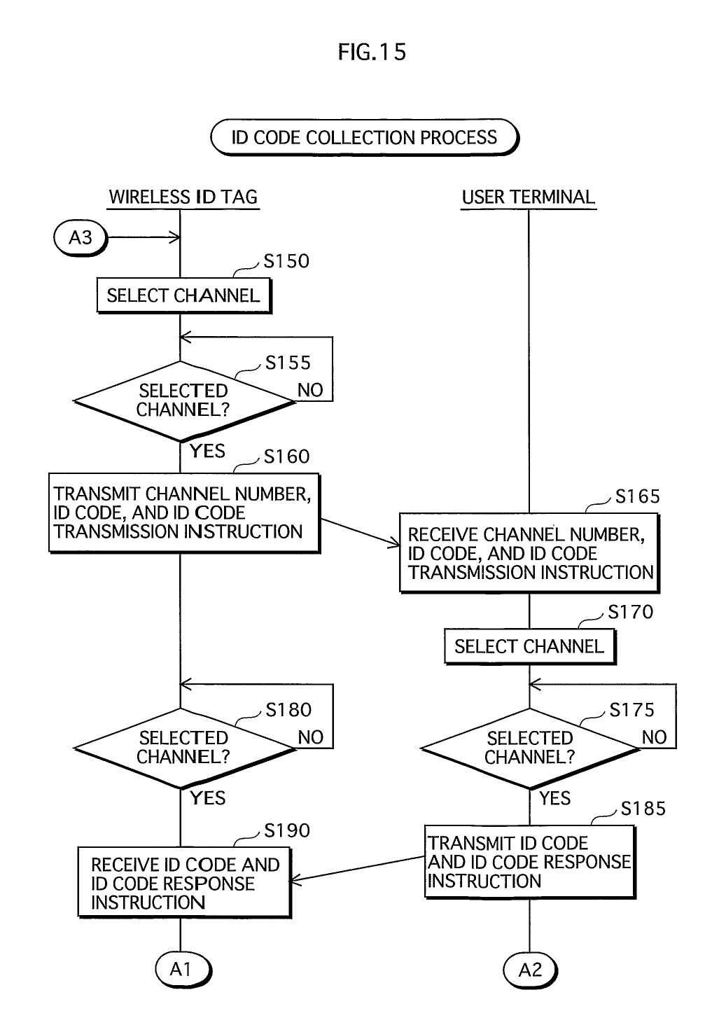

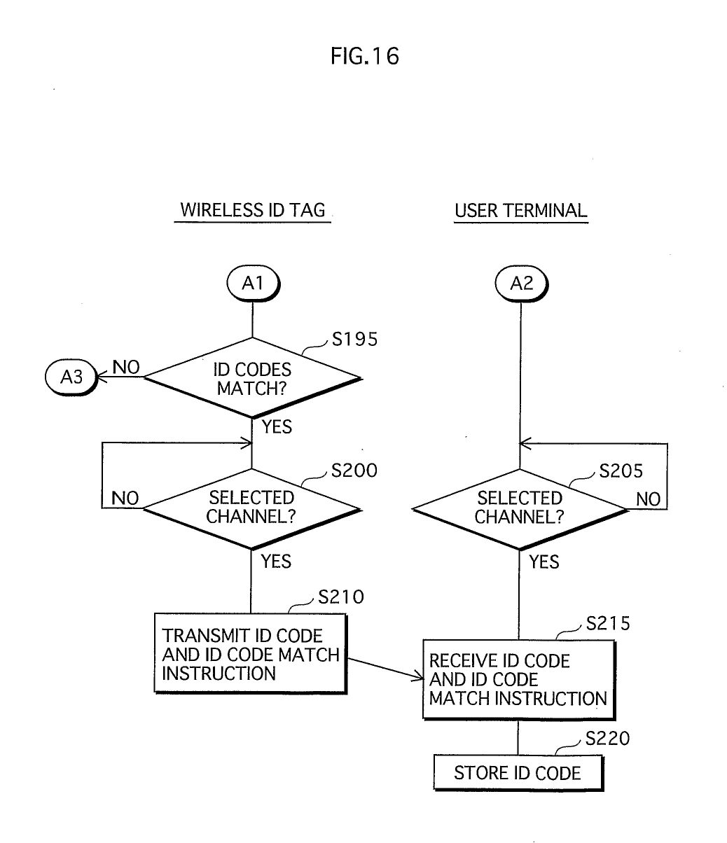

Here, the operation of the ID code collection process will be described with reference to the flowcharts shown in FIGS. 15 and 16.

Upon receiving the ID code collection instruction, the control unit 315 selects one numeral out of numerals “1” to “50” at random, reads an ID code from the ID code storage unit 310, and selects a channel whose channel number matches the numeral selected at random (step S150).

The control unit 315 outputs the read ID code, the channel number of the selected channel, and the ID code transmission instruction to the user terminal 10 via the modulation unit 313 and the antenna unit 302 (step S160) in the ID code transmission period using the selected channel (step S155).

The reading control unit 142 receives the ID code, channel number, and ID code transmission instruction via the antenna unit 147, the modulation/demodulation unit 146, and the instruction decoding unit 144, and writes the received ID code into an ID code area in the temporary storage unit 141 indicated by the received channel number (step S165).

The reading control unit 142 selects a channel having the received channel number (step S170), and in the ID code response period using the selected channel (step S175), transmits the received ID code and the ID code response instruction, which instructs to transmit an ID code, to the wireless ID tag via the instruction generating unit 143, the modulation/demodulation unit 146, and the antenna unit 147 (step S185).

The control unit 315 receives the ID code response instruction and the ID code via the antenna unit 302, the demodulation unit 312, and the instruction decoding unit 314 (step S190) in the ID code response period using the selected channel (step S180), and compares the received ID code with the ID code read from the ID code storage unit 310 (step S195) If the ID codes match (“Yes” in step S195), the control unit 315 transmits the ID code and the ID code match instruction to the user terminal 10 via the modulation unit 313 and the antenna unit 302 (step S210) in the ID code match period using the selected channel (step S200). If the ID codes do not match (“No” in step S195), the control unit 315 returns to step S150 and repeats the process.

Upon receiving the ID code match instruction and an ID code via the antenna unit 147, the modulation/demodulation unit 146, and the instruction decoding unit 144 (step S215) in the ID code match period in the selected channel (step S205), the reading control unit 142 recognizes that an ID code stored in an ID code area in the temporary storage unit 141 corresponding to the selected channel is the ID code for correctly identifying a wireless ID tag, reads the ID code from the ID code area in the temporary storage unit 141, and writes the read ID code into the received information storage unit 104 (step S220).

1.8 Operation of ID Code Writing Process

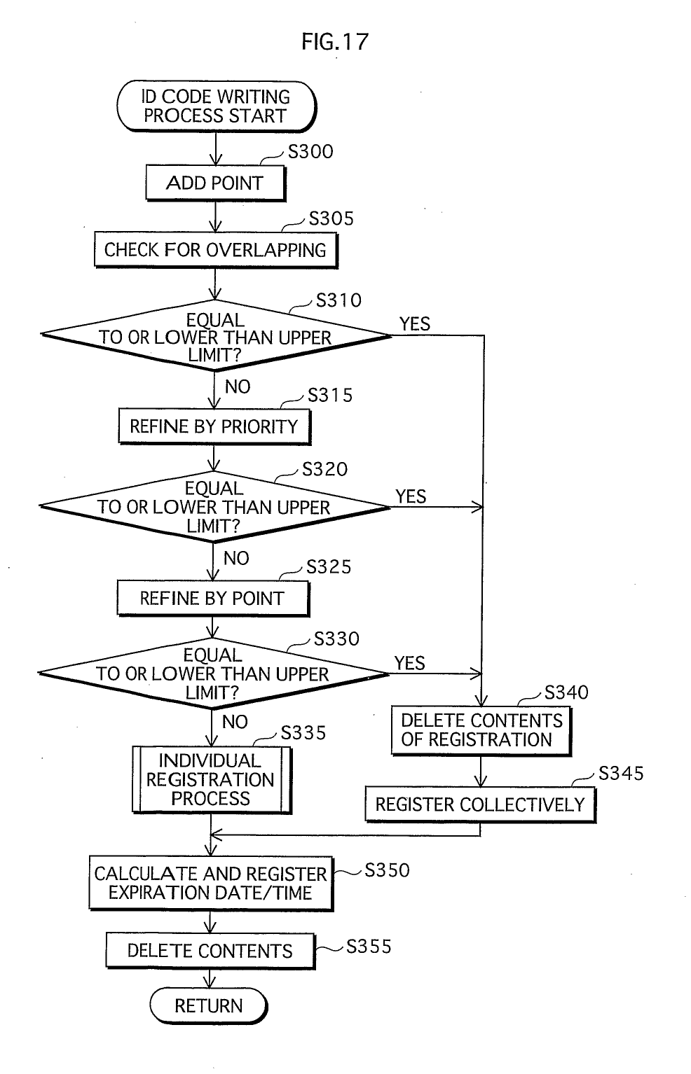

Here, the operation of ID code writing process will be described with reference to the flowchart shown in FIG. 17.

The control unit 107 acquires, from the type code table T100, a name, a priority levels and a point value corresponding to the ID code stored in an information storage area in the received information storage unit 104, and stores the acquired name, priority level, and point value into the information storage area in the received information storage unit 104 in which the ID code is stored (step S300). This operation is performed for each ID code stored in the received information storage unit 104.

The control unit 107 then confirms whether or not there are ID codes, among those stored in the information storage areas in the received information storage unit 104, that overlap each other. If there are overlapping ID codes, the control unit 107 subtracts a predetermined value from each point value corresponding to the overlapping ID codes, and replaces the point values stored in the information storage areas with the point values after the subtraction (step S305).

The control unit 107 then confirms whether or not the number of ID codes stored in the received information storage unit 104 is equal to or lower than an upper limit “5” (step S310).

If it judges that the number of ID codes stored in the received information storage unit 104 is equal to or lower than the upper limit “5” (“Yes” in step S310), the control unit 107 performs steps S340, S345, S350, and S355 as will be described later.

If it judges that the number of ID codes stored in the received information storage unit 104 is higher than the upper limit “5” (“No” in step S310), the control unit 107 compares the priority level of the ID code stored in the received information storage unit 104 with the standard priority level stored in the standard priority storage unit 135. If the priority level is lower than the standard priority level, the control unit 107 deletes, from the received information storage unit 104, the ID code, and the name, priority level, and point value corresponding to the ID code (step S315). The control unit 107 performs this operation for each ID code stored in the received information storage unit 104.

The control unit 107 then judges for the second time whether or not the number of ID codes stored in the received information storage unit 104 is equal to or lower than the upper limit “5” (step S320).

If it judges that the number of ID codes stored in the received information storage unit 104 is equal to or lower than the upper limit “5” (“Yes” in step S320), the control unit 107 performs steps S340, S345, S350, and S355.

If it judges that the number of ID codes stored in the received information storage unit 104 is higher than the upper limit “5” (“No” in step S320), the control unit 107 compares the point value of the ID code stored in the received information storage unit 104 with the standard point value stored in the standard point storage unit 136. If the point value is lower than the standard point value, the control unit 107 deletes the ID code, and the name, priority level, and point value corresponding to the ID code (step S325). The control unit 107 performs this operation for each ID code stored in the received information storage unit 104.

The control unit 107 judges again whether or not the number of ID codes stored in the received information storage unit 104 is equal to or lower than the upper limit “5” (step S330).

If it judges that the number of ID codes stored in the received information storage unit 104 is equal to or lower than the upper limit “5” (“Yes” in step S330), the control unit 107 deletes the registration contents of the ID tag information storage unit 202 (step S340), and writes an ID code stored in the received information storage unit 104 and a point value corresponding to the ID code into the ID tag information storage unit 202 via the input/output unit 110 (step S345). The control unit 107 performs this step for each ID code stored in the received information storage unit 104, namely as many times as the number of ID codes stored in the received information storage unit 104.

If it judges that the number of ID codes stored in the received information storage unit 104 is higher than the upper limit “5” (“No” in step S330), the control unit 107 writes an ID code stored in the received information storage unit 104 and a point value corresponding to the ID code into the ID tag information storage unit 202 if the user acknowledges the registration of the ID code in an individual registration process (step S335).

After the registration of the ID codes, the control unit 107 acquires the current date/time from the clock unit 108, acquires the standard days “3” from the standard days information storage unit 131, calculates the expiration date/time using the acquired current date/time and standard days, and writes the calculated expiration date/time into the expiration date information storage unit 203 (step S350).

The control unit 107 deletes the contents of the received information storage unit 104 (step S355).

1.9 Individual Registration Process

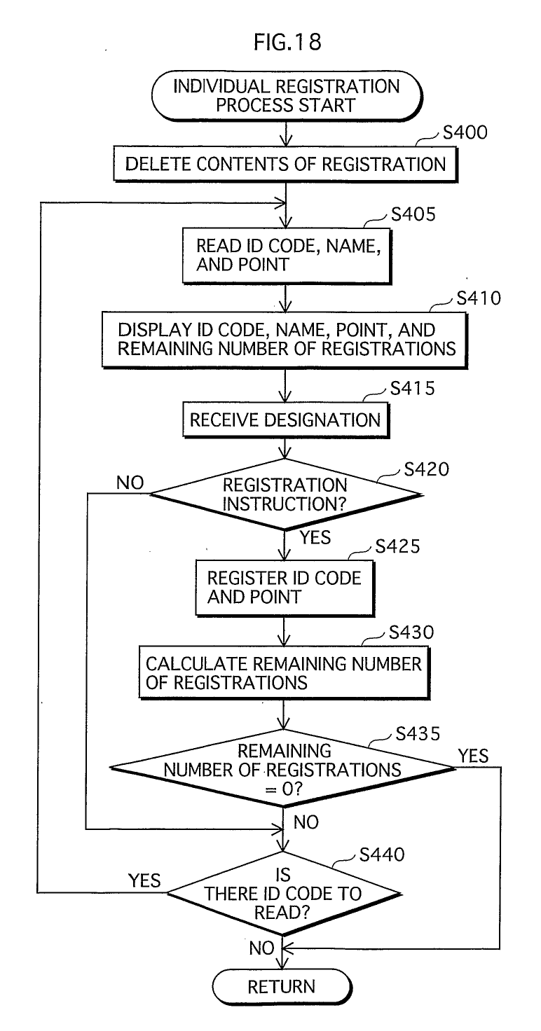

Here, the operation of the individual registration process will be described with reference to the flowchart shown in FIG. 18.

The control unit 107 deletes the registration contents of the ID tag information table T200 of the ID tag information storage unit 202 (step S400).

The control unit 107 reads an ID code, and the name and point value corresponding to the ID code from the received information storage unit 104 (step S405), and outputs the read ID code, name, and point value, and the remaining number of registrations (its initial value is “5”) to the display unit 106. The display unit 106 displays the received ID code, name, and point value, and the remaining number of registrations (step S410).

The control unit 107 then receives the registration instruction or the no-registration instruction, from the input unit 105 (step S415). The control unit 107 judges whether or not the received instruction is the registration instruction (step S420).

If it judges that the received instruction is not the registration instruction, that is to say, that the received instruction is the no-registration instruction (“No” in step S420), the control unit 107 discards a pair of the read ID code and point value, and performs step S435 as will be described later.

If it judges that the received instruction is the registration instruction (“Yes” in step S420), the control unit 107 writes a pair of the read ID code and point value into the ID tag information storage unit 202 via the input/output unit 110 (step S425). The control unit 107 subtracts “1” from the remaining number of registrations, replaces the remaining number of registrations with the result of the subtraction (step S430), and judges whether or not the remaining number of registrations is “0” (step S435). If it is judged that the remaining number of registrations is “0” (“Yes” in step S435), the process ends.

If it judges that the remaining number of registrations is not “0” (“No” in step S435), the control unit 107 judges whether or not there is an ID code to read in the received information storage unit 104 (step S440).

If it is judged that there is an ID code to read (“Yes” in step S440), the control returns to step S405 to repeat the steps. If it is judged that there is no ID code to read, namely that all the ID codes stored in the received information storage unit 104 have been read (“No” in step S440), the process ends.

1.10 Authentication Method Registration Process

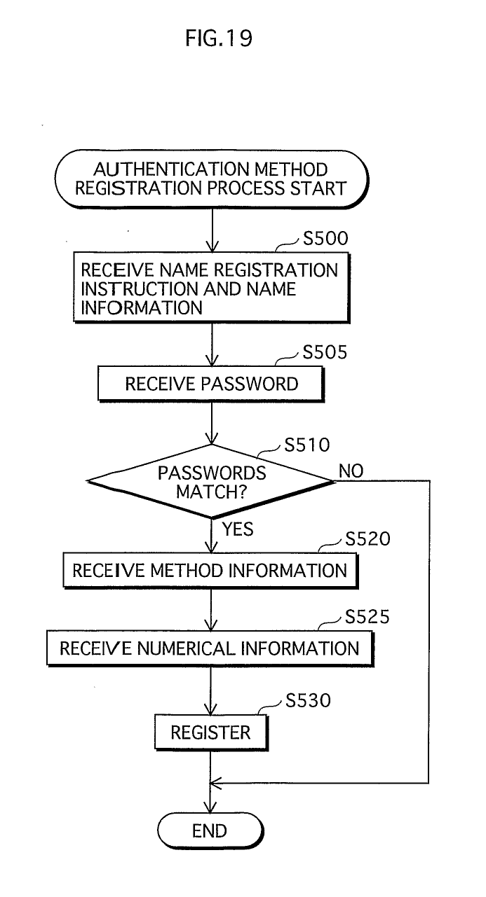

Here, the operation of the authentication method registration process will be described with reference to the flowchart shown in FIG. 19.

The control unit 107, upon receiving the name registration instruction and the name information from the input unit 105, temporarily stores the received name information (step S500).

The control unit 107 generates the password request information, outputs the generated password request information to the display unit 106, and then receives a password from the input unit 105 (step S505). The control unit 107 judges whether or not the received password matches a password stored in the password storage unit 103 (step S510). If the passwords do not match (“No” in step S510), the control unit 107 deletes the temporarily stored name information and ends the process.

If the passwords match (“Yes” in step S510), the control unit 107 generates the method request information, outputs the generated method request information to the display unit 106, and then receives the method information from the input unit 105 (step S520).

The control unit 107 generates the numerical value request information, outputs the generated numerical value request information to the display unit 106, and then receives the numerical information from the input unit 105 (step S525). The control unit 107 then writes the temporarily stored name information and a pair of the received method information and numerical information into the authentication standard code table T101 (step S530).

1.11 Operation of Authentication Process

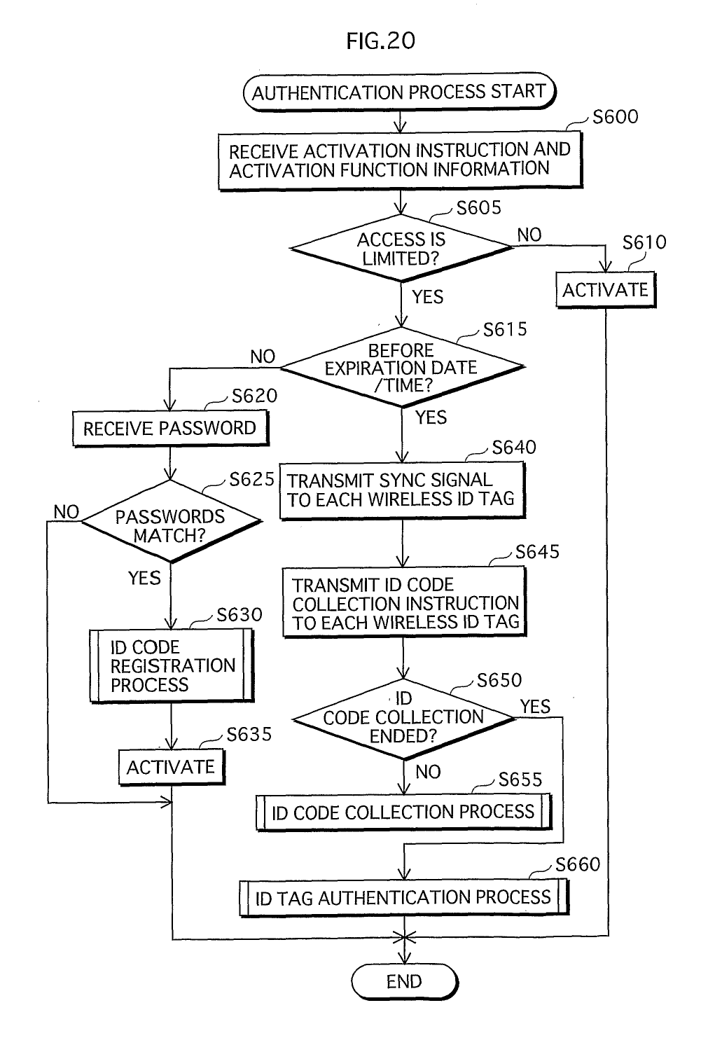

Here, the operation of authentication process will be described with reference to the flowchart shown in FIG. 20.

The control unit 107, upon receiving the activation instruction and the activation function information from the input unit 105 (step S600), judges whether or not the access by the user to the function corresponding to the received activation function information is limited (step S605).

If it judges that the access by the user to the function is not limited (“No” in step S605), the control unit 107 activates the function indicated by the received activation function information (step S610).

If it judges that the access is limited (“Yes” in step S605), the control unit 107 acquires the expiration date/time stored in the expiration date information storage unit 203 and the current date/time from the clock unit 108, and judges whether or not the current date/time is before the expiration date/time (step S615).

If it judges that the current date/time is not before the expiration date/time (“No” in step S615), the control unit 107 generates the password request information, outputs the generated password request information to the display unit 106, then receives a password from the input unit 105 (step S620), and judges whether or not the received password matches the password stored in the password storage unit 103 (step S625). If the passwords do not match (“No” in step S625), the control unit 107 does not activate the function indicated by the received activation function information, and ends the process. If the passwords match (“Yes” in step S625), the control unit 107 performs the ID code registration process shown in FIG. 14 and re-registers the ID code (step S630), and activates the function indicated by the received activation function information (step S635).

If it judges that the current date/time is before the expiration date/time (“Yes” in step S615), the control unit 107 outputs the ID code read start instruction to the reading control unit 142 of the tag reading unit 109. Upon receiving the ID code read start instruction, the reading control unit 142 outputs the sync signal transmission instruction in the sync signal transmission period, and generates and outputs a sync signal wave. Upon receiving the sync signal transmission instruction from the reading control unit 142, the instruction generating unit 143 generates a pulse signal wave based on the received sync signal transmission instruction, and outputs the generated pulse signal wave to the modulation/demodulation unit 146. The modulation/demodulation unit 146 changes the amplitude of a carrier wave based on the received pulse signal wave, and outputs the carrier wave with the changed amplitude to the antenna unit 147. The antenna unit 147 radiates the received carrier wave into the air as a radio wave. The control unit 315 receives the sync signal transmission instruction via the antenna unit 302, the demodulation unit 312, and the instruction decoding unit 314, further receives a sync signal wave, extracts a sync signal, and generates a sync signal wave that includes repeatedly a sync signal that synchronizes with the extracted sync signal (step S640).

The reading control unit 142 outputs the ID code collection instruction. The instruction generating unit 143 generates a pulse signal wave based on the received ID code collection instruction, and outputs the generated pulse signal wave to the modulation/demodulation unit 146. The modulation/demodulation unit 146 changes the amplitude of a carrier wave based on the received pulse signal wave, and outputs the carrier wave with the changed amplitude to the antenna unit 147. The antenna unit 147 radiates the received carrier wave into the air as a radio wave. The control unit 315 receives the ID code collection instruction via the antenna unit 302, the demodulation unit 312, and the instruction decoding unit 314 (step S645).

The reading control unit 142 monitors the progress of the three-second ID code collection period (step S650), and in the three-second ID code collection period, performs the ID code collection process shown in FIGS. 15 and 16 (step S655).

After the ID code collection period passes over (“Yes” in step S650), the reading control unit 142 determines that the ID code collection process ended, and outputs the ID code read completion instruction to the control unit 107. Upon receiving the ID code read completion instruction, the control unit 107 performs the ID tag authentication process to authenticate the user, and if the authenticity of the user is certified by the authentication, activates the function indicated by the received activation function information (step S660).

1.12 Operation of ID Tag Authentication Process

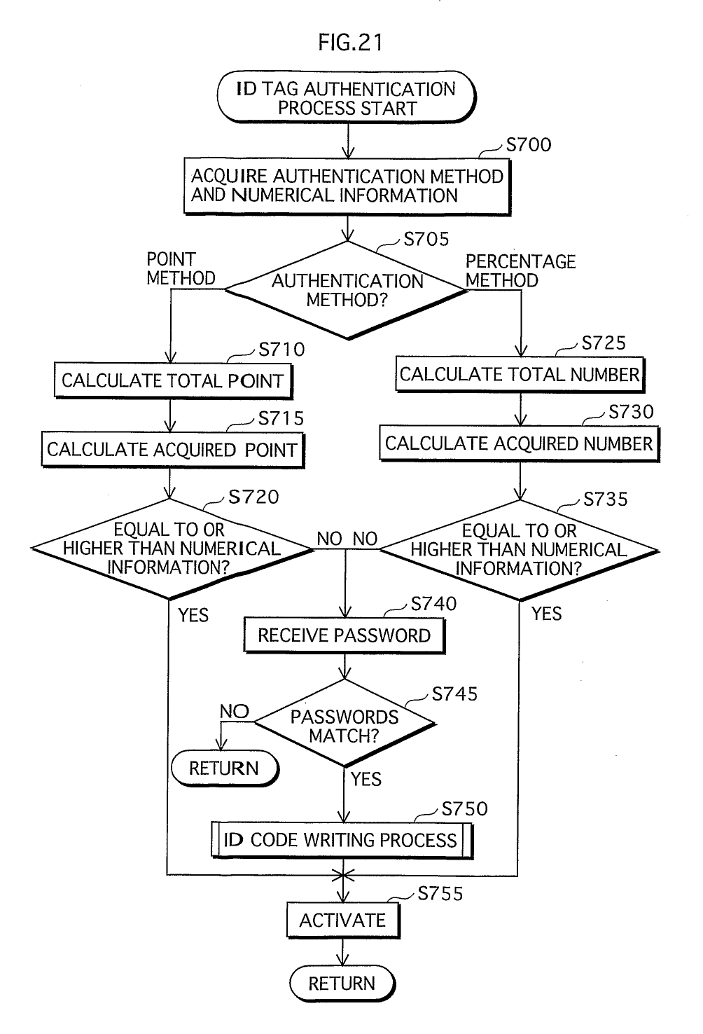

Here, the operation of ID tag authentication process will be described with reference to the flowchart shown in FIG. 21.

If the reading control unit 142 determines that the ID code collection process ended, the reading control unit 142 outputs the ID code read completion instruction to the control unit 107. Upon receiving the ID code read completion instruction, the control unit 107 acquires, from the authentication standard code table T101, the authentication method and the numerical information corresponding to the function name indicated by the received activation function information (step S700). The control unit 107 then judges whether or not the received authentication method is the point method or the percentage method (step S705).

If it judges that the received authentication method is the point method in step S705, the control unit 107 calculates total points by adding up the points for all the ID codes stored in the ID tag information storage unit 202 (step S710). The control unit 107 further calculates acquired points by adding up the points for the ID codes that match the ID codes stored in the received information storage unit 104 (step S715). The control unit 107 calculates a ratio of the acquired points to the total points, and judges whether or not the calculated ratio is equal to or higher than the value indicated by the acquired numerical information (step S720). If it judges that the calculated ratio is equal to or higher than the value indicated by the numerical information (“Yes” in step S720), the control unit 107 activates the function indicated by the received activation function information (step S755). If it judges that the calculated ratio is lower than the value indicated by the numerical information (“No” in step S720), the control unit 107 generates the password request information, outputs the generated password request information to the display unit 106, then receives a password from the input unit 105 (step S740), and judges whether or not the received password matches the password stored in the password storage unit 103 (step S745). If the passwords do not match (“No” in step S745), the control unit 107 does not activate the function indicated by the received activation function information, and ends the process. If the passwords match (“yes” in step S745), the control unit 107 performs the ID code writing process shown in FIG. 17 (step S750), registers the ID code, and then activates the function indicated by the received activation function information (step S755).

If it judges that the received authentication method is the percentage method in step S705, the control unit 107 calculates the total number of ID codes stored in the ID tag information storage unit 202 (step S725). The control unit 107 further calculates the number of acquired ID codes, the number being equal to the number of ID codes that match the ID codes stored in the received information storage unit 104 (step S730). The control unit 107 calculates a ratio of the number of acquired ID codes to the total number of ID codes, and judges whether or not the calculated ratio is equal to or higher than the value indicated by the acquired numerical information (step S735). If it judges that the calculated ratio is equal to or higher than the value indicated by the numerical information (“Yes” in step S735), the control unit 107 activates the function indicated by the received activation function information (step S755). If it judges that the calculated ratio is lower than the value indicated by the numerical information (“No” in step S735), the control unit 107 performs the above-described step S740 and onwards.

1.13 Modifications of Embodiment 1

The above-described Embodiment 1 is one example as an embodiment of the present invention. The present invention is not limited to the embodiment, but may be modified in various manners for achieving the theme, for example, as follows.

(1) In the above-described embodiment, it is confirmed during an authentication process whether or not a registered ID code has expired. However, not limited to this, the following is possible. That is to say, the confirmation on whether or not a registered ID code has expired may be performed when the authentication recording medium 20 is inserted in the user terminal 10. This is achieved, for example, as follows. The user terminal 10 is provided with a detection unit that detects whether or not an authentication recording medium 20 has been inserted in the user terminal 10. Upon detection of the insertion of the authentication recording medium therein, the user terminal 10 confirms whether or not the ID code of the authentication recording medium 20 has expired. If it judges that the ID code has expired, the user terminal 10 performs the process shown in FIG. 13 and registers the ID code. If it judges that the ID has not expired, the user terminal 10 does not register the ID code. In doing this, if the power of the user terminal 10 is switched from OFF to ON while the authentication recording medium 20 is inserted in the user terminal 10, the detection unit judges that the authentication recording medium 20 has been inserted in the user terminal 10.

The user terminal 10 may not register an ID code and a point value as soon as it judges that the ID code has expired, but may register them when it receives a request to use a function for which the access by the user is limited. This is achieved, for example, as follows. The user terminal 10 is provided with a registration designation information storage unit that stores information designating whether or not an ID code needs to be registered. If the user terminal 10 judges that the ID code has expired, the user terminal 10 stores, into the registration designation information storage unit, information designating that an ID code needs to be registered; and if the user terminal 10 judges that the ID code has not expired, the user terminal 10 stores, into the registration designation information storage unit, information designating that it is not necessary to register an ID code. The authentication in this modification is performed as follows. In step S615 of FIG. 20, instead of judging whether or not the current date/time is before the expiration date/time, the information stored in the registration designation information storage unit is referred to, and if the registration designation information storage unit stores the information designating that an ID code needs to be registered, the control unit 107 performs steps S620-S635, and if the registration designation information storage unit stores the information designating that it is not necessary to register an ID code, the control unit 107 performs step S640 and onwards. The registration designation information storage unit may be provided in the authentication recording medium 20.

(2) In the above-described embodiment, there is an upper limit to the number of ID codes to be registered with the authentication recording medium 20. However, not limited to this, the following is possible.

All the ID codes read from each wireless ID tag may be registered, without setting an upper limit to the number of ID codes to be registered. This can be achieved by changing the ID code writing process as follows: after execution of step S305 of FIG. 17, step S340 and onwards are executed.

Alternatively, in the case where no upper limit is set to the number of ID codes to be registered with the authentication recording medium 20, at least one of (i) refining by priority level, (ii) refining by point value, and (iii) individual registration process may be performed.

(3) In the above-described embodiment, an upper limit to the number of ID codes to be registered with the authentication recording medium 20 is stored in the number of registrations information storage unit 132 in advance. However, not limited to this, the following is possible.

The number of registrations information storage unit 132 may not have stored an upper limit in advance when the user terminal is purchased, and after purchasing it, the user may set (and then change) the upper limit. Alternatively, the number of registrations information storage unit 132 may have stored an upper limit in advance when the user terminal is purchased, and after purchasing it, the user may change the upper limit.

(4) In the above-described embodiment, refining is done by priority levels, points, or the individual registration process. However, not limited to these, refining may be done by the following method, for example.

The distance between the user terminal 10 and each wireless ID tag is measured. It is judged for each wireless ID tag whether or not the measured distance is equal to or smaller than a predetermined distance (for example, 0.5 m). The sets of an ID code, a priority level, and a point value to be registered are then narrowed down to those of wireless ID tags that are remote from the user terminal 10 by a distance equal to or smaller than the predetermined distance.

The judgment on whether or not the distance between a wireless ID tag and the user terminal 10 is equal to or smaller than the predetermined distance is made as follows. The reading control unit 142 measures a response time (that is, for example, a duration between a transmission of the ID code response instruction and a reception of the ID code match instruction) between the user terminal 10 and a wireless ID tag, using the clock unit 108, and stores the measurement result in the received information storage unit 104 with indication of a correspondence with an ID code. The control unit 107 stores in advance a communication speed of the wireless ID tags (for example, 15 sec/byte that is an intermediate value of the above-indicated communication speeds). The control unit 107 calculates the distance between the user terminal 10 and the wireless ID tag using the response time stored in the received information storage unit 104, and using the communication speed of the wireless ID tag, and then judges whether or not the calculated distance is equal to or smaller than the predetermined distance.

As another method for judging whether or not a distance between the user terminal 10 and a wireless ID tag is equal to or smaller than the predetermined distance, the electric field strength, which indicates the strength of a radio wave during a response, may be used. With this method, the reading control unit 142 measures the electric field strength during a response between the user terminal 10 and a wireless ID tag (for example, a duration between a transmission of the ID code response instruction and a reception of the ID code match instruction), and stores the measurement result in the received information storage unit 104 with indication of a correspondence with an ID code. The control unit 107 stores in advance the output power of the wireless ID tags. The control unit 107 calculates the distance between the user terminal 10 and the wireless ID tag using the field intensity stored in the received information storage unit 104, and using the output power of the wireless ID tag, and then judges whether or not the calculated distance is equal to or smaller than the predetermined distance.

(5) In the above-described embodiment, when an ID code is registered, refining is done by priority levels, points, or the individual registration process. However, not limited to these, the following is possible.

The control unit 107 may select, at random, ID codes from one or more ID codes stored in the received information storage unit 104, and register the selected ID codes with the ID tag information storage unit 202 of the authentication recording medium 20, together with corresponding point values.

(6) In the above-described embodiment, among the ID codes stored in the information storage areas in the received information storage unit 104, the ID codes overlapping each other are subtracted by a predetermined value, in terms of the points. However, not limited to this, the following is possible. Regarding the ID codes overlapping each other, the priority levels may be subtracted by a predetermined value (for example, “2”), and the priority levels after the subtraction may be stored in correspondence with the ID codes.

(7) The present invention may be achieved as a combination of the above-descried embodiment and any of the above-descried modifications.

1.14 Summary of Embodiment 1

As described above, in the authentication system 1, when a user requests to use a function of the user terminal 10 for which the access by the user is limited, the user terminal 10 first performs authentication using ID codes acquired from wireless ID tags embedded in objects (clothes, paper moneys, authentication cards or the like) worn or carried by the user, and if the authenticity of the user is not certified by the authentication, the user terminal 10 receives a password and performs an authentication using the received password. With this arrangement, if the authenticity of the user is not certified by the authentication by the ID codes, the user can be authenticated without repeating the procedures for the authentication. Also, when it receives an instruction to activate a function for which the access by the user is limited, the authentication system 1 first performs authentication using wireless ID codes. This eliminates the user having to input a password each time he/she tries to use a function for which the access by him/her is limited, which facilitates the user. Further, even if the user terminal 10 is lost or stolen, a function for which the access by the user is limited cannot be used unless the authenticity of the user is certified by the authentication using wireless ID tags or the authentication using passwords. This prevents the function for which the access by the user is limited from being used.

Also, when the authenticity of the user is certified by the authentication using passwords, the authentication system 1 re-registers the ID codes and point values using the ID codes collected in the authentication by the ID codes, and activates the function for which the access by the user is limited, as requested by the user. This eliminates the user having to stop designating the activation of the function so as to register the ID codes and point values from the start, thus enabling the user to update the contents of registration easily.

Also, the authentication system 1 has a standard value used in judging the authenticity of the user by the ID codes. With this arrangement, even if the acquired ID codes do not completely match the ID codes having been registered beforehand due to a failure to communicate with all the wireless ID tags due to, for example, a large distance between some wireless ID tags and the user terminal 10, or inappropriate intensity levels of the radio waves during the communication, the authentication system 1 can certify the authenticity of the user by confirming that the standard value is satisfied.

Also, when registering an ID code, the authentication system 1 can perform refining by priority level, refining by point value, or individual registration in which it registers only the ID codes that are instructed by the user to register. This makes it possible for unnecessary ID tags to be excluded during the authentication. For example, if the user terminal 10 reads an ID code from a wireless ID tag attached to a table near the user during the ID code registration process, the authentication system 1 excludes the ID code read from the wireless ID tag attached to the table.

Also, the authentication system 1 uses, for the authentication by the wireless ID tags, the wireless ID tags embedded in objects worn or carried by the user. Each user can be identified uniquely by the combination of the wireless ID tags embedded in objects worn or carried by the user. This enables the authentication system 1 to authenticate the user correctly. And in conventional authentication systems, the user always needs to remind himself/herself that he/she is carrying a wireless ID tag necessary for the authentication. In contrast, in the above-described authentication system 1, the user does not need to be aware that he/she is carrying a wireless ID tag since wireless ID tags are embedded in objects worn or carried by the user.

### 2. Embodiment 2

The following describes an authentication system 1A in an embodiment of the present invention.

2.1 Outline of Authentication System 1A

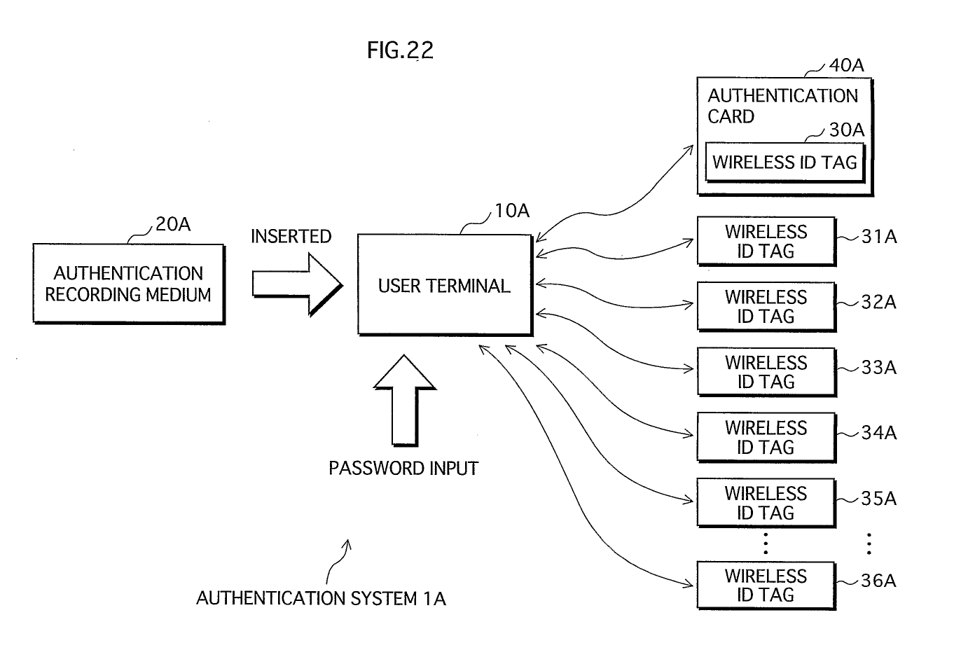

The authentication system 1A includes, as shown in FIG. 22, a user terminal 1A, an authentication recording medium 20A, wireless ID tags 31A, 32A, 33A, 34A, 35A, . . . 36A, and an authentication card 40A. The wireless ID tags 31A, 32A, 33A, 34A, 35A, . . . 36A are embedded in clothes, accessories, paper moneys or the like users wear or carry. The wireless ID tag 30A is embedded in the authentication card 40A. The authentication recording medium 20A is inserted into the user terminal 10A for use.

In the authentication system 1A, each wireless ID tag stores an ID code for identifying itself, and has an area for storing data received from the user terminal 10A. The user terminal 10A transmits authentication data in advance only to wireless ID tags required in authentication using ID tags, and also writes the authentication data into the authentication recording medium 20A. Each piece of authentication data is composed of 32 bits, and is assigned to a different wireless ID tag. That is to say, the wireless ID tags required for authentication correspond to different pieces of authentication data, respectively.

In the authentication system 1A, when a user requests to use a function of the user terminal 10A for which the access by the user is limited, the user terminal 10A reads the authentication data from the wireless ID tags 31, 32, 33, 34, 35, . . . 36, performs an authentication using the read authentication data and the authentication data that has been registered with the authentication recording medium 20A beforehand, and if the authenticity of the user is certified by the authentication, activates the function for which the access by the user is limited. If the authenticity of the user is not certified by the authentication, the user terminal 10A performs an authentication using a password, and if the authenticity of the user is certified by the authentication, activates the function.

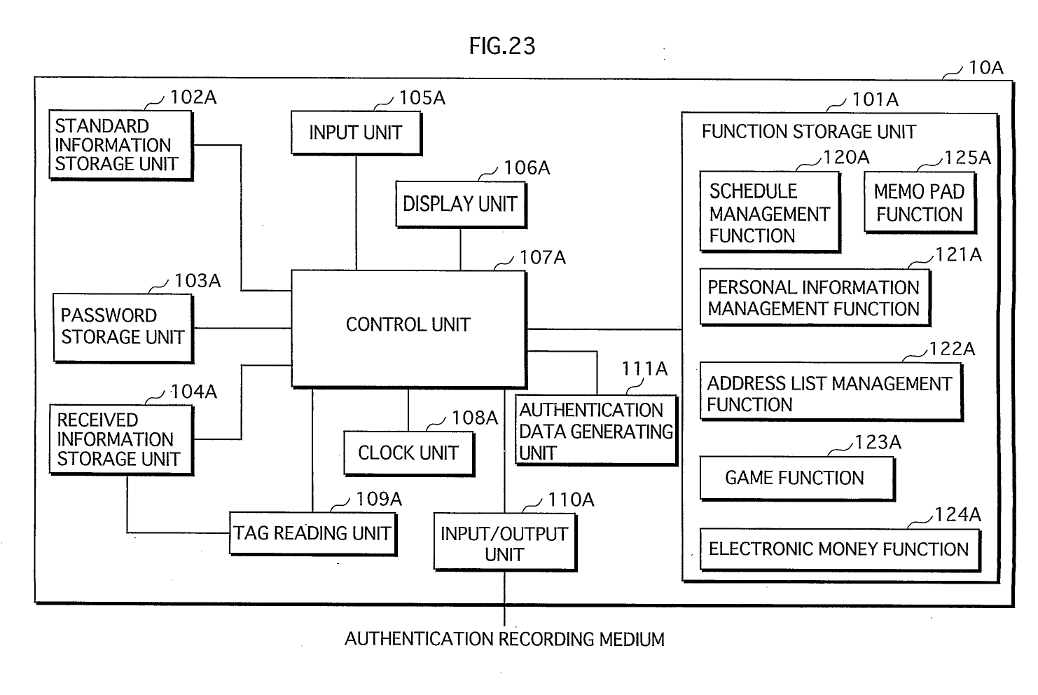

2.2 User Terminal 10A The construction of the user terminal 10A will be described. The user terminal 10A, as shown in FIG. 23, includes a function storage unit 101A, a standard information storage unit 102A, a password storage unit 103A, a received information storage unit 104A, an input unit 105A, a display unit 106A, a control unit 107A, a clock unit 108A, a tag reading unit 109A, an input/output unit 110A, and an authentication data generating unit 111A.

The user terminal 10A is more specifically a computer system including a microprocessor, a ROM, a RAM, a hard disk unit, a display unit and the like. A computer program is recorded in the ROM or the hard disk unit. The user terminal 10A achieves its functions as the microprocessor operates in accordance with the computer program.

The user terminal 10A is, for example, a PDA (Personal Digital Assistant).

(1) Function Storage Unit 101A

The function storage unit 101A, as shown in FIG. 23, includes a schedule management function 120A, a personal information management function 121A, an address list management function 122A, a game function 123A, an electronic money function 124A, and a memo pad function 125A.

These functions are the same as those stored in the function storage unit 101 in Embodiment 1, and the description thereof is omitted here.

(2) Standard Information Storage Unit 102A

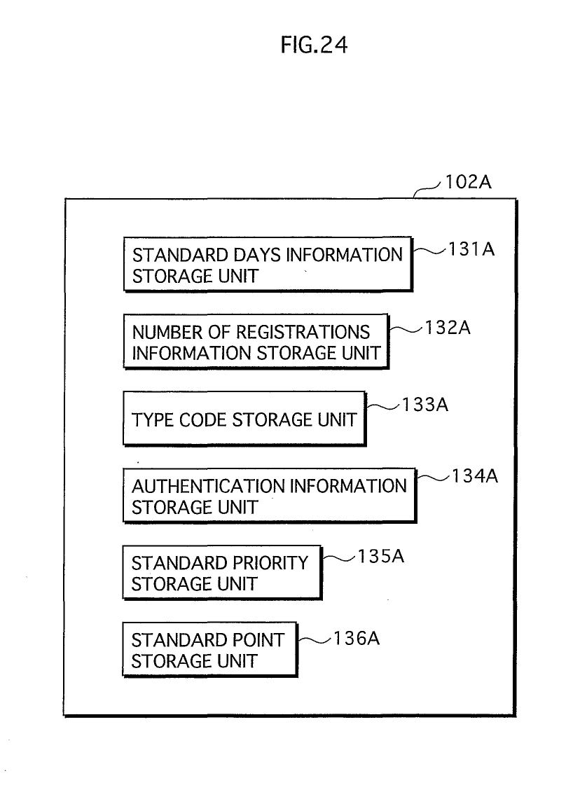

The standard information storage unit 102A, as shown in FIG. 24, includes a standard days information storage unit 131A, a number of registrations information storage unit 132A, a type code storage unit 133A, an authentication information storage unit 134A, a standard priority storage unit 135A, and a standard point storage unit 136A.

(A) Standard Days Information Storage Unit 131A

The standard days information storage unit 131A is the same as the standard days information storage unit 131 described in Embodiment 1, and the description thereof is omitted.

(B) Number of Registrations Information Storage Unit 132A

The number of registrations information storage unit 132A is the same as the number of registrations information storage unit 132 described in Embodiment 1, and the description thereof is omitted.

(C) Type Code Storage Unit 133A

The type code storage unit 133 A is the same as the type code storage unit 133 described in Embodiment 1, and the description thereof is omitted.

It should be noted here that in the following description, explanation with reference to the type code table T100 shown in FIG. 4 will be given when the necessity arises.

(D) Authentication Information Storage Unit 134A The authentication information storage unit 134A is the same as the authentication information storage unit 134 described in Embodiment 1, and the description thereof is omitted.

It should be noted here that in the following description, explanation with reference to the authentication standard code table T100 shown in FIG. 5 will be given when the necessity arises.

(E) Standard Priority Storage Unit 135A

The standard priority storage unit 135A is the same as the standard priority storage unit 135 described in Embodiment 1, and the description thereof is omitted.

(F) Standard Point Storage Unit 136A

The standard point storage unit 136A is the same as the standard point storage unit 136 described in Embodiment 1, and the description thereof is omitted.

(3) Password Storage Unit 103A

The password storage unit 103A is the same as the password storage unit 103 described in Embodiment 1, and the description thereof is omitted.

(4) Received Information Storage Unit 104A

The received information storage unit 104A includes 50 information storage areas each of which stores a set of an ID code that was read from one of the wireless ID tags 30A, 31A, 32A, 33A, 34A, 35A, . . . 36A during an ID tag authentication, and a name, a priority level, a point, and authentication data that correspond to the read ID code.

(5) Clock Unit 108A

The clock unit 108 is a clock that measures time.

(6) Input Unit 105A

The input unit 105A, upon receiving from a user a designation to start to register authentication data, outputs an authentication data registration instruction, which instructs to register the authentication data, to the control unit 107A.

The input unit 105A also receives a password from a user, and outputs the received password to the control unit 107A.

Upon receiving from a user a designation to write authentication data corresponding to an ID code displayed by the display unit 106A, the input unit 105A outputs a registration instruction, which instructs to register the authentication data corresponding to the displayed ID code, to the control unit 107A. Upon receiving from a user a designation not to write authentication data corresponding to an ID code displayed by the display unit 106A, the input unit 105A outputs a no-registration instruction, which instructs not to register the authentication data corresponding to the displayed ID code, to the control unit 107A.

Upon receiving from a user a designation to register a function for which the access by the user is limited, or a designation to change the contents of registration of a function for which the access by the user is limited, the input unit 105A, as is the case with the input unit 105 in Embodiment 1, generates name information, and outputs a name registration instruction and the generated name information to the control unit 107A.

As is the case with the input unit 105 in Embodiment 1, upon receiving method information from a user, the input unit 105A outputs the received method information to the control unit 107A. Also, upon receiving numerical information from a user, the input unit 105A outputs the received numerical information to the control unit 107A.

As is the case with the input unit 105 in Embodiment 1, upon receiving from a user a designation to activate a function stored in the function storage unit 101A, the input unit 105A generates activation function information, and outputs an activation instruction and the generated activation function information to the control unit 107A.

The input unit 105A also receives, as is the case with the input unit 105 in Embodiment 1, a designation or information in relation to the activated function. Upon receiving such a designation, the input unit 105A outputs an instruction corresponding to the received designation to the control unit 107A. Upon receiving such information, the input unit 105A outputs the received information to the control unit 107A.

(7) Display Unit 106A

The display unit 106A is the same as the display unit 106 described in Embodiment 1, and the description thereof is omitted.

(8) Tag Reading Unit 109A

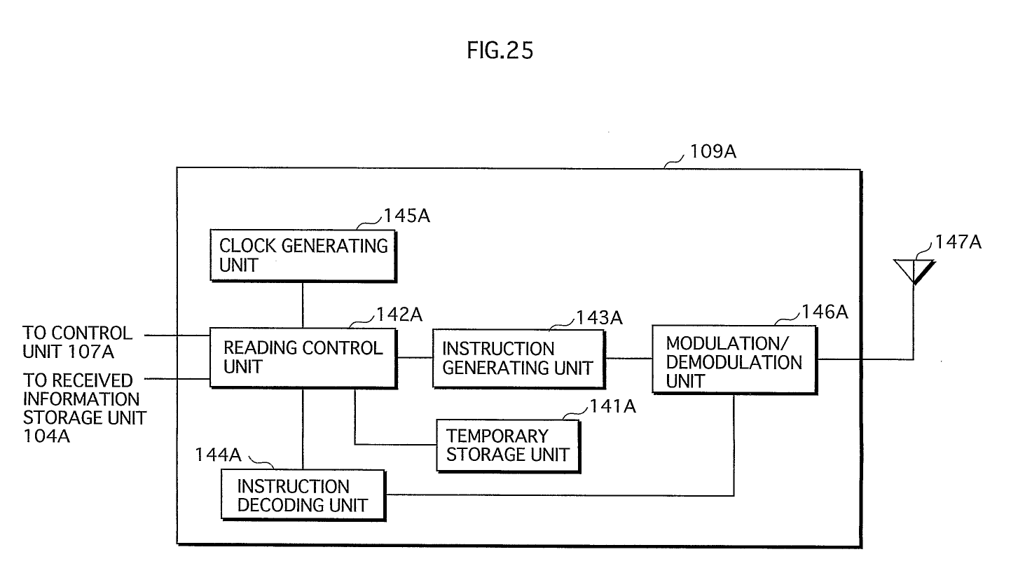

As is the case with the tag reading unit 109 in Embodiment 1, the tag reading unit 109A can read information in relation to up to 50 wireless ID tags in a same time period. As shown in FIG. 25, the tag reading unit 109A includes a temporary storage unit 141A, a reading control unit 142A, an instruction generating unit 143A, an instruction decoding unit 144A, a clock generating unit 145A, a modulation/demodulation unit 146A, and an antenna unit 147A.

(A) Temporary Storage Unit 141A

The temporary storage unit 141A includes 50 ID code areas each of which temporarily stores a pair of (i) an ID code for identifying a wireless ID tag and (ii) a piece of authentication data corresponding to the ID code.

(B) Reading Control Unit 142A

The reading control unit 142A controls writing authentication data into wireless ID tags and also controls reading authentication data from wireless ID tags.

<Writing Authentication Data>

The reading control unit 142A, upon receiving, from the control unit 107A, an ID code read start instruction to start reading ID codes of the wireless ID tags, reads ID codes from each wireless ID tag as in Embodiment 1, and writes the read ID codes into the received information storage unit 104A. It should be noted here that a name, a priority level, a point, and authentication data corresponding to the ID code have not been written in the received information storage unit 104A at this point in time.

After the ID code collection period of three seconds passes over, the reading control unit 142A outputs an ID code read completion instruction, which indicates that the reading of the ID code is completed, to the control unit 107A.

The reading control unit 142A, upon receiving, from the control unit 107A, an authentication data write start instruction to start writing authentication data into each wireless ID tag, outputs an ID code and authentication data stored in the received information storage unit 104A and the designation transmission instruction, which designates to write the authentication data, to the instruction generating unit 143A. After this, upon receiving the ID code and authentication data and the designation reception instruction, which indicates that the wireless ID tag wrote the authentication data, from the instruction decoding unit 144A, the reading control unit 142A outputs the next ID code and authentication data and the designation transmission instruction to the instruction generating unit 143A. The reading control unit 142A performs the above-described operation for each ID code stored in the received information storage unit 104A, namely as many times as the number of ID codes stored in the received information storage unit 104A.

Upon completion of the above-described operation, the reading control unit 142A outputs to the control unit 107A, a writing completion instruction that indicates that the writing of authentication data into each wireless ID code is completed.

<Control for Authentication>

The reading control unit 142A, upon receiving, from the control unit 107A, an authentication data read start instruction to start reading authentication data from each wireless ID tag, controls sync signal transmission and authentication data collection in the sync signal transmission period and the authentication data collection period, respectively. The authentication data collection period is divided into a third collection period and a fourth collection period. Each of the third and fourth collection periods is composed of an authentication data transmission period, an authentication data response period, and an authentication data match period. The authentication data transmission period, authentication data response period, and authentication data match period form one cycle of, for example, 500 msec.

One cycle is equally divided into 50 sections of 10 msec. Each section of 10 msec is referred to as channel. The 50 channels in one cycle are referred to as, in order of time, channel 1, channel 2, channel 3, . . . channel 50. The 50 channels are identified by the channel numbers.

<Outputting Instructions>

The reading control unit 142A, upon receiving an authentication data read start instruction from the control unit 107A, outputs to the instruction generating unit 143A (i) a sync signal transmission instruction to transmit a sync signal, and (ii) an authentication data collection instruction to collect authentication data of the wireless ID tags, in the stated order.

<Collecting Authentication Data>

After outputting the authentication data instruction to the instruction generating unit 143A, the reading control unit 142A collects the authentication data in the authentication data collection period of three seconds, as follows. After the authentication data collection period passes over, the reading control unit 142A determines that the authentication data of all the wireless ID tags have been collected, and ends the authentication data collection. As stated earlier, the authentication data collection period is divided into the third collection period and the fourth collection period, and in each of the third and fourth collection periods, the reading control unit 142A controls the authentication data transmission, authentication data response, and authentication data match. The reason why the authentication data collection is performed twice is the same as the reason for performing the ID code collection twice.

The reading control unit 142A receives the authentication data transmission instruction, an ID code, a channel number, and authentication data in the authentication data transmission period. Upon receiving the authentication data transmission instruction, the reading control unit 142A writes the received ID code and authentication data into an ID code area in the temporary storage unit 141A indicated by the received channel number.

The reading control unit 142A receives the standard clock from the clock generating unit 145A, and based on the received standard clock, generates a sync signal wave that repeatedly includes a sync signal composed of one pulse signal per 10 msec, and outputs the generated sync signal wave to the instruction generating unit 143A for 100 msec.

The reading control unit 142A selects a channel having the received channel number, and outputs the received authentication data and an authentication data response instruction, which instructs to transmit authentication data, to the instruction generating unit 143A in the authentication data response period using the selected channel.

The reading control unit 142A waits for the selected channel in the authentication data match period to come to receive the authentication data match instruction and authentication data from the instruction decoding unit 144A. Upon receiving the authentication data match instruction and authentication data from the instruction decoding unit 144A in the selected channel in the authentication data match period, the reading control unit 142A recognizes that an ID code and authentication data stored in an ID code area in the temporary storage unit 141A corresponding to the selected channel are a correct ID code and correct authentication data, and reads the ID code and ID code and authentication data from the ID code area in the temporary storage unit 141A, and writes the read ID code and ID code and authentication data into the received information storage unit 104A. It should be noted here that a name, a priority level, and a point value corresponding to the ID code have not been written at this point in time.

After the authentication data collection period of three seconds passes over, the reading control unit 142A outputs an authentication data read completion instruction, which indicates that the reading of the authentication data is completed, to the control unit 107A.

(C) Instruction Generating Unit 143A

The instruction generating unit 143A receives, from the reading control unit 142A, (i) the sync signal transmission instruction, (ii) the ID code collection instruction, (iii) a pair of the ID code response instruction and an ID code, (iv) a set of the designation transmission instruction, an ID code, and authentication data, (v) the authentication data collection instruction and (iv) a pair of the authentication data response instruction and authentication data.

The operation after the instruction generating unit 143A receives (i) the sync signal transmission instruction, (ii) the ID code collection instruction, or (iii) a pair of the ID code response instruction and an ID code is the same as the operation described in Embodiment 1, and the description thereof is omitted.

Upon receiving the designation transmission instruction, the authentication data collection instruction, or the authentication data response instruction from the reading control unit 142A, the instruction generating unit 143A generates a pulse signal wave based on the received instruction, and outputs the generated pulse signal wave to the modulation/demodulation unit 146A.

Upon receiving the designation transmission instruction, an ID code, and authentication data from the reading control unit 142A, the instruction generating unit 143A outputs a pulse signal wave in accordance with the designation response instruction, outputs a pulse signal wave in accordance with the received ID code, generates a pulse signal wave based on the received authentication data, and outputs the generated pulse signal wave to the modulation/demodulation unit 146A.

Upon receiving the authentication data response instruction and authentication data from the reading control unit 142A, the instruction generating unit 143A outputs a pulse signal wave in accordance with the authentication data response instruction, generates a pulse signal wave based on the received authentication data, and outputs the generated pulse signal wave to the modulation/demodulation unit 146A.

(D) Clock Generating Unit 145A

The clock generating unit 145A is the same as the clock generating unit 145 described in Embodiment 1, and the description thereof is omitted.

(E) Instruction Decoding Unit 144A

The instruction decoding unit 144A receives a pulse signal wave from the modulation/demodulation unit 146A. The instruction decoding unit 144A then decodes the received pulse signal wave and extracts an instruction and information from the pulse signal wave.

The instruction extracted by the instruction decoding unit 144A here is one of the ID code transmission instruction, the ID code match instruction, the designation reception instruction, the authentication data transmission instruction, and the authentication data match instruction.

The operation after the instruction decoding unit 144A receives the ID code transmission instruction or the ID code match instruction is the same as the operation described in Embodiment 1, and the description thereof is omitted.

If the extracted instruction is the designation reception instruction, the instruction decoding unit 144A extracts an ID code and authentication data as the information. The instruction decoding unit 144A outputs the extracted ID code and authentication data to the reading control unit 142A.

If the extracted instruction is the authentication data transmission instruction, the instruction decoding unit 144A extracts a channel number, an ID code, and authentication data as the information. The instruction decoding unit 144A outputs the extracted channel number, ID code, and authentication data to the reading control unit 142A.

If the extracted instruction is the authentication data match instruction, the instruction decoding unit 144A extracts authentication data as the information. The instruction decoding unit 144A outputs the extracted authentication data to the reading control unit 142A.

(F) Modulation/Demodulation Unit 146A

The modulation/demodulation unit 146A is the same as the modulation/demodulation unit 146 described in Embodiment 1, and the description thereof is omitted.

(G) Antenna Unit 147

The antenna unit 147A is the same as the antenna unit 147 described in Embodiment 1, and the description thereof is omitted.

(9) Control Unit 107A

The control unit 107A controls (i) registration of authentication data with the authentication recording medium 20A, (ii) registration of the authentication method, and (iii) the authentication.

<Authentication Data Registration Control>

The control unit 107A, upon receiving the authentication data registration instruction from the input unit 105A, generates the password request information, and outputs the generated password request information to the display unit 106A. The control unit 107A then receives a password from the input unit 105A, and judges whether or not the received password matches a password stored in the password storage unit 103A. If the passwords do not match, the control unit 107A stops the registration of the authentication data.

If the passwords match, the control unit 107A outputs the ID code read start instruction to the tag reading unit 109A.

Upon receiving the ID code read completion instruction from the tag reading unit 109A, the control unit 107A performs the following operations.

The control unit 107A instructs the authentication data generating unit 111A to generate authentication data, receives authentication data from the authentication data generating unit 111A, acquires, from the type code table T100 of the type code storage unit 133A, a name, a priority level, and a point value corresponding to the ID code stored in an information storage area in the received information storage unit 104A, and stores the received authentication data and the acquired name, priority level, and point value into the information storage area in the received information storage unit 104A in which the ID code is stored. This operation is performed for each ID code stored in the received information storage unit 104A.

The control unit 107A then confirms whether or not there are ID codes, among those stored in the information storage areas in the received information storage unit 104A, that overlap each other. If there are overlapping ID codes, the control unit 107A subtracts a predetermined value from each point value corresponding to the overlapping ID codes, and replaces the point values stored in the information storage areas with the point values after the subtraction. If there is no overlapping ID code, the point values are stored as they are. It should be noted here that if the subtraction results in “0” or lower, a value “1” is stored as the point value after the subtraction.

The control unit 107A then confirms whether or not the number of ID codes stored in the received information storage unit 104A is equal to or lower than an upper limit stored in the number of registrations information storage unit 132A.

If it judges that the number of ID codes stored in the received information storage unit 104A is equal to or lower than the upper limit, the control unit 107A deletes the contents of the ID tag information storage unit 202A in the authentication recording medium 20A, and writes authentication data stored in the received information storage unit 104A and a point value corresponding to the authentication data into the ID tag information storage, unit 202A via the input/output unit 110A. The control unit 107A performs the writing operation after the deletion of the contents of the ID tag information storage unit 202A, for each ID code stored in the received information storage unit 104A, namely as many times as the number of ID codes stored in the received information storage unit 104A. After this, the control unit 107A outputs the writing start instruction to the reading control unit 142A. Then, upon receiving the writing completion instruction from the reading control unit 142A, the control unit 107A acquires the current date/time from the clock unit 108A, and acquires the standard days “3” from the standard days information storage unit 131A. The control unit 107A calculates the expiration date/time using the acquired current date/time and standard days, and writes the calculated expiration date/time into the expiration date information storage unit 203A of the authentication recording medium 20A via the input/output unit 110A. The control unit 107 further deletes the contents of the received information storage unit 104A.

If it judges that the number of ID codes stored in the received information storage unit 104A is higher than the upper limit, the control unit 107A performs the refining by the priority level as in Embodiment 1, and judges again whether or not the number of ID codes stored in the received information storage unit 104A is equal to or lower than the upper limit stored in the number of registrations information storage unit 132A.

If it judges that the number of ID codes stored in the received information storage unit 104A is equal to or lower than the upper limit, the control unit 107A deletes the contents of the ID tag information storage unit 202A, and writes authentication data stored in the received information storage unit 104A and a point value corresponding to the authentication data into the ID tag information storage unit 202A via the input/output unit 110A. The control unit 107A performs the writing operation after the deletion of the contents of the ID tag information storage unit 202A, for each ID code stored in the received information storage unit 104A, namely as many times as the number of ID codes stored in the received information storage unit 104A. After this, the control unit 107A outputs the writing start instruction to the reading control unit 142A. Then, upon receiving the writing completion instruction from the reading control unit 142A, the control unit 107A calculates the expiration date/time, writes the calculated expiration date/time, and deletes the contents of the received information storage unit 104A, as described above.

If it judges that the number of ID codes stored in the received information storage unit 104A is higher than the upper limit, the control unit 107 performs the refining by the point value as in Embodiment 1, and judges again whether or not the number of ID codes stored in the received information storage unit 104A is equal to or lower than the upper limit stored in the number of registrations information storage unit 132A.

If it judges that the number of ID codes stored in the received information storage unit 104A is equal to or lower than the upper limit, the control unit 107A deletes the contents of the ID tag information storage unit 202A, and writes authentication data stored in the received information storage unit 104A and a point value corresponding to the authentication data into the ID tag information storage unit 202A via the input/output unit 110A. The control unit 107A performs the writing operation after the deletion of the contents of the ID tag information storage unit 202A, for each ID code stored in the received information storage unit 104A, namely as many times as the number of ID codes stored in the received information storage unit 104A. After this, the control unit 107A outputs the writing start instruction to the reading control unit 142A. Then, upon receiving the writing completion instruction from the reading control unit 142A, the control unit 107A calculates the expiration date/time, writes the calculated expiration date/time, and deletes the contents of the received information storage unit 104A, as described above. If it judges that the number of ID codes stored in the received information storage unit 104A is higher than the upper limit, the control unit 107A deletes the contents of the ID tag information storage unit 202A. The control unit 107A then reads an ID code and the name, point value, and authentication data corresponding to the ID code, from the received information storage unit 104A, and outputs the read ID code, name, point value, and the remaining number of registrations to the display unit 106A. It should be noted here that the initial value of the remaining number of registrations is set to the upper limit of the number of registrations. In this example, the initial value of the remaining number of registrations is “5”. The control unit 107A then receives the registration instruction or the no-registration instruction from the input unit 105A. Upon receiving the registration instruction, the control unit 107A writes a pair of the read authentication data and point value into the ID tag information storage unit 202A of the authentication recording medium 20A via the input/output unit 110A, subtracts “1” from the remaining number of registrations, and replaces the remaining number of registrations with the result of the subtraction. Upon receiving the no-registration instruction, the control unit 107A deletes the read ID code, and the name, point value, and authentication data corresponding to the ID code, from the received information storage unit 104A, and outputs the read ID code. The control unit 107A repeats the operation after the deletion of the contents of the ID tag information storage unit 202A until the remaining number becomes zero, or as many times as the number of ID codes stored in the received information storage unit 104A. When the number of pieces of authentication data registered with the ID tag information storage unit 202A has reached the upper limit, and if it judges that there is yet an ID code to read from the received information storage unit 104A, the control unit 107A deletes the ID code and the name, point value, and authentication data from the received information storage unit 104A. After this, the control unit 107A outputs the writing start instruction to the reading control unit 142A. Then, upon receiving the writing completion instruction from the reading control unit 142A, the control unit 107A calculates the expiration date/time, writes the calculated expiration date/time, and deletes the contents of the received information storage unit 104A, as described above.

<Authentication Method Registration Control>

The authentication method registration control is performed in the same manner as in Embodiment 1, and the description thereof is omitted.

<Authentication Control>

The control unit 107A, upon receiving the activation instruction and the activation function information from the input unit 105A, judges by referring to the authentication standard code table T101 in the authentication information storage unit 134A whether or not the access by the user to the function corresponding to the received activation function information is limited.

If it judges that the access is not limited, the control unit 107A activates the function indicated by the received activation function information.

If it judges that the access is limited, the control unit 107A acquires the expiration date/time stored in the expiration date information storage unit 203A in the authentication recording medium 20A and the current date/time from the clock unit 108A, and judges whether or not the current date/time is before the expiration date/time.

If it judges that the current date/time is not before the expiration date/time, the control unit 107A generates the password request information and outputs the generated password request information to the display unit 106A. The control unit 107A then receives a password from the input unit 105A, and judges whether or not the received password matches the password stored in the password storage unit 103A. If the passwords do not match, the control unit 107A does not activate the function indicated by the received activation function information. If the passwords match, the control unit 107A outputs the ID code read start instruction to the tag reading unit 109A, performs the same operations as it does after it outputs the ID code read start instruction in the above-described authentication data registration control, re-registers the authentication data, and after this, activates the function indicated by the received activation function information.

If it judges that the current date/time is before the expiration date/time, the control unit 107A outputs the authentication data read start instruction to the tag reading unit 109A. Upon receiving the authentication data read completion instruction from the tag reading unit 109A, the control unit 107A acquires, from the authentication standard code table T101 of the authentication information storage unit 134A, the authentication method and the numerical information corresponding to the function name indicated by the received activation function information. The control unit 107A then judges whether or not the received authentication method is the point method or the percentage method.

If it judges that the received authentication method is the point method, the control unit 107A calculates total points by adding up the points for all the pieces of authentication data stored in the ID tag information storage unit 202A in the authentication recording medium 20A. The control unit 107A further calculates acquired points by adding up the points for pieces of authentication data that match the authentication data stored in the received information storage unit 104A. The control unit 107A calculates a ratio of the acquired points to the total points, and judges whether or not the calculated ratio is equal to or higher than the value indicated by the numerical information acquired from the authentication standard code table T101 of the authentication information storage unit 134A. If it judges that the calculated ratio is equal to or higher than the value indicated by the numerical information, the control unit 107A activates the function indicated by the received activation function information. If it judges that the calculated ratio is lower than the value indicated by the numerical information, the control unit 107A generates the password request information and outputs the generated password request information to the display unit 106A. The control unit 107A then receives a password from the input unit 105A, and judges whether or not the received password matches the password stored in the password storage unit 103A. If the passwords do not match, the control unit 107A does not activate the function indicated by the received activation function information.

If the passwords match, the control unit 107A deletes the ID codes and authentication data from the received information storage unit 104A, and to re-register authentication data, outputs the ID code read start instruction to the tag reading unit 109A. After this, as in the above-described authentication data registration control, the control unit 107A registers authentication data and point values with the ID tag information storage unit 202A of the authentication recording medium 20A. After the registration, the control unit 107A activates the function indicated by the received activation function information.

If it judges that the received authentication method is the percentage method, the control unit 107A calculates the total number of ID codes stored in the ID tag information storage unit 202A. The control unit 107A further calculates the number of acquired pieces of authentication data, the number being equal to the number of pieces of authentication data that match the pieces of authentication data stored in the received information storage unit 104A. The control unit 107A calculates a ratio of the number of acquired pieces of authentication data to the total number of pieces of authentication data, and judges whether or not the calculated ratio is equal to or higher than the value indicated by the numerical information acquired from the authentication standard code table T101 of the authentication information storage unit 134A. If it judges that the calculated ratio is equal to or higher than the value indicated by the numerical information, the control unit 107A activates the function indicated by the received activation function information. If it judges that the calculated ratio is lower than the value indicated by the numerical information, the control unit 107A operates the same as it does when it judges that the calculated ratio with the point method is lower than the value indicated by the numerical information.

After it activates the function indicated by the activation function information received from the input unit 105A, the control unit 107A controls the activated function based on the instruction received from the input unit 105A regarding the activated function.

(10) Input/Output Unit 110A

The input/output unit 110A performs data input/output between the control unit 107A and the authentication recording medium 20A.

(11) Authentication Data Generating Unit 111A

The authentication data generating unit 111A, upon receiving an instruction to generate authentication data from the control unit 107A, generates authentication data and outputs the generated authentication data to the control unit 107A.

2.3 Authentication Recording Medium 20A

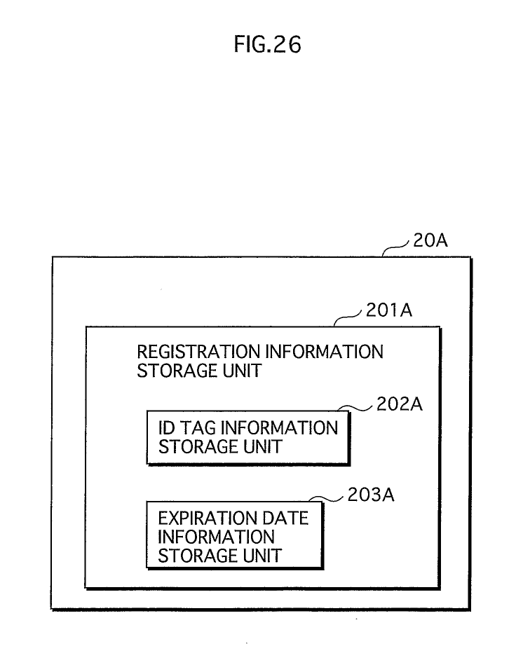

The authentication recording medium 20A is a portable recording medium, and as shown in FIG. 26, includes a registration information storage unit 201A, which include an ID tag information storage unit 202A and an expiration date information storage unit 203A.

(1) ID Tag Information Storage Unit 202A

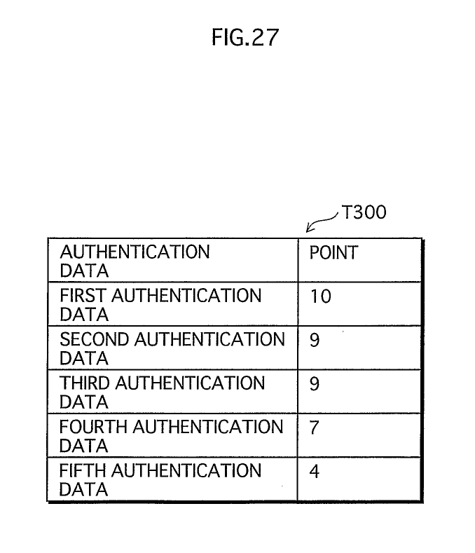

The ID tag information storage unit 202A includes an ID tag information table T300. FIG. 27 shows one example of the ID tag information table T300.

The ID tag information table T300 has storage areas that can store up to five pairs of a piece of authentication data and a point value.

In the table, each piece of authentication data is data that is generated by the user terminal 10A for each ID code for identifying a wireless ID tag, and has a point value corresponding thereto.

The pairs of a piece of authentication data and a point value are written to the table by the control unit 107A of the user terminal 10A. The ID tag information table T300 shown in FIG. 27 indicates a state after the data is written by the control unit 107A. Each piece of authentication data is, as stated earlier, composed of 32 bits. In the example shown in FIG. 27, the authentication data is referred to as the first to fifth authentication data, for the sake of convenience.

(2) Expiration Date Information Storage Unit 203A

The expiration date information storage unit 203A is the same as the expiration date information storage unit 203 described in Embodiment 1, and the description thereof is omitted. It should be noted here that the expiration date/time is written by the control unit 107A of the user terminal 10A.

2.4 Wireless ID Tag 30A

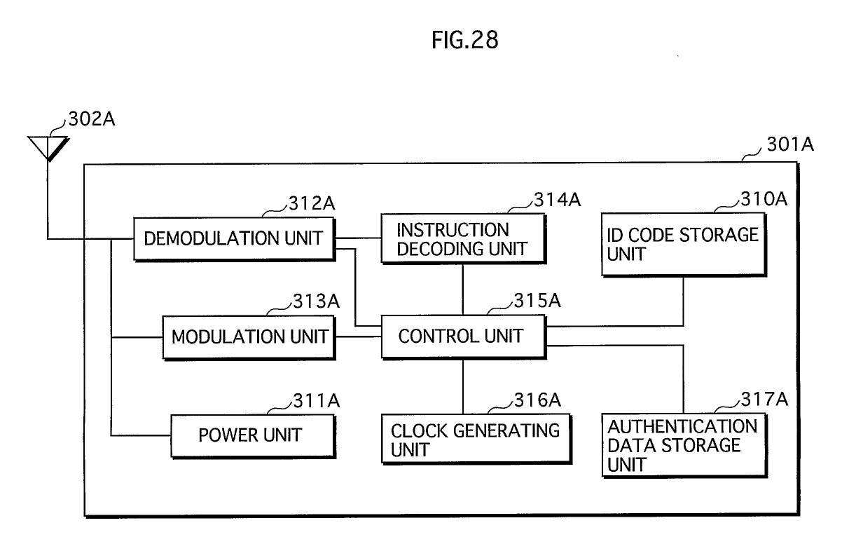

The wireless ID tag 30A is embedded in the authentication card 40A. As is the case with Embodiment 1, the wireless ID tag 30A is in a plate-like shape, and as shown in FIG. 28, includes an IC chip unit 301A and an antenna unit 302A.

The distance of communication for the wireless ID tag 30A is approximately within one meter, and the communication speed is 10-20 byte/msec. It is possible to read each of 50 or less stacked wireless ID tags 30 (multi-reading).

The wireless ID tag 30A is more specifically a computer system including a microprocessor, a ROM, a RAM and the like. A computer program is recorded in the ROM. The wireless ID tag 30A achieves its functions as the microprocessor operates in accordance with the computer program.

As shown in FIG. 28, the IC chip unit 301A includes an ID code storage unit 310A, a power unit 311A, a demodulation unit 312A, a modulation unit 313A, an instruction decoding unit 314A, a control unit 315A, a clock generating unit 316A, and an authentication data storage unit 317A. It should be noted here that the wireless ID tags 31A, 32A, 33A, 34A, 35A, . . . 36A have the same construction as the wireless ID tag 30A, and the description thereof is omitted.

(1) ID Code Storage Unit 310A

The ID code storage unit 310A stores ID codes for identifying each of the wireless ID tags 30A.

(2) Authentication Data Storage Unit 317A

The authentication data storage unit 317A has an area for storing a piece of authentication data.

(3) Power Unit 311A

The power unit 311A is the same as the power unit 311 described in Embodiment 1, and the description thereof is omitted.

(4) Demodulation Unit 312A

The demodulation unit 312A is the same as the demodulation unit 312 described in Embodiment 1, and the description thereof is omitted.

(5) Instruction Decoding Unit 314A

The instruction decoding unit 314A receives the pulse signal waves from the demodulation unit 312A, decodes the received pulse signal waves to extract instructions, and outputs the extracted instructions to the control unit 315A. The instructions extracted by the instruction decoding unit 314A include the sync signal transmission instruction, ID code collection instruction, ID code response instruction, designation transmission instruction, authentication data collection instruction, and authentication data response instruction.

If it extracts the ID code response instruction, the instruction decoding unit 314A further extracts an ID code as information, and outputs the extracted ID code to the control unit 315A.

If it extracts the designation transmission instruction, the instruction decoding unit 314A further extracts an ID code and authentication data as information, and outputs the extracted ID code and authentication data to the control unit 315A.

If it extracts the authentication data response instruction, the instruction decoding unit 314A further extracts authentication data as information, and outputs the extracted authentication data to the control unit 315A.

(6) Control Unit 315A

The control unit 315A receives instructions from the instruction decoding unit 314A. The instructions received from the instruction decoding unit 314A include the sync signal transmission instruction, ID code collection instruction, ID code response instruction, designation transmission instruction, authentication data collection instruction, and authentication data response instruction. If it receives the ID code response instruction, the control unit 315A further receives an ID code as information. If it receives the designation transmission instruction, the control unit 315A further receives an ID code and authentication data as information. If it receives the authentication data response instruction, the control unit 315A further receives authentication data as information.

Upon receiving the sync signal transmission instruction from the instruction decoding unit 314A, the control unit 315A operates in the same manner as the control unit 315 in Embodiment 1 after receiving the sync signal transmission instruction, and therefore the description is omitted here.

Upon receiving the ID code collection instruction from the instruction decoding unit 314A, the control unit 315A operates in the same manner as the control unit 315 in Embodiment 1 after receiving the ID code collection instruction, and therefore the description is omitted here.

Upon receiving the designation transmission instruction from the instruction decoding unit 314A, the control unit 315A further receives an ID code and authentication data, and judges whether or not the received ID code matches an ID code stored in the ID code storage unit 310A. If it judges that the received ID code matches an ID code stored in the ID code storage unit 310A, the control unit 315A writes the received authentication data into the authentication data storage unit 317A, and transmits the ID code, authentication data, and a designation reception instruction to the modulation unit 313A. If it judges that the received ID code does not match an ID code stored in the ID code storage unit 310A, the control unit 315A discards the received ID code and authentication data. It should be noted here that when the authentication data is written, the authentication data having been registered is overwritten with the received authentication data.

Upon receiving the authentication data collection instruction from the instruction decoding unit 314A, the control unit 315A judges whether or not there is authentication data in the authentication data storage unit 317A.

If it judges that there is authentication data in the authentication data storage unit 317A, the control unit 315A selects one numeral out of numerals “1” to “50” at random, reads an ID code from the ID code storage unit 310A, further reads authentication data from the authentication data storage unit 317A. The control unit 315A then selects a channel whose channel number matches the numeral selected at random, and outputs the read ID code and authentication data, the channel number of the selected channel, and the authentication data transmission instruction to the modulation unit 313A in the authentication data transmission period using the selected channel. Upon receiving the authentication data response instruction in the authentication data response period via the selected channel, the control unit 315A further receives authentication data, and compares the received authentication data with the authentication data read from the authentication data storage unit 317A. If the two pieces of authentication data match, the control unit 315A outputs the authentication data and the authentication data match instruction to the modulation unit 313A in the authentication data match period using the selected channel. If the two pieces of authentication data do not match, the control unit 315A repeats the above-descried operation, starting with the selection of one numeral out of numerals “1” to “50” at random.

If it judges that there is no authentication data in the authentication data storage unit 317A, the control unit 315A does not perform the operation.

(7) Modulation Unit 313A

The modulation unit 313A receives an instruction and information from the control unit 315A, generates a bit sequence composed of the received instruction and information, and changes the impedance of the antenna unit 302A in accordance with the bits (each of which represents “0” or “1”) contained in the generated bit sequence.

The instructions received from the control unit 315A include the ID code transmission instruction, the ID code match instruction, the designation reception instruction, the authentication data transmission instruction, and the authentication data match instruction. If it receives the ID code transmission instruction, the modulation unit 313A further receives a channel number and an ID code as information. If it receives the ID code match instruction, the modulation unit 313A further receives an ID code as information. If it receives the designation transmission instruction, the modulation unit 313A further receives an ID code and authentication data as information. If it receives the authentication data transmission instruction, the modulation unit 313A further receives a channel number, an ID code, and authentication data as information. If it receives the authentication data match instruction, the modulation unit 313A further receives authentication data as information.

(8) Clock Generating Unit 316A

The clock generating unit 316A generates the standard clock indicating the standard time, and outputs the generated standard clock to the control unit 315A.

(9) Antenna Unit 302A

The antenna unit 302A is the same as the antenna unit 302 described in Embodiment 1, and the description thereof is omitted.

2.5 Outline of Operation of Authentication Data Registration

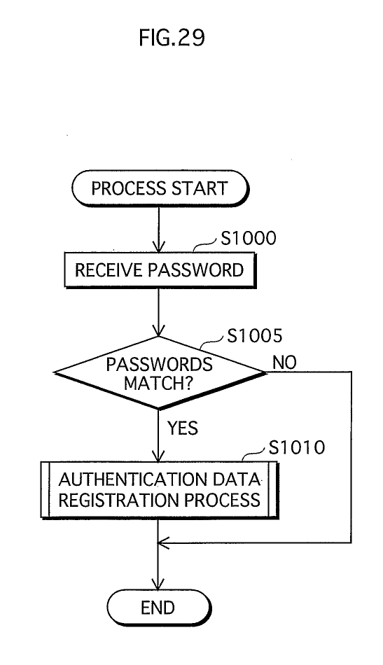

Here, an outline of the operation of registering authentication data with the ID tag information storage unit 202A of the authentication recording medium 20A will be described with reference to the flowchart shown in FIG. 29.

Upon receiving the authentication data registration instruction from the input unit 105A, the control unit 107A of the user terminal 10A outputs the password request information to the display unit 106A, and receives a password from the input unit 105A (step S1000).

The control unit 107A judges whether or not the received password matches a password stored in the password storage unit 103A (step S1005).

If the passwords match (“Yes” in step S1005), the authentication data registration process is executed between the user terminal 10A and the wireless ID tag. In the authentication data registration process, the authentication data and the a point value are registered with the ID tag information storage unit 202A of the authentication recording medium 20A, the authentication data is transmitted to the corresponding wireless ID tag, and the authentication data is registered with the wireless ID tag (step S1010).

If the passwords do not match (“No” in step S1005), the control unit 107A ends the process.

2.6 Operation of Authentication Data Registration Process

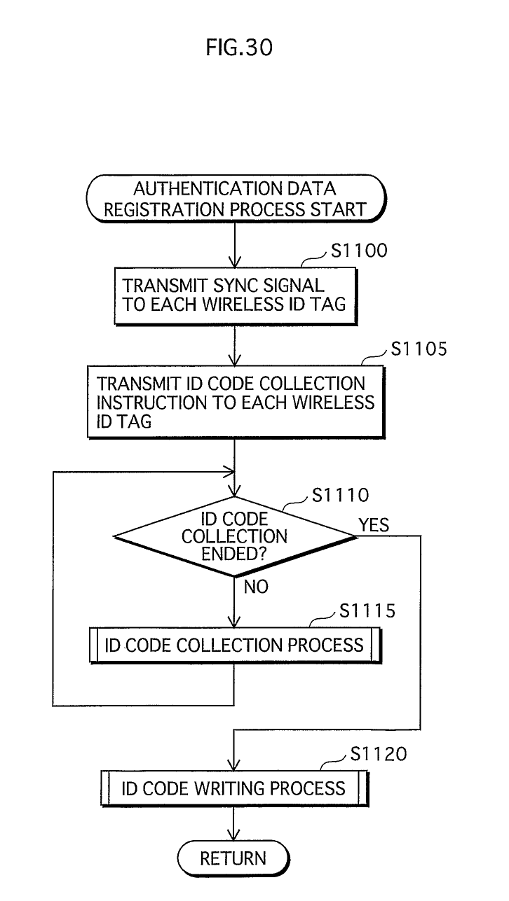

Here, the operation of the authentication data registration process will be described with reference to the flowchart shown in FIG. 30.

The control unit 107A outputs the ID code read start instruction to the reading control unit 142A of the tag reading unit 109A. Upon receiving the ID code read start instruction, the reading control unit 142A outputs the sync signal transmission instruction in the sync signal transmission period, and generates and outputs a sync signal wave. Upon receiving the sync signal transmission instruction from the reading control unit 142A, the instruction generating unit 143A generates a pulse signal wave based on the received sync signal transmission instruction, and outputs the generated pulse signal wave to the modulation/demodulation unit 146A. The modulation/demodulation unit 146A changes the amplitude of a carrier wave based on the received pulse signal wave, and outputs the carrier wave with the changed amplitude to the antenna unit 147A. The antenna unit 147A radiates the received carrier wave into the air as a radio wave. The control unit 315A receives the sync signal transmission instruction via the antenna unit 302A, the demodulation unit 312A, and the instruction decoding unit 314A, further receives a sync signal wave, extracts a sync signal, and generates a sync signal wave that includes repeatedly a sync signal that synchronizes with the extracted sync signal (step S1100).

The reading control unit 142A outputs the ID code collection instruction. The instruction generating unit 143A generates a pulse signal wave based on the received ID code collection instruction, and outputs the generated pulse signal wave to the modulation/demodulation unit 146A. The modulation/demodulation unit 146A changes the amplitude of a carrier wave based on the received pulse signal wave, and outputs the carrier wave with the changed amplitude to the antenna unit 147A. The antenna unit 147A radiates the received carrier wave into the air as a radio wave. The control unit 315A receives the ID code collection instruction via the antenna unit 302A, the demodulation unit 312A, and the instruction decoding unit 314A (step S1105).

The reading control unit 142A monitors the progress of the three-second ID code collection period (step S1110), and in the three-second ID code collection period (“No” in step S1110), performs the ID code collection process for collecting ID codes from each wireless ID tag (step S1115).

After the ID code collection period passes over (“Yes” in step S1110), the reading control unit 142A determines that the ID code collection process ended, and outputs the ID code read completion instruction to the control unit 107A. Upon receiving the ID code read completion instruction, the control unit 107A generates authentication data, and performs the authentication data writing process to register the authentication data with the ID tag information storage unit 202A (step S1120).

2.7 Operation of ID Code Collection Process

The operation of the ID code collection process is the same as the one shown in FIGS. 15 and 16, and therefore the description is omitted here.

2.8 Operation of Authentication Data Writing Process

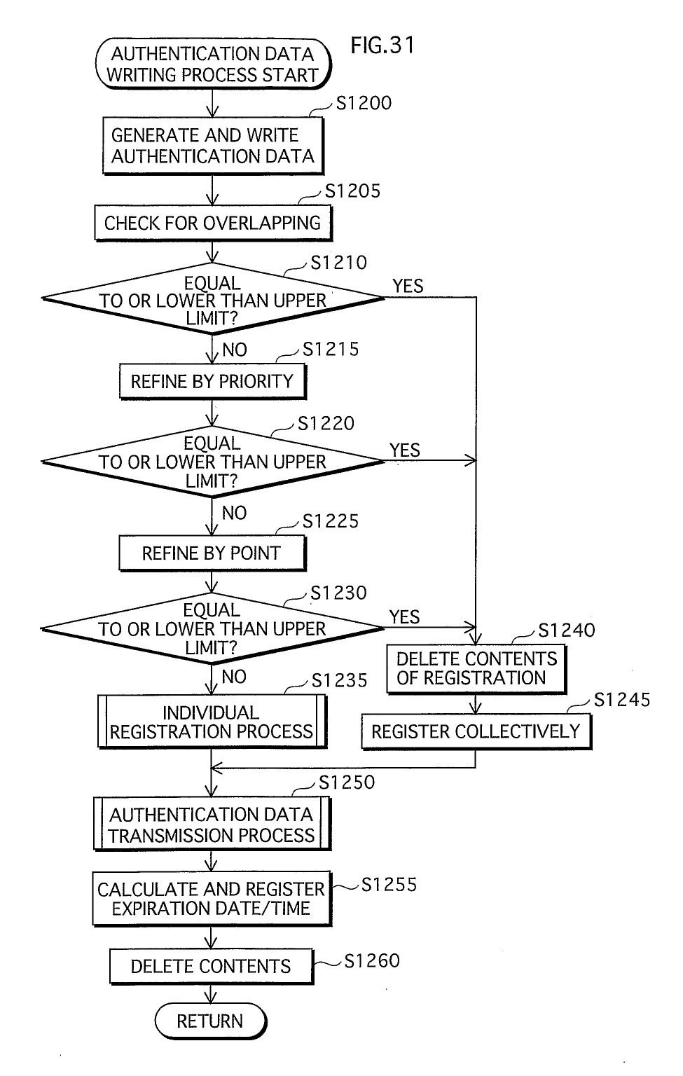

Here, the operation of authentication data writing process will be described with reference to the flowchart shown in FIG. 31.

The control unit 107A generates a piece of authentication data that corresponds to an ID code stored in an information storage area in the received information storage unit 104A, acquires, from the type code table T100 of the type code storage unit 133A, a name, a priority level, and a point value corresponding to the ID code, and stores the generated piece of authentication data, acquired name, priority level, and point value into the information storage area in the received information storage unit 104A in which the ID code is stored (step S1200). This operation is performed for each ID code stored in the received information storage unit 104A.

The control unit 107A then confirms whether or not there are ID codes, among those stored in the information storage areas in the received information storage unit 104A, that overlap each other. If there are overlapping ID codes, the control unit 107A subtracts a predetermined value from each point value corresponding to the overlapping ID codes, and replaces the point values stored in the information storage areas with the point values after the subtraction (step S1205).

The control unit 107A then confirms whether or not the number of ID codes stored in the received information storage unit 104A is equal to or lower than an upper limit “5” (step S1210).

If it judges that the number of ID codes stored in the received information storage unit 104A is equal to or lower than the upper limit “5” (“Yes” in step S1210), the control unit 107 performs steps S1240, S1245, S1250, S1255, and S1260 as will be described later.

If it judges that the number of ID codes stored in the received information storage unit 104A is higher than the upper limit “5” (“No” in step S1210), the control unit 107A compares the priority level of the ID code stored in the received information storage unit 104A with the standard priority level stored in the standard priority storage unit 135A. If the priority level is lower than the standard priority level, the control unit 107A deletes, from the received information storage unit 104A, the ID code, and the authentication data, name, priority level, and point value corresponding to the ID code (step S1215). The control unit 107A performs this operation for each piece of authentication data stored in the received information storage unit 104A.

The control unit 107A then judges for the second time whether or not the number of ID codes stored in the received information storage unit 104A is equal to or lower than the upper limit “5” (step S1220).

If it judges that the number of ID codes stored in the received information storage unit 104A is equal to or lower than the upper limit “5” (“Yes” in step S1220), the control unit 107A performs steps S1240, S1245, S1250, S1255, and S1260.

If it judges that the number of ID codes stored in the received information storage unit 104A is higher than the upper limit “5” (“No” in step S1220), the control unit 107A compares the point value of the ID code stored in the received information storage unit 104A with the standard point value stored in the standard point storage unit 136A. If the point value is lower than the standard point value, the control unit 107A deletes the ID code, and the authentication data, name, priority level, and point value corresponding to the ID code (step S1225). The control unit 107A performs this operation for each ID code stored in the received information storage unit 104A.

The control unit 107 judges again whether or not the number of ID codes stored in the received information storage unit 104A is equal to or lower than the upper limit “5” (step S1230).

If it judges that the number of ID codes stored in the received information storage unit 104A is equal to or lower than the upper limit “5” (“Yes” in step S1230), the control unit 107A deletes the registration contents of the ID tag information table T300 of the ID tag information storage unit 202A (step S1240), and writes authentication data stored in the received information storage unit 104A and a point value corresponding to the authentication data into the ID tag information storage unit 202A via the input/output unit 110A (step S1245). The control unit 107A performs this step for each piece of authentication data stored in the received information storage unit 104A, namely as many times as the number of pieces of authentication data stored in the received information storage unit 104A.

If it judges that the number of ID codes stored in the received information storage unit 104A is higher than the upper limit “5” (“No” in step S1230), the control unit 107A writes authentication data stored in the received information storage unit 104A and a point value corresponding to the authentication data into the ID tag information storage unit 202A if the user acknowledges the registration of the authentication data in an individual registration process (step S1235).

The control unit 107A outputs the writing start instruction to the reading control unit 142A. Upon receiving the writing start instruction, the reading control unit 142A performs the authentication data transmission process in which it transmits, to each wireless ID tag, the designation transmission instruction and the ID code and authentication data stored in the received information storage unit 104A, and each wireless ID tag registers the authentication data (step S1250).

After the authentication data transmission process, the reading control unit 142A outputs the writing completion instruction to the control unit 107A. Upon receiving the writing completion instruction, the control unit 107A acquires the current date/time from the clock unit 108A, acquires the standard days “3” from the standard days information storage unit 131A, calculates the expiration date/time using the acquired current date/time and standard days, and writes the calculated expiration date/time into the expiration date information storage unit 203A (step S1255).

The control unit 107A deletes the contents of the received information storage unit 104A (step S1260).

2.9 Individual Registration Process

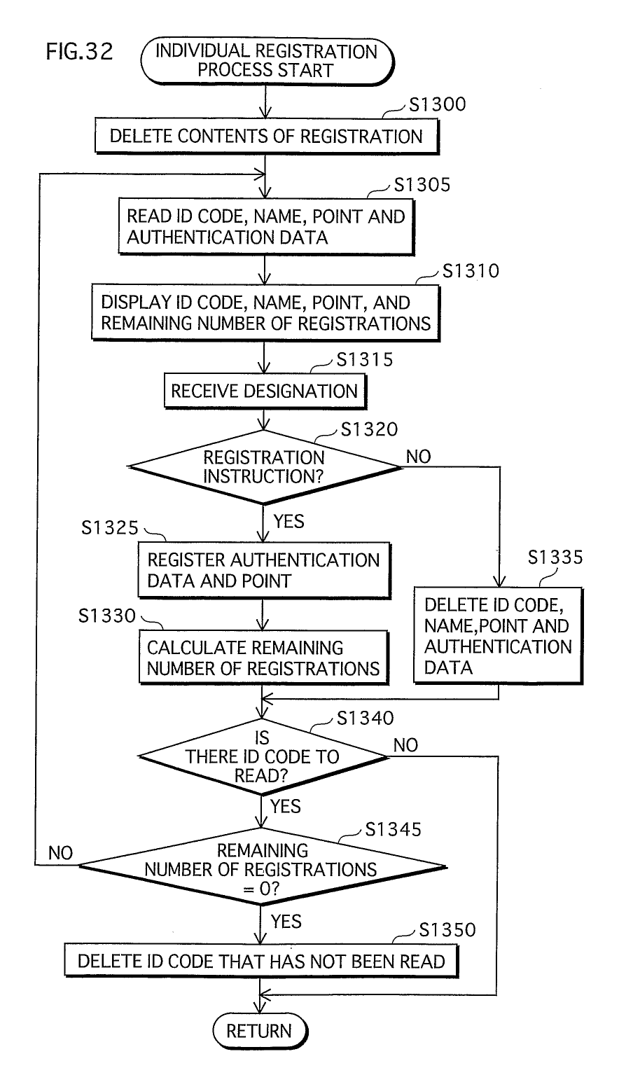

Here, the operation of the individual registration process will be described with reference to the flowchart shown in FIG. 32.

The control unit 107A deletes the registration contents of the ID tag information table T300 of the ID tag information storage unit 202A (step S1300).

The control unit 107A reads an ID code, and the authentication data, name and point value corresponding to the ID code from the received information storage unit 104A (step S1305), and outputs the read ID code, name, and point value, and the remaining number of registrations (its initial value is “5”) to the display unit 106A. The display unit 106A displays the received ID code, name, and point value, and the remaining number of registrations (step S1310).

The control unit 107A then receives the registration instruction or the no-registration instruction from the input unit 105A (step S1315). The control unit 107A judges whether or not the received instruction is the registration instruction (step S1320).

If it judges that the received instruction is not the registration instruction, that is to say, that the received instruction is the no-registration instruction (“No” in step S1320), the control unit 107A discards the read ID code, authentication data, name, and point value from the received information storage unit 104A, and executes step S1340 as will be described later.

If it judges that the received instruction is the registration instruction (“Yes” in step S1320), the control unit 107A writes a pair of the read authentication data and point value into the ID tag information storage unit 202A via the input/output unit 110A (step S1325). The control unit 107A subtracts “1” from the remaining number of registrations, replaces the remaining number of registrations with the result of the subtraction (step S1330).

The control unit 107A judges whether or not there is an ID code to read in the received information storage unit 104A (step S1340).

If it is judged that there is an ID code to read (“Yes” in step S1340), the control unit 107A judges whether or not the remaining number of registrations is “0” (step S1345). If it is judged that the remaining number of registrations is “0” (“Yes” in step S1345), the control unit 107A deletes all the ID codes, authentication data, names, and point values that have not been read (step S1350), and ends the process. At this point in time, the received information storage unit 104A stores only the ID codes, authentication data, names, and point values that correspond to the received registration instructions.

If it judges that the remaining number of registrations is not “0” (“No” in step S1345), the control returns to step S1305 to repeat the steps.

If it is judged that there is no ID code to read, namely that all the ID codes stored in the received information storage unit 104 have been read (“No” in step S1340), the process ends.

2.10 Authentication Data Transmission Process

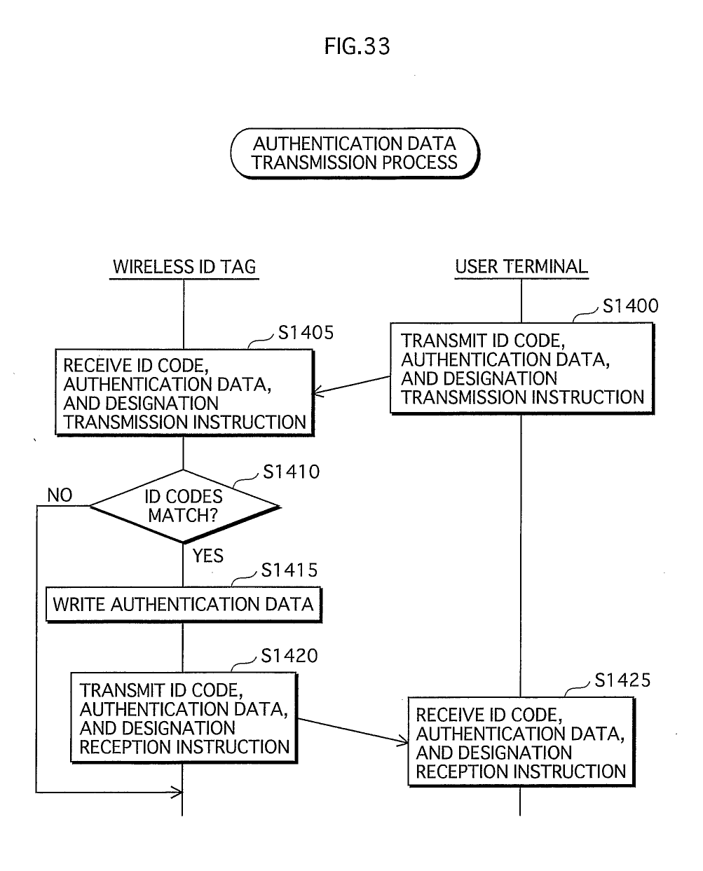

Here, the operation of the authentication data transmission process will be described with reference to the flowchart shown in FIG. 33.

After the control unit 107A writes all the authentication data and point values into the ID tag information storage unit 202A, it outputs the writing start instruction to the reading control unit 142A. Upon receiving the writing start instruction, the reading control unit 142A reads an ID code and authentication data from the received information storage unit 104A, and transmits the read ID code and authentication data and the designation transmission instruction to a wireless ID tag via the instruction generating unit 143A, dulation/demodulation unit 146A, and antenna unit 147A (step S1400).

Upon receiving the ID code and authentication data and the designation transmission instruction via the antenna unit 302A, demodulation unit 312A, and instruction decoding unit 314A (step S1405), the control unit 315A judges whether or not the received ID code matches an ID code stored in the ID code storage unit 310A (step S1410).

If the ID codes match (“Yes” in step S1410), the control unit 315A writes the received authentication data into the authentication data storage unit 317A (step S1415). The control unit 315A transmits the ID code and authentication data and the designation reception instruction to the user terminal 10A via the modulation unit 313A and antenna unit 302A (step S1420).

If the ID codes do not match (“No” in step S1410), the control unit 315A discards the received ID code and authentication data and ends the process.

The reading control unit 142A receives the ID code and authentication data and the designation reception instruction via the antenna unit 147A, modulation/demodulation unit 146A, and instruction decoding unit 144A (step S1425).

The above-described operation of the authentication data transmission process is performed for each pair of an ID code and authentication data stored in the received information storage unit 104A.

2.11 Authentication Method Registration Process

The authentication method registration process is the same as the one shown in FIG. 19, and the description thereof is omitted here.

2.12 Operation of Authentication Process

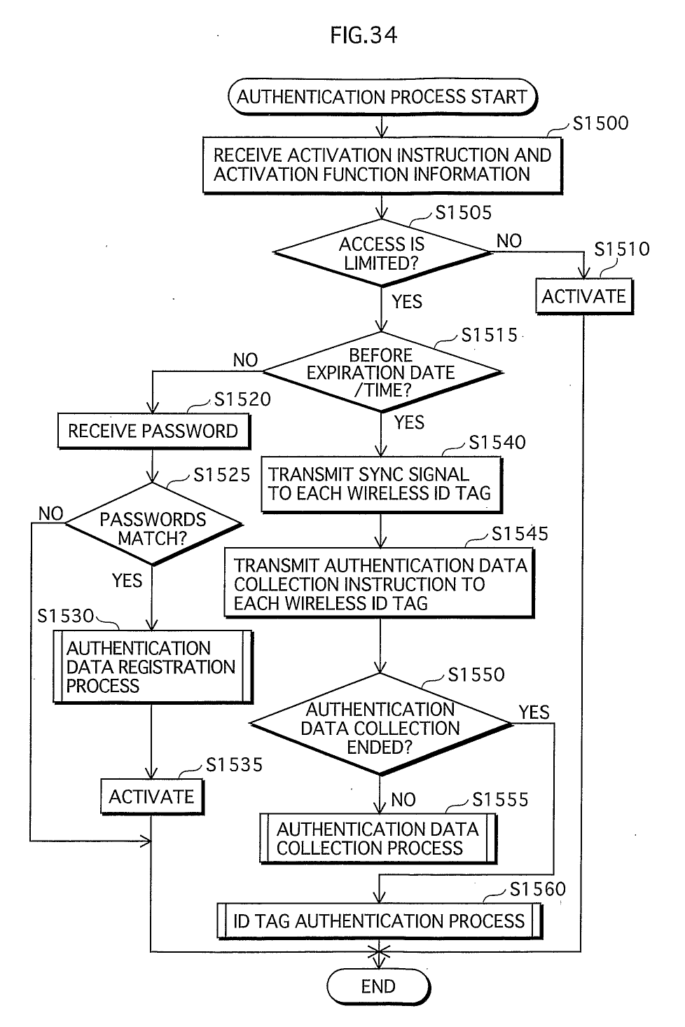

Here, the operation of authentication process will be described with reference to the flowchart shown in FIG. 34.

The control unit 107A, upon receiving the activation instruction and the activation function information from the input unit 105A (step S1500), judges whether or not the access by the user to the function corresponding to the received activation function information is limited (step S1505).

If it judges that the access by the user to the function is not limited (“No” in step S1505), the control unit 107A activates the function indicated by the received activation function information (step S1510).

If it judges that the access is limited (“Yes” in step S1505), the control unit 107 acquires the expiration date/time stored in the expiration date information storage unit 203A and the current date/time from the clock unit 108A, and judges whether or not the current date/time is before the expiration date/time (step S1515).

If it judges that the current date/time is not before the expiration date/time (“No” in step S1515), the control unit 107A generates the password request information, outputs the generated password request in formation to the display unit 106A, then receives a password from the input unit 105A (step S1520), and judges whether or not the received password matches the password stored in the password storage unit 103A (step S1525). If the passwords do not match (“No” in step S1525), the control unit 107A does not activate the function indicated by the received activation function information, and ends the process. If the passwords match (“Yes” in step S1525), the control unit 107A performs the authentication data registration process shown in FIG. 30 and re-registers the authentication data (step S1530), and activates the function indicated by the received activation function information (step S1535).

If it judges that the current date/time is before the expiration date/time (“Yes” in step S1515), the control unit 107A outputs the authentication data read start instruction to the reading control unit 142A of the tag reading unit 109A. Upon receiving the authentication data read start instruction, the reading control unit 142A outputs the sync signal transmission instruction in the sync signal transmission period, and generates and outputs a sync signal wave. Upon receiving the sync signal transmission instruction from the reading control unit 142A, the instruction generating unit 143A generates a pulse signal wave based on the received sync signal transmission instruction, and outputs the generated pulse signal wave to the modulation/demodulation unit 146A. The modulation/demodulation unit 146A changes the amplitude of a carrier wave based on the received pulse signal wave, and outputs the carrier wave with the changed amplitude to the antenna unit 147A. The antenna unit 147A radiates the received carrier wave into the air as a radio wave. The control unit 315A receives the sync signal transmission instruction via the antenna unit 302A, the demodulation unit 312A, and the instruction decoding unit 314A, further receives a sync signal wave, extracts a sync signal, and generates a sync signal wave that includes repeatedly a sync signal that synchronizes with the extracted sync signal (step S1540).

The reading control unit 142A outputs the authentication data collection instruction. The instruction generating unit 143A generates a pulse signal wave based on the received authentication data collection instruction, and outputs the generated pulse signal wave to the modulation/demodulation unit 146A. The modulation/demodulation unit 146A changes the amplitude of a carrier wave based on the received pulse signal wave, and outputs the carrier wave with the changed amplitude to the antenna unit 147A. The antenna unit 147A radiates the received carrier wave into the air as a radio wave. The control unit 315A receives the authentication data collection instruction via the antenna unit 302A, the demodulation unit 312A, and the instruction decoding unit 314A (step S1545).

The reading control unit 142A monitors the progress of the three-second authentication data collection period (step S1550), and in the three-second authentication data collection period (“No” in step S1550), performs the authentication data collection process and collects the authentication data stored in the wireless ID tag (step S1555).

After the authentication data collection period passes over (“Yes” in step S1550), the reading control unit 142A determines that the ID code collection process ended, and outputs the authentication data read completion instruction to the control unit 107A. Upon receiving the authentication data read completion instruction, the control unit 107A performs the ID tag authentication process to authenticate the user, and if the authenticity of the user is certified by the authentication, activates the function indicated by the received activation function information (step S1560).

2.13 Operation of Authentication Data Collection Process

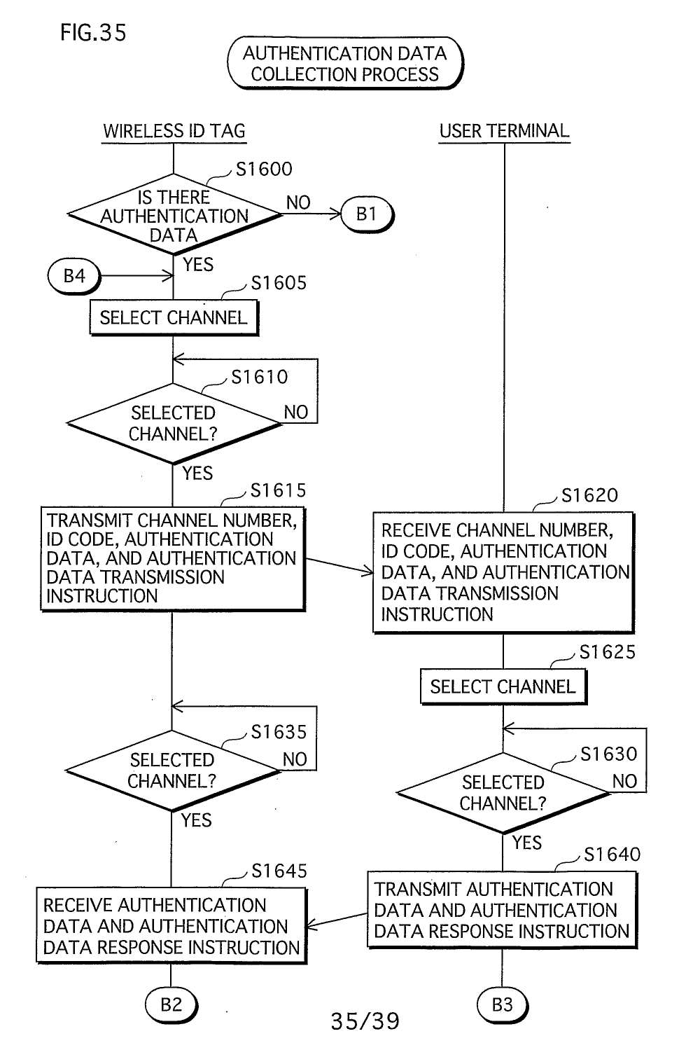

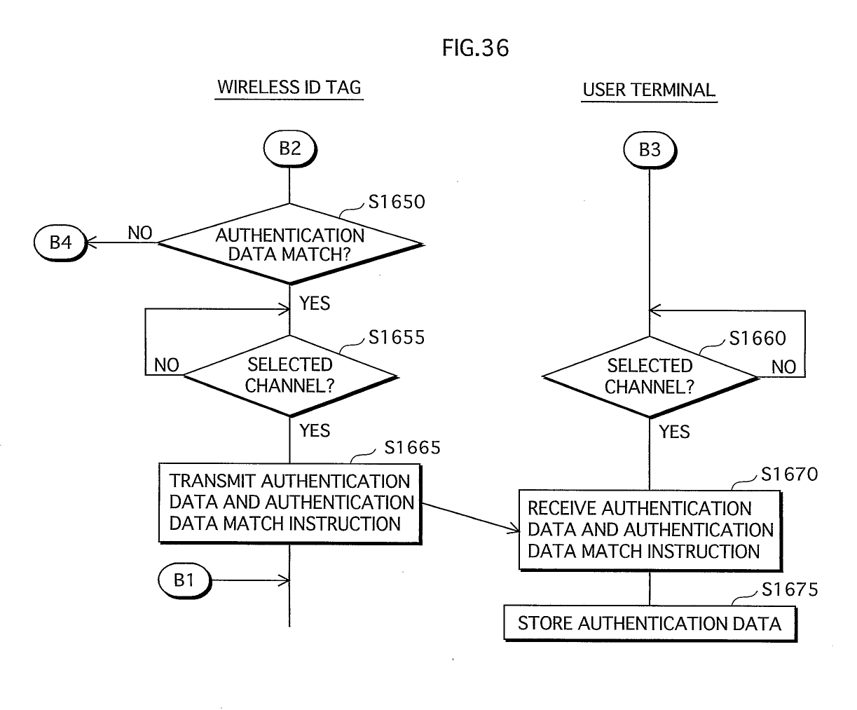

Here, the operation of the authentication data collection process will be described with reference to the flowcharts shown in FIGS. 35 and 36.

Upon receiving the authentication data collection instruction, the control unit 315A judges whether or not there is authentication data in the authentication data storage unit 317A (step S1600).

If it judges that there is no authentication data in the authentication data storage unit 317A (“No” in step S1600), the control unit 315A ends the process.

If it judges that there is authentication data in the authentication data storage unit 317A (“Yes” in step S1600), the control unit 315A selects one numeral out of numerals “1” to “50” at random, reads an ID code from the ID code storage unit 310A, and selects a channel whose channel number matches the numeral selected at random (step S1605).

The control unit 315A outputs the read ID code and authentication data, the channel number of the selected channel, and the authentication data transmission instruction to the user terminal 10A via the modulation unit 313A and the antenna unit 302A (step S1615) in the authentication data transmission period using the selected channel (step S1610).

The reading control unit 142A receives the ID code and authentication data, channel number, and authentication data transmission instruction via the antenna unit 147A, the modulation/demodulation unit 146A, and the instruction decoding unit 144A, and writes the received ID code and authentication data into an ID code area in the temporary storage unit 141A indicated by the received channel number (step S1620).

The reading control unit 142A selects a channel having the received channel number (step S1625), and in the ID code response period using the selected channel (step S1630), transmits the received authentication data and the authentication data response instruction, which instructs to transmit authentication data, to the wireless ID tag via the instruction generating unit 143A, the modulation/demodulation unit 146A, and the antenna unit 147A (step S1640.

The control unit 315A receives the authentication data response instruction and the authentication data via the antenna unit 302A, the demodulation unit 312A, and the instruction decoding unit 314A (step S1645) in the ID code response period using the selected channel (step S1635), and compares the received authentication data with the authentication data read from the authentication data storage unit 317A (step S1650). If the two pieces of authentication data match (“Yes” in step S1650), the control unit 315A transmits the authentication data and the authentication data match instruction to the user terminal 10A via the modulation unit 313A and the antenna unit 302A (step S1665) in the authentication data match period using the selected channel (step S1655). If the two pieces of authentication data do not match (“No” in step S1650), the control unit 315A returns to step S1605 and repeats the process.

Upon receiving the authentication data match instruction and authentication data via the antenna unit 147A, modulation/demodulation unit 146A, and instruction decoding unit 144A (step S1670) in the authentication data match period in the selected channel (step S1660), the reading control unit 142A recognizes that an ID code and authentication data stored in an ID code are a in the temporary storage unit 141A corresponding to the selected channel is authenticate ID code and authentication data, reads the ID code and authentication data from the ID code area in the temporary storage unit 141A, and writes the read ID code and authentication data into the received information storage unit 104A (step S1675).

2.14 Operation of ID Tag Authentication Process

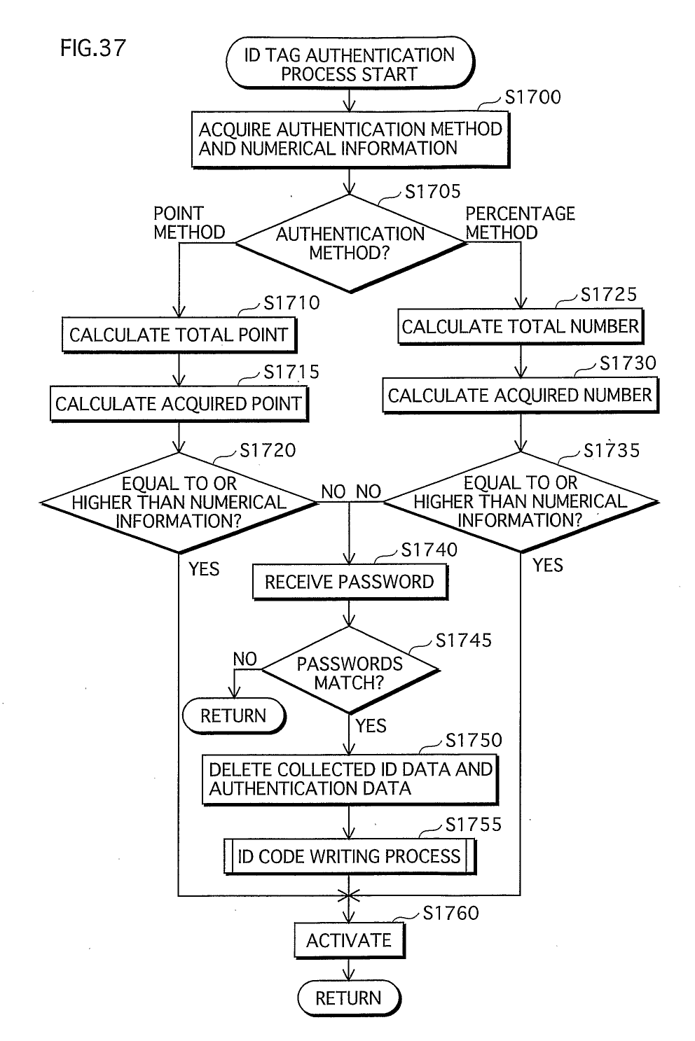

Here, the operation of ID tag authentication process will be described with reference to the flowchart shown in FIG. 37.

If the reading control unit 142A determines that the authentication data collection process ended, the reading control unit 142A outputs the authentication data read completion instruction to the control unit 107A. Upon receiving the authentication data read completion instruction, the control unit 107A acquires, from the authentication standard code table T101 of the authentication information storage unit 134A, the authentication method and the numerical information corresponding to the function name indicated by the received activation function information (step S1700). The control unit 107A then judges whether or not the received authentication method is the point method or the percentage method (step S1705).

If it judges that the received authentication method is the point method in step S1705, the control unit 107A calculates total points by adding up the points for all the pieces of authentication data stored in the ID tag information storage unit 202A (step S1710). The control unit 107A further calculates acquired points by adding up the points for the pieces of authentication data that match the authentication data stored in the received information storage unit 104A (step S1715). The control unit 107A calculates a ratio of the acquired points to the total points, and judges whether or not the calculated ratio is equal to or higher than the value indicated by the acquired numerical information (step S1720). If it judges that the calculated ratio is equal to or higher than the value indicated by the numerical information (“Yes” in step S1720), the control unit 107A activates the function indicated by the received activation function information (step S1760). If it judges that the calculated ratio is lower than the value indicated by the numerical information (“No” in step S1720), the control unit 107A generates the password request information, outputs the generated password request information to the display unit 106A, then receives a password from the input unit 105A (step S1740), and judges whether or not the received password matches the password stored in the password storage unit 103A (step S1745). If the passwords do not match (“No” in step S1745), the control unit 107A does not activate the function indicated by the received activation function information, and ends the process. If the passwords match (“Yes” in step S1745), the control unit 107A deletes the ID codes and authentication data from the received information storage unit 104A (step S1750). The control unit 107A then performs the authentication data registration process shown in FIG. 30 (step S1755), registers the authentication data and a point value, and activates the function indicated by the received activation function information (step S1760).

If it judges that the received authentication method is the percentage method in step S1705, the control unit 107A calculates the total number of pieces of the authentication data stored in the ID tag information storage unit 202A (step S1725). The control unit 107A further calculates the number of acquired pieces of authentication data, the number being equal to the number of pieces of authentication data that match the authentication data stored in the received information storage unit 104A (step S1730). The control unit 107A calculates a ratio of the number of acquired pieces of authentication data to the total number of pieces of authentication data, and judges whether or not the calculated ratio is equal to or higher than the value indicated by the acquired numerical information (step S1735). If it judges that the calculated ratio is equal to or higher than the value indicated by the numerical information (“Yes” in step S1735), the control unit 107A activates the function indicated by the received activation function information (step S1760). If it judges that the calculated ratio is lower than the value indicated by the numerical information (“No” in step S1735), the control unit 107A performs the above-described step S1740 and onwards.

2.15 Modifications of Embodiment 2

The above-described Embodiment 2 is one example as an embodiment of the present invention. The present invention is not limited to the embodiment, but may be modified in various manners for achieving the theme, for example, as follows.

(1) In the above-described embodiment, it is confirmed during an authentication process whether or not the authentication data registered with the authentication recording medium 20A has expired. However, not limited to this, the confirmation on whether or not the registered authentication data has expired may be performed when the authentication recording medium 20A is inserted in the user terminal 10A. This is achieved, for example, as follows. The user terminal 10A is provided with a detection unit that detects whether or not an authentication recording medium 20A has been inserted in the user terminal 10A. Upon detection of the insertion of the authentication recording medium therein, the user terminal 10A confirms whether or not the authentication data registered with the authentication recording medium 20A has expired. If it judges that the authentication data has expired, the user terminal 10A performs the process shown in FIG. 29 and registers the authentication data. If it judges that the authentication data not expired, the user terminal 10A does not register the authentication data. In doing this, if the power of the user terminal 10A is switched from OFF to ON while the authentication recording medium 20A is inserted in the user terminal 10A, the detection unit judges that the authentication recording medium 20A has been inserted in the user terminal 10A.

The user terminal 10A may not register authentication data and a point value as soon as it judges that the authentication data has expired, but may register them when it receives a request to use a function for which the access by the user is limited. This is achieved, for example, as follows. The user terminal 10A is provided with a registration designation information storage unit that stores information designating whether or not authentication data needs to be registered. If the user terminal 10A judges that the authentication data has expired, the user terminal 10A stores, into the registration designation information storage unit, information designating that authentication data needs to be registered; and if the user terminal 10A judges that the authentication data has not expired, the user terminal 10A stores, into the registration designation information storage unit, information designating that it is not necessary to register authentication data. The authentication in this modification is performed as follows. In step S1515 of FIG. 34, instead of judging whether or not the current date/time is before the expiration date/time, the information stored in the registration designation information storage unit is referred to, and if the registration designation information storage unit stores the information designating that authentication data needs to be registered, the control unit 107A performs steps S1520-S1535, and if the registration designation information storage unit stores the information designating that it is not necessary to register authentication data, the control unit 107A performs step S1540 and onwards. The registration designation information storage unit may be provided in the authentication recording medium 20A.

(2) In the above-described embodiment, when a user requests to use a function of the user terminal 10A for which the access by the user is limited, the user terminal 10A performs an authentication using passwords, and if the passwords match, deletes the ID codes and authentication data stored in the received information storage unit 104A, and re-registers the authentication data. However, not limited to this, the following is possible.

Upon judging that the passwords match, the user terminal 10A deletes only the authentication data from the received information storage unit 104A, and performs the authentication data registration process using the ID codes stored in the received information storage unit 104A. This can be achieved by changing the ID tag authentication process as follows: in step S1750 of FIG. 37, the control unit 107A deletes only the authentication data, instead of the ID codes and authentication data, from the received information storage unit 104A; and in step S1755, the control unit 107A performs the authentication data writing process shown in FIG. 31, instead of the authentication data registration process.

(3) In the above-described embodiment, there is an upper limit to the number of pieces of authentication data to be registered with the authentication recording medium 20A. However, not limited to this, the following is possible.

All the pieces of authentication data read from each wireless ID tag may be registered, without setting an upper limit to the number of pieces of authentication data to be registered. This can be achieved by changing the authentication data writing process as follows: after execution of step S1205 of FIG. 31, step S1240 and onwards are executed.

Alternatively, in the case where no upper limit is set to the number of pieces of authentication data to be registered with the authentication recording medium 20A, at least one of (i) refining by priority level, (ii) refining by point value, and (iii) individual registration process may be performed. In this case, after at least one of (i) refining by priority level, (ii) refining by point value, and (iii) individual registration process is performed, pieces of authentication data corresponding to the ID codes stored in the received information storage unit 104A are written.

(4) In the above-described embodiment, an upper limit to the number of pieces of authentication data to be registered with the authentication recording medium 20A is stored in the number of registrations information storage unit 132A in advance. However, not limited to this, the following is possible.

The number of registrations information storage unit 132A may not have stored an upper limit in advance when the user terminal is purchased, and after purchasing it, the user may set (and then change) the upper limit. Alternatively, the number of registrations information storage unit 132A may have stored an upper limit in advance when the user terminal is purchased, and after purchasing it, the user may change the upper limit.

(5) In the above-described embodiment, refining is done by priority levels, points, or the individual registration process. However, not limited to these, refining may be done by the following method, for example.

The distance between the user terminal 10A and each wireless ID tag is measured. It is judged for each wireless ID tag whether or not the measured distance is equal to or smaller than a predetermined distance (for example, 0.5 m). The sets of an ID code, authentication data, a priority level, and a point value to be registered are then narrowed down to those of wireless ID tags that are remote from the user terminal 10A by a distance equal to or smaller than the predetermined distance.

The judgment on whether or not the distance between a wireless ID tag and the user terminal 10A is equal to or smaller than the predetermined distance is the same as in Modification (4) to Embodiment 1, and the description is omitted here.

(6) In the above-described embodiment, when authentication data is registered, refining is done by priority levels, points, or the individual registration process. However, not limited to these, the following is possible.

The control unit 107A may select, at random, authentication data from one or more pieces of authentication data stored in the received information storage unit 104A, and register the selected authentication data with the ID tag information storage unit 202A of the authentication recording medium 20A, together with corresponding point values.

(7) In the above-described embodiment, among the ID codes stored in the information storage areas in the received information storage unit 104A, the ID codes overlapping each other are subtracted by a predetermined value, in terms of the points. However, not limited to this, the following is possible. Regarding the ID codes overlapping each other, the priority levels may be subtracted by a predetermined value (for example, “2”), and the priority levels after the subtraction may be stored in correspondence with the ID codes and authentication data.

(8) The present invention may be achieved as a combination of the above-descried embodiment and any of the above-descried modifications.

2.16 Summary of Embodiment 2

As described above, in the authentication system 1A, when a user requests to use a function of the user terminal 10A for which the access by the user is limited, the user terminal 10A first performs authentication using authentication data acquired from wireless ID tags embedded in objects (clothes, paper moneys, authentication cards or the like) worn or carried by the user (the authentication data has been written by the user terminal 10A in the wireless ID tags beforehand), and if the authenticity of the user is not certified by the authentication, the user terminal 10A receives a password and performs an authentication using the received password. With this arrangement, if the authenticity of the user is not certified by the authentication by the authentication data, the user can be authenticated without repeating the procedures for the authentication. Also, when it receives an instruction to activate a function for which the access by the user is limited, the authentication system 1A first performs authentication using wireless ID codes. This eliminates the user having to input a password each time he/she tries to use a function for which the access by him/her is limited, which facilitates the user. Further, even if the user terminal 10A is lost or stolen, a function for which the access by the user is limited cannot be used unless the authenticity of the user is certified by the authentication using wireless ID tags or the authentication using passwords. This prevents the function for which the access by the user is limited from being used.

Also, when the authenticity of the user is certified by the authentication using passwords, the authentication system 1A re-registers the authentication data and point values using the authentication data corresponding to ID codes collected in the authentication by the authentication data, and activates the function for which the access by the user is limited, as requested by the user. This eliminates the user having to stop designating the activation of the function so as to register the authentication data and point values from the start, thus enabling the user to update the contents of registration easily.

Also, the authentication system 1A has a standard value used in judging the authenticity of the user by the authentication data. With this arrangement, even if the acquired authentication data does not completely match the authentication data having been registered beforehand due to a failure to communicate with all the wireless ID tags due to, for example, a large distance between some wireless ID tags and the user terminal 10A, or inappropriate intensity levels of the radio waves during the communication, the authentication system 1A can certify the authenticity of the user by confirming that the standard value is satisfied.

Also, when registering authentication data with the authentication recording medium 20A, the authentication system 1A can perform refining by priority level, refining by point value, or individual registration in which it registers only the authentication data that is instructed by the user to register. This makes it possible to register only such authentication data that corresponds to wireless ID tags required for the authentication.

Also, the authentication system 1A uses, for the authentication by the wireless ID tags, the wireless ID tags embedded in objects worn or carried by the user. Each user can be identified uniquely by the combination of the wireless ID tags embedded in objects worn or carried by the user. This enables the authentication system 1A to authenticate the user correctly. And in conventional authentication systems, the user always needs to remind himself/herself that he/she is carrying a wireless ID tag necessary for the authentication. In contrast, in the above-described authentication system 1A, the user does not need to be aware that he/she is carrying a wireless ID tag since wireless ID tags are embedded in objects worn or carried by the user.

### 3. Other Modifications

Up to now, the present invention has been explained by describing the embodiments thereof. However, the present invention is not limited to the above-described embodiments, but may be modified in various manners, for example, as follows.

(1) In Embodiment 1, the priority levels and point values are set in advance in the type code table T100. However, not limited to this, the columns for the priority levels and point values in the type code table T100 may be blank when the user terminal is purchased, and after purchasing it, the user may set (and then change) the priority levels and point values. Alternatively, the priority levels and point values may have been set in advance in the type code table T100 when the user terminal is purchased, and after purchasing it, the user may change the priority levels and point values. Also, the user terminal may be connected to a management apparatus for managing the type code table T100, via a network such as the Internet. The type code table T100 then may be downloaded from the management apparatus to be initialized and changed.

The above-described modification is also applicable to Embodiment 2.

(2) In Embodiment 1, the authentication recording medium 20 is inserted in the user terminal 10 for use. However, not limited to this, the registration information storage unit 201 of the authentication recording medium 20 may be provided in the user terminal 10.

Also, Embodiment 2, the registration information storage unit 201A of the authentication recording medium 20A may be provided in the user terminal 10A.

(3) in the above-described embodiments, the authentication system includes a user terminal, an authentication recording medium, and one or more wireless ID tags. However, not limited to this, the following is possible.

For example, the authentication system may be an authentication system 1B that includes a bank ATM terminal (hereinafter referred to as “ATM terminal”) 50B, a user terminal 10B, an authentication recording medium 20B, and wireless ID tags 30B, 31B, 32B, 33B, 34B, 35B, . . . 36B. As in conventional technologies, when an ATM card (cash card) is inserted in the ATM terminal 50B, an authentication using the inserted ATM card is also performed.

The authentication system in this modification will be described with a focus on differences from the authentication system 1 in Embodiment 1. It should be noted here that the description of the authentication recording medium 20B and wireless ID tags 30B, 31B, 32B, 33B, 34B, 35B, . . . 36B is omitted here since they are the same as the counterparts in Embodiment 1.

(A) ATM Terminal 50B

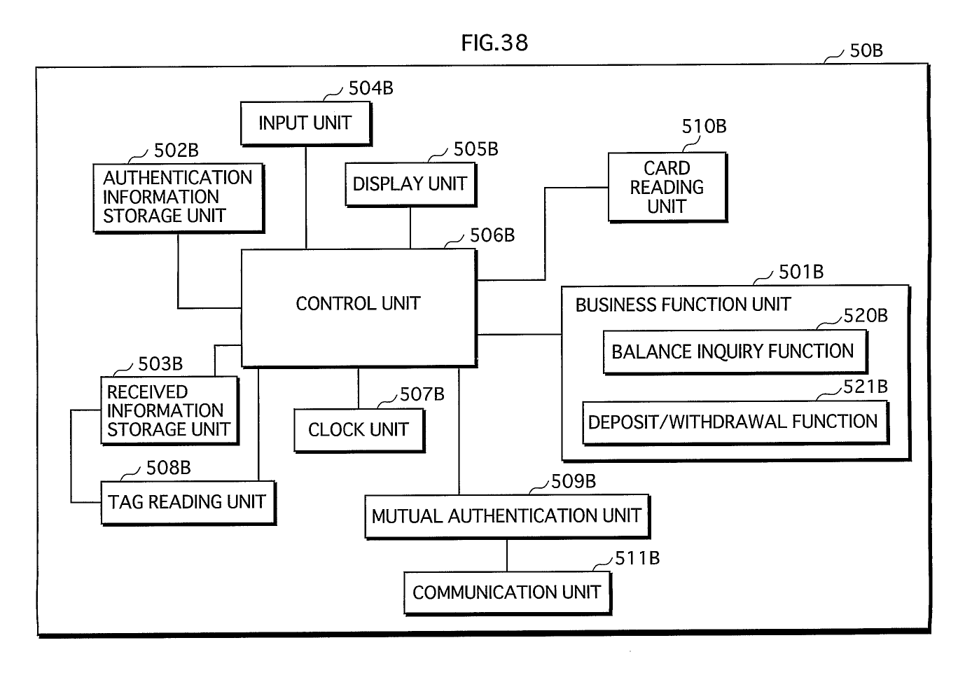

The ATM terminal 50B includes, as shown in FIG. 38, a business function unit 501B, an authentication information storage unit 502B, a received information storage unit 503B, an input unit 504B, a display unit 505B, a control unit 506B, a clock unit 507B, a tag reading unit 508B, a mutual authentication unit 509B, a card reading unit 510B, and a communication unit 511B.

The ATM terminal 50B is more specifically a computer system including a microprocessor, a ROM, a RAM, a hard disk unit, a display unit and the like. A computer program is recorded in the ROM or the hard disk unit. The ATM terminal 50B achieves its functions as the microprocessor operates in accordance with the computer program.

<Business Function Unit 501B>

The business function unit 501B stores functions regarding the business that can be performed by the ATM terminal 50B (hereinafter such functions are referred to as “business functions”). For example, the business function unit 501B stores, as the business functions, a balance inquiry function 520B and a deposit/withdrawal function 521B.

<Authentication Information Storage Unit 502B>

The authentication information storage unit 502B is the same as the authentication information storage unit 134 in Embodiment 1, and the description thereof is omitted here.

<Received Information Storage Unit 503B>

The received information storage unit 503B is the same as the received information storage unit 104 in Embodiment 1, and the description thereof is omitted here.

<Clock Unit 507B>

The clock unit 507B is a clock that measures time.

<Input Unit 504B>

The input unit 504B, upon receiving from a user a designation to activate a business function stored in the business function unit 501B, generates activation function information, and outputs the generated activation function information and the activation instruction to the control unit 506B.

The input unit 504B also receives designations and information regarding the activated function. Upon receiving a designation from the user, the input unit 504B outputs an instruction corresponding to the received designation to the control unit 506B; and upon receiving information, the input unit 504B outputs the received information to the control unit 506B.

The input unit 504B also receives a secret number of a cash card from the user, and outputs the received secret number to the control unit 506B.

<Display Unit 505B>

The display unit 505B, upon receiving from the control unit 506B the number request information requesting to insert a cash card or input a secret number, displays the received number request information and urges the user to insert a cash card or input a secret number.

Also, upon receiving from the control unit 506B information regarding a functions stored the business function storage unit 501B, the display unit 505B displays the received information.

<Tag Reading Unit 508B>

The tag reading unit 508B is the same as the tag reading unit 109 in Embodiment 1, and the description thereof is omitted here.

<Control Unit 506B>

The control unit 506B, upon receiving from the input unit 504B the activation instruction and the activation function information, outputs a communication start instruction, which designates to start a communication with the user terminal 10B, to the mutual authentication unit 509B.

Upon receiving from the mutual authentication unit 509B a communication end instruction, which indicates that a communication with the user terminal 10B ended, and authentication failure information, which indicates that the authenticity is not acknowledged in the mutual authentication with the user terminal 10B, the control unit 506B ends the operation without activating the function indicated by the received activation function information.

Upon receiving from the mutual authentication unit 509B (i) the communication end instruction indicating that a communication with the user terminal 10B ended, (ii) expiration date information indicating the expiration date/time of an ID code used for authentication and stored in the authentication recording medium 20B, and (iii) all the ID codes and point values corresponding to the ID codes stored in the authentication recording medium 20B, the control unit 506B operates as follows.

The control unit 506B acquires the current date/time from the clock unit 507B, and judges whether or not the current date/time is before the expiration date/time indicated by the expiration date information.

If it judges that the current date/time is not before the expiration date/time, the control unit 506B generates the number request information and outputs the generated number request information to the display unit 505B. Then, upon receiving a secret number from the input unit 504B, the control unit 506B performs a known authentication by comparing the received secret number with a secret number read from a cash card via the card reading unit 510B. If it judges that the user is authenticate by the authentication, the control unit 506B activates the function indicated by the received activation function information.

If it judges that the current date/time is before the expiration date/time, the control unit 506B outputs an ID code read start instruction to the tag reading unit 508B. Upon receiving an ID code read completion instruction from the tag reading unit 508B, the control unit 506B acquires an authentication method and numerical information corresponding to the function name indicated by the received activation function information, from the authentication standard code table T101. The control unit 506B judges whether or not the acquired authentication method is the point method or the percentage method.

Here, description of authentication by the point method and the percentage method is omitted since it is the same as in Embodiment 1.

During the authentication by the point method or the percentage method, if the calculated ratio is lower than the numerical value indicated by the numerical information, that is to say, if it is judged that the user is not authenticate, the control unit 506B generates the number request information and outputs the generated number request information to the display unit 505B. Then, upon receiving a secret number from the input unit 504B, the control unit 506B performs a known authentication by comparing the received secret number with a secret number read from a cash card via the card reading unit 510B. If it judges that the user is authenticate by the authentication, the control unit 506B activates the function indicated by the received activation function information.

After activating the function indicated by the activation function information received from the input unit 504B, the control unit 506B control the activated function based on the instruction regarding the function received from the input unit 504B.

<Mutual Authentication Unit 509B>

The mutual authentication unit 509B stores a first secret key, which is generated beforehand, and a second public key, which corresponds to a second secret key stored in the user terminal 10B, the keys being used for a mutual authentication with the user terminal 10B. The mutual authentication unit 509B transmits and receives information to/from the user terminal 10B through radio communications via the communication unit 511B.

Upon receiving a communication start instruction from the control unit 506B, the mutual authentication unit 509B performs a mutual authentication with the user terminal 10B via the communication unit 511B using the first secret key and the second public key, and if the authenticity of both parties is certified by the mutual authentication, generates a session key. At this point in time, the user terminal 10B also generates the same session key as the session key generated by the mutual authentication unit 509B. The mutual authentication and generation of the session key are known technologies, and the description thereof is omitted here.

If the authenticity of both parties is not certified by the mutual authentication, the mutual authentication unit 509B generates authentication failure information, and outputs the generated authentication failure information and a communication end instruction to the control unit 506B.

If the authenticity of both parties is certified by the mutual authentication, the mutual authentication unit 509B receives via the communication unit 511B encrypted information which is generated by encrypting the following information using the session key: (i) expiration date information; (ii) all the ID codes stored in the authentication recording medium 20B and point values corresponding to the ID codes; and (iii) an information transmission instruction that indicates transmission of information. The mutual authentication unit 509B decrypts the received encrypted information using the session key to generate the expiration date information, ID codes, point values, and information transmission instruction, and outputs the generated expiration date information, ID codes, and point values and a communication end instruction to the control unit 506B.

<Card Reading Unit 510B>

The card reading unit 510B inputs and outputs information from/to the control unit 506B and the cash card.

<Communication Unit 511B>

The communication unit 511B performs radio communications with the user terminal 10B, and transmits and receives instructions and information to/from the user terminal 10B and mutual authentication unit 509B.

(B) User Terminal 10B

Here, user terminal 10B will be described with a focus on differences from the user terminal 10 described in Embodiment 1.

The user terminal 10B includes a mutual authentication unit 112B and a communication unit 113B in addition to the components of the user terminal 10 described in Embodiment 1.

<Mutual Authentication Unit 112B>

The mutual authentication unit 112B stores a first public key, which corresponds to the first secret key stored in the ATM terminal 50B, and a second secret key, which is generated beforehand, the keys being used for a mutual authentication with the ATM terminal 50B. The mutual authentication unit 112B transmits and receives information to/from the ATM terminal 50B through radio communications via the communication unit 113B.

The mutual authentication unit 112B performs a mutual authentication with the ATM terminal 50B via the communication unit 113B using the first public key and the second secret key it stores, and if the authenticity of both parties is certified by the mutual authentication, generates a session key. The mutual authentication and generation of the session key are known technologies, and the description thereof is omitted here.

If the authenticity of both parties is not certified by the mutual authentication, the mutual authentication unit 112B ends communications with the ATM terminal 50B.

If the authenticity of both parties is certified by the mutual authentication, the mutual authentication unit 112B reads from the authentication recording medium 20B the expiration date information, ID codes, and point values corresponding to the ID codes, generates encrypted information by encrypting the read expiration date information, ID codes, point values corresponding to the ID codes, and the information transmission instruction using the session key, and transmits the generated encrypted information to the ATM terminal 50B via the communication unit 113B.

<Communication Unit 113B>

The communication unit 113B performs radio communications with the ATM terminal 50B, and transmits and receives instructions and information to/from the ATM terminal 50B and mutual authentication unit 112B.

(C) Authentication Operation when ATM Terminal 50B is Used

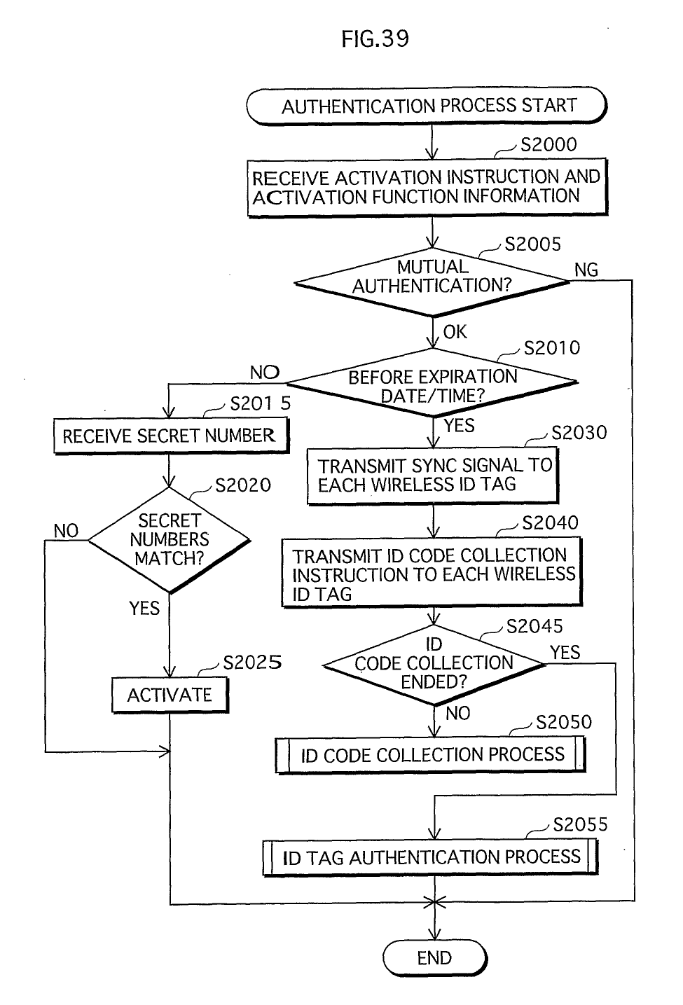

Here, the authentication operation when the ATM terminal 50B is used will be described with reference to the flowchart shown in FIG. 39.

The control unit 506B of the ATM terminal 50B, upon receiving the activation instruction and the activation function information from the input unit 504B (step S2000), outputs the communication start instruction to the mutual authentication unit 509B. The mutual authentication unit 509B performs a mutual authentication with the user terminal 10B, and judges whether or not the authenticity of both parties is certified by the mutual authentication (step S2005).

If the authenticity of both parties is not certified by the mutual authentication (“NG” in step S2005), the process ends.

If the authenticity of both parties is certified by the mutual authentication (“YES” in step S2005), the mutual authentication unit 112B of the user terminal 10B generates encrypted information by encrypting the expiration date information, ID codes, point values corresponding to the ID codes, and the information transmission instruction, and transmits the generated encrypted information to the mutual authentication unit 509B. Upon receiving the encrypted information, the mutual authentication unit 509B decrypts the received encrypted information using the session key to generate the expiration date information, ID codes, point values, and information transmission instruction, and outputs the generated expiration date information, ID codes, and point values and the communication end instruction to the control unit 506B. Upon receiving the expiration date information, ID codes, point values, and communication end instruction, the control unit 506B compares the received expiration date information with the current date/time and judges whether or not the current date/time is before the expiration date/time (step S2010).

If it is judged that the current date/time is not before the expiration date/time (“No” in step S2010), the control unit 506B generates number request information and outputs the generated number request information to the display unit 505B, and receives a secret number from the input unit 105 (step S2015). The control unit 506B then judges whether or not the received secret number matches a secret number stored in the inserted cash card (step S2020). If it judges that the secret numbers do not match (“No” in step S2020), the control unit 506B ends the process without activating the function indicated by the activation function information. If it judges that the secret numbers match (“Yes” in step S2020), the control unit 506B activates the function indicated by the activation function information (step S2025).

If it is judged that the current date/time is before the expiration date/time (“Yes” in step S2010), the control unit 506B outputs the ID code read start instruction to the tag reading unit 508B. The tag reading unit 508B transmits the sync signal transmission instruction and sync signal wave to each wireless ID tag in each sync signal transmission period. Upon receiving the sync signal transmission instruction and sync signal wave, each wireless ID tag extracts a sync signal, and generates a sync signal wave that includes repeatedly a sync signal that synchronizes with the extracted sync signal (step S2030).

The tag reading unit 508B transmits the ID code collection instruction to the wireless ID tag 30B, and the wireless ID tag 30B receives the ID code collection instruction (step S2040).

The tag reading unit 508B monitors the progress of the three-second ID code collection period (step S2045), and in the three-second ID code collection period (“No” in step S2045), performs the ID code collection process shown in FIGS. 15 and 16 (step S2050).

After the ID code collection period passes over (“Yes” in step S2045), the tag reading unit 508B determines that the ID code collection process ended, and outputs the ID code read completion instruction to the control unit 506B. The control unit 506B receives the ID code read completion instruction, and if the authenticity of the user is certified in the ID tag authentication process, activates the function indicated by the received activation function information (step S2055).

(D) Operation of ID Tag Authentication Process

Here, the operation of ID tag authentication process will be described with a focus on differences from the flowchart shown in FIG. 21.

In this ID tag authentication process, the ATM terminal 50B similarly performs the steps S700-S735 shown in FIG. 21.

Step S740 is performed differently. That is to say, in step S740, the control unit 506B generates the number request information and outputs the generated number request information to the display unit 505B, and then receives a secret number from the input unit 504B.

Step S745 is also performed differently. That is to say, in step S745, the control unit 506B judges whether or not the received secret number matches the secret number stored in the inserted cash card.

If it judges that the secret numbers match, the control unit 506B performs the step S755. If it judges that the secret numbers do not match, the control unit 506B ends the process without activating the function indicated by the received activation function information.

(4) In the above-described Embodiment 1, biological information indicating biological characteristics of the user may be used instead, of passwords.

The biological information is, for example, fingerprint information indicating characteristics of the user's fingerprints, voiceprint information indicating characteristics of the user's voiceprint, iris information indicating characteristics of the user's iris, contour information indicating characteristics of the user's face contour, DNA information indicating characteristics of the user's DNA, or any combination of these pieces of information.

When the fingerprint information is used for the authentication, the user terminal 10 is provided with (i) a fingerprint input unit that receives a user's fingerprint and generates the fingerprint information from the received fingerprint, and (ii) a fingerprint information storage unit that stores in advance fingerprint information of the user that is used as a standard in the authentication.

When the voiceprint information is used for the authentication, the user terminal 10 is provided with (i) a voiceprint input unit that receives a user's voiceprint and generates the voiceprint information from the received fingerprint, and (ii) a voiceprint information storage unit that stores in advance voiceprint information of the user that is used as a standard in the authentication.

When the iris information is used for the authentication, the user terminal 10 is provided with (i) an iris input unit that reads a user's iris and generates the iris information from the read iris, and (ii) an iris information storage unit that stores in advance iris information of the user that is used as a standard in the authentication.

When the contour information is used for the authentication, the user terminal 10 is provided with (i) a contour input unit that reads a user's face contour and generates the contour information from the read face contour, and (ii) a contour information storage unit that stores in advance contour information of the user that is used as a standard in the authentication.

When the DNA information is used for the authentication, the user terminal 10 is provided with (i) a DNA input unit that receives DNA information that is generated by analyzing the user's DNA, and (ii) a DNA information storage unit that stores in advance DNA information of the user that is used as a standard in the authentication. The DNA information is information generated by analyzing, for example, the hair, blood, or saliva of the user.

The user terminal judges whether or not the biological information stored beforehand matches the biological information received from the user, and determines that the user is authenticate if it judges that the two pieces of biological information match.

It should be noted here that in this modification, it is judged that the biological information stored beforehand matches the biological information received from the user if the level of the match (a ratio of the matching portion to the total information) is equal to or higher than a predetermined value (for example, 80%).

The above-described modification is also applicable to Embodiment 2.

(5) In the above-described embodiments, a PDA is introduced as one example of the user terminal. However, not limited to this, the user terminal may be a mobile phone or a personal computer.

(6) The authentication system 1 described in Embodiment 1 may be applied to the entering/leaving management in a condominium. The following describes one example of the entering/leaving management in a condominium.

The authentication card 40 in which the wireless ID tag 30 is embedded stores an identifier for identifying the authentication card 40. People who have been permitted to enter/leave the condominium are given authentication cards storing different identifiers, respectively. In this example, it is supposed that each of the authentication cards is the authentication card 40.

In this example, the user terminal 10 is used as an apparatus for managing the entering/leaving in the condominium. The authentication card 40 is inserted in the user terminal 10. In the user terminal 10, the function storage unit stores only an open/close function for opening/closing a door. Also, the authentication information storage unit 134 stores a set of a function name, authentication method, and numerical information corresponding to the open/close function. The user terminal 10 further includes the ID tag information storage unit 202, the expiration date information storage unit 203, and an insertion detection unit that detects an insertion of the authentication card 40.

The ID tag information storage unit 202 has an area for storing one or more sets of a collected pair of an ID code and a point value corresponding to the ID code, and an identifier read from the authentication card 40.

In the ID code registration process, the authentication card 40 is inserted in the user terminal 10. When writing the ID code and a corresponding point value into the ID tag information storage unit 202, the user terminal 10 reads an identifier from the inserted authentication card 40, and stores the read identifier and the ID code and the corresponding point value therein by correlating them with each other.

In the authentication process for entering/leaving of a user, when the user inserts the authentication card 40 into the user terminal 10, the insertion detection unit detects the insertion of the authentication card 40, and then the user terminal 10 generates the activation function information and outputs the activation instruction and the generated activation function information to the control unit 107. In Embodiment 1, when the user inserts the authentication card 40 into the user terminal 10, the input unit 105 receives a designation to activate a function, generates the activation function information, and outputs the generated activation function information and the activation instruction instructing to activate the function, to the control unit 107.

After this, the user terminal 10 collects ID codes from each wireless ID tag, reads the identifier from the inserted authentication card 40, reads all the sets of an ID code and a point value corresponding to the read identifier from the ID tag information storage unit 202, and performs an authentication by the point or percentage method using the read ID codes and collected ID codes. If the authenticity of the user is not certified by this authentication, a password is input by the user, and an authentication using passwords is performed.

The above-described modification is also applicable to Embodiment 2.

(7) In the above-described modification (6), as is the case with Embodiment 1, an ID code is registered only if the authenticity of the user is certified by the authentication using a password received from the user. However, for the ID code registration, an authentication using an inserted authentication card may be performed instead of the authentication using passwords.

While in Embodiment 1, the input unit 105 of the user terminal 10 receives from the user an instruction to start a registration of an ID code, and outputs the ID code registration instruction to the control unit 107, in this modification, when the user inserts the authentication card 40 into the user terminal 10, the insertion detection unit detects the insertion of the authentication card 40, and then the user terminal 10 outputs the ID code registration instruction to the control unit 107. After this, the user terminal 10 follows the same procedures as in Embodiment 1 to register the ID code and point value.

The above-described modification is also applicable to Embodiment 2.

(8) In the above-described modification (6), the ID code registration may be performed as follows.

The user terminal 10 is further provided with a sensor for detecting that a user is leaving a room.

The wireless ID tag 30 embedded in the authentication card 40 includes a reading unit for reading an identifier stored in the authentication card 40.

When the sensor detects that a user is leaving the room, the user terminal 10 collects ID codes from each wireless ID tag. Also, the wireless ID tag 30 of the authentication card 40, when it transmits an ID code to the user terminal 10, reads the identifier of the authentication card 40, and transmits the read identifier to the user terminal 10.

The user terminal 10 generates sets of an ID code, which was collected from a wireless ID tag, and a point value corresponding to the ID code, and writes the identifier collected from the wireless ID tag 30 together with the generated sets of an ID code and a point value into the ID tag information storage unit 202 by correlating the identifier with the sets of an ID code and a point value.

The above-described modification is also applicable to Embodiment 2.

(9) In Embodiment 1, an arrangement may be made to change the standard number of days stored in the standard days information storage unit 131, the standard priority value stored in the standard priority storage unit 135, and the standard point stored in the standard point storage unit 136.

The above-described modification is also applicable to Embodiment 2.

(10) In Embodiment 1, refining by the priority level or the point value is performed during the ID code registration. However, the refining by the priority level or the point value may be performed during the authentication. More specifically, the collected ID codes may be refined by the priority level or the point value, and the refined ID codes may be used in the authentication. Alternatively, the collected ID codes may be refined by excluding one or more predetermined type codes (for example, a type code indicating a coat), and the remaining ID codes may be used in the authentication.

The above-described modification is also applicable to Embodiment 2.

(11) In Embodiment 1, the user terminal 10 may register at least two ID codes with the authentication recording medium 20, namely, the lower limit of the number of ID codes to be registered may be set to “2”.

For example, if only one ID code is to be registered as a result of the refining by the priority level or point value, the user terminal 10 may change the standard priority level so that at least two ID codes are to be registered, and then may collect ID codes again.

Alternatively, in the above case, the user terminal 10 may change the standard point value or change the standard priority level and the standard point value so that at least two ID codes are to be registered.

In Embodiment 2, the user terminal 10A may register at least two pieces of authentication data with the authentication recording medium 20A.

(12) In Embodiment 1, the priority level or the point value is used to refine the number of ID codes to be registered. However, not limited to this, the ID codes may be narrowed down to those including a predetermined type code.

The above-described modification is also applicable to Embodiment 2.

(13) The present invention may be a method for achieving the above, or a computer program for causing a computer to achieve the method, or a digital signal representing the computer program.

Furthermore, the present invention may be a computer-readable recording medium such as a flexible disk, a hard disk, CD-ROM, MO, DVD, DVD-ROM, DVD RAM, BD (Blu-ray Disc), or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium apparatus, or by transferring the program or the digital signal via a network or the like, the program or the digital signal may be executed by another independent computer system.

(14) The present invention may be any combination of the above-described embodiments and modifications.

### INDUSTRIAL APPLICABILITY

The above-described authentication system can be used effectively, namely repetitively and continuously, in the industry for manufacturing and distributing user terminals.

1. An authentication system including a plurality of wireless IC tags and an authentication apparatus which permits a user to use a function provided by the authentication apparatus if authenticity of the user is certified by authentication,
the authentication apparatus comprising:
a tag verification information storage unit operable to store a plurality of pieces of tag verification information for identifying the plurality of wireless IC tags respectively;
a receiving unit operable to wirelessly receive, from wireless IC tags attached to objects carried by the user, a plurality of pieces of tag certification information for identifying the wireless IC tags attached to the objects respectively;
a tag judgment unit operable to judge whether or not a level of match between the plurality of pieces of tag verification information and the plurality of pieces of tag certification information satisfies a predetermined condition; and
a permission unit operable to permit a use of the function if the tag judgment unit judges that the level of match satisfies the predetermined condition, and
each of the plurality of wireless IC tags comprising:
a tag certification information storage unit operable to store a piece of tag certification information for identifying a wireless IC tag storing the piece of tag certification information; and
an output unit operable to output wirelessly the piece of tag certification information.

2. An authentication apparatus which permits a user to use a function provided by the authentication apparatus if authenticity of the user is certified by authentication, the authentication apparatus comprising:
a tag verification information storage unit operable to store a plurality of pieces of tag verification information for identifying a plurality of wireless IC tags respectively;
a receiving unit operable to wirelessly receive, from wireless IC tags attached to objects carried by the user, a plurality of pieces of tag certification information for identifying the wireless IC tags attached to the objects respectively;
a tag judgment unit operable to judge whether or not a level of match between the plurality of pieces of tag verification information and the plurality of pieces of tag certification information satisfies a predetermined condition; and
a permission unit operable to permit a use of the function if the tag judgment unit judges that the level of match satisfies the predetermined condition.

3. The authentication apparatus of claim 2 further comprising:
an identification information storage unit operable to store first identification information; and
a user judgment unit operable to, if the tag judgment unit judges that the level of match does not satisfy the predetermined condition, receive second identification information and judge whether or not the first identification information matches the received second identification information, wherein
the permission unit permits the use of the function if the tag judgment unit judges that the level of match does not satisfy the predetermined condition, and if the user judgment unit judges that the first identification information matches the received second identification information.

4. The authentication apparatus of claim 3, wherein
the first identification information is either (i) first character information being a combination of one or more numerals and/or one or more alphabets and/or one or more signs or (ii) first biological information indicating biological characteristics of the user,
the second identification information is either (i) second character information being a combination of one or more numerals and/or one or more alphabets and/or one or more signs or (ii) second biological information indicating biological characteristics of the user,
if the user judgment unit receives the second character information, the user judgment unit judges whether or not the first character information matches the received second character information, and if the user judgment unit receives the second biological information, the user judgment unit judges whether or not the first biological information and the received second biological information correspond to a same user.

5. The authentication apparatus of claim 2, wherein
the plurality of pieces of tag verification information are a plurality of verification ID codes for identifying the plurality of wireless IC tags respectively,
the plurality of pieces of tag certification information are a plurality of certification ID codes for identifying the wireless IC tags attached to the objects respectively, and
the authentication apparatus further comprises
an update unit operable to, if a predetermined condition for update is satisfied, acquire at least two certification ID codes out of the plurality of certification ID codes received by the receiving unit, and update contents of the tag verification information storage unit by storing the at least two acquired certification ID codes into the tag verification information storage unit as verification ID codes.

6. The authentication apparatus of claim 5 further comprising:
an identification information storage unit operable to store first identification information; and
a user judgment unit operable to receive second identification information and judge whether or not the first identification information matches the received second identification information, wherein
the predetermined condition for update is that the first identification information matches the second identification information, and
the update unit updates the contents of the tag verification information storage unit if the first identification information matches the second identification information.

7. The authentication apparatus of claim 5 further comprising:
a distance calculating unit operable to calculate values of a distance between the authentication apparatus and each of the wireless IC tags from which the plurality of certification ID codes have been received, wherein
the update unit acquires at least two certification ID codes for which calculated values of the distance are each equal to or lower than a predetermined value, from the plurality of received certification ID codes.

8. The authentication apparatus of claim 5, wherein
each of the plurality of certification ID codes contains a type code indicating a type of an object to which a wireless IC tag identified by the certification ID code is attached, wherein
the update unit acquires at least two certification ID codes containing a predetermined type code, from the plurality of certification ID codes received by the receiving unit.

9. The authentication apparatus of claim 8 further comprising:
a priority level storage unit operable to store a plurality of priority levels with a plurality of type codes corresponding thereto, wherein
the predetermined type code is correlated with priority levels that are equal to or higher than a priority-level threshold value, and
the update unit acquires at least two certification ID codes that have priority levels that are equal to or higher than the priority-level threshold value, from the plurality of certification ID codes received by the receiving unit, and updates contents of the tag verification information storage unit by storing the at least two acquired certification ID codes into the tag verification information storage unit as verification ID codes by priority.

10. The authentication apparatus of claim 9 further comprising:
a priority level update unit operable to receive a type code and a priority level, and update the priority level storage unit by replacing a priority level, which is stored in the priority level storage unit in correspondence with the received type code, with the received priority level.

11. The authentication apparatus of claim 8 further comprising:
a point storage unit operable to store a plurality of point values with a plurality of type codes corresponding thereto, wherein
the predetermined type codes are correlated with point values that are equal to or higher than a point-value threshold value, and
the update unit acquires at least two certification ID codes that have point values that are equal to or higher than the point-value threshold value, from the plurality of certification ID codes received by the receiving unit, and updates contents of the tag verification information storage unit by storing the at least two acquired certification ID codes into the tag verification information storage unit as verification ID codes by priority.

12. The authentication apparatus of claim 11 further comprising:
a point update unit operable to receive a type code and a point value, and update the point storage unit by replacing a point value, which is stored in the point storage unit in correspondence with the received type code, with the received point value.

13. The authentication apparatus of claim 2, wherein
the plurality of pieces of tag verification information are a plurality of pieces of unique authentication data for verification assigned by the authentication apparatus,
the plurality of pieces of tag certification information are a plurality of pieces of unique authentication data for certification assigned by the authentication apparatus,
the receiving unit wirelessly receives, from the wireless IC tags attached to the objects, a plurality of ID codes for identifying the wireless IC tags attached to the objects respectively;
the authentication apparatus further comprises:
an update unit operable to, if a predetermined condition for update is satisfied, generate a different piece of authentication data for each ID code received by the receiving unit, acquire at least two pieces of authentication data from pieces of generated authentication data, and update contents of the tag verification information storage unit by storing the at least two pieces of acquired authentication data into the tag verification information storage unit as authentication data for verification; and
a transmission unit operable to transmit, for each piece of authentication data for verification having been updated by the update unit, a piece of authentication data for verification as a piece of authentication data for certification, to a wireless IC tag having an ID code corresponding to the piece of authentication data for verification.

14. The authentication apparatus of claim 13 further comprising:
an identification information storage unit operable to store first identification information; and
a user judgment unit operable to receive second identification information and judge whether or not the first identification information matches the received second identification information, wherein
the predetermined condition for update is that the first identification information matches the second identification information, and
if the first identification information matches the second identification information,
the update unit updates the contents of the tag verification information storage unit, and
the transmission unit transmits, for each piece of authentication data for verification having been updated by the update unit, a piece of authentication data for verification as a piece of authentication data for certification, to a wireless IC tag having an ID code corresponding to the piece of authentication data for verification.

15. The authentication apparatus of claim 13 further comprising:
a distance calculating unit operable to calculate values of a distance between the authentication apparatus and each of the wireless IC tags from which the plurality of ID codes have been received, wherein
the update unit acquires at least two pieces of authentication data corresponding to ID codes for which calculated values of the distance are each equal to or lower than a predetermined value, among the plurality of received ID codes.

16. The authentication apparatus of claim 13, wherein
each of the plurality of ID codes contains a type code indicating a type of an object to which a wireless IC tag identified by the ID code is attached, wherein
the update unit acquires at least two pieces of authentication data corresponding to ID codes that include a predetermined type code among the plurality of ID codes received by the receiving unit.

17. The authentication apparatus of claim 2, wherein
each of the plurality of pieces of tag certification information contains a type code indicating a type of an object to which a wireless IC tag identified by the piece of tag certification information is attached, wherein
the tag judgment unit judges whether or not a level of match between the plurality of pieces of tag verification information and one or more pieces of tag certification information, which remain after excluding, from the plurality of pieces of tag certification information received by the receiving unit, pieces of tag certification information that contain a predetermined type code, satisfies a predetermined condition.

18. The authentication apparatus of claim 2, wherein
the tag verification information storage unit further stores expiration date/time information that indicates an expiration date/time of each piece of tag verification information, and
the authentication apparatus further comprises
a control unit operable to, if having judged that any expiration date/time of the plurality of pieces of tag verification information has not been reached, control the receiving unit to receive the plurality of pieces of tag certification information.

19. The authentication apparatus of claim 2, wherein
the tag judgment unit judges whether or not a ratio of (i) a number of pieces of tag verification information that, among the plurality of pieces of tag verification information, match any of the plurality of pieces of tag certification information to (ii) a total number of the plurality of pieces of tag verification information stored in the tag verification information storage unit is equal to or higher than a standard value.

20. The authentication apparatus of claim 2, wherein
the tag verification information storage unit further stores point values indicating weights assigned to the plurality of pieces of tag verification information, in correspondence with the plurality of pieces of tag verification information, and
the tag judgment unit judges whether or not a ratio of (i) an acquired point value that is obtained by adding up point values corresponding to pieces of tag verification information that, among the plurality of pieces of tag verification information, match any of the plurality of pieces of tag certification information to (ii) a total point value that is obtained by adding up point values corresponding to the plurality of pieces of tag verification information stored in the tag verification information storage unit is equal to or higher than a standard value.

21. The authentication apparatus of claim 2, wherein
the tag verification information storage unit is a portable recording medium, and
the portable recording medium is inserted in the authentication apparatus.

22. An authentication method for an authentication apparatus which permits a user to use a function provided by the authentication apparatus if authenticity of the user is certified by authentication,
the authentication apparatus comprising:
a tag verification information storage unit operable to store a plurality of pieces of tag verification information for identifying a plurality of wireless IC tags respectively, and
the authentication method comprising the steps of:
wirelessly receiving, from wireless IC tags attached to objects carried by the user, a plurality of pieces of tag certification information for identifying the wireless IC tags attached to the objects respectively;
judging whether or not a level of match between the plurality of pieces of tag verification information and the plurality of pieces of tag certification information satisfies a predetermined condition; and
permitting a use of the function if it is judged in the above step that the level of match satisfies the predetermined condition.

23. An authentication program for an authentication apparatus which permits a user to use a function provided by the authentication apparatus if authenticity of the user is certified by authentication,
the authentication apparatus comprising:
a tag verification information storage unit operable to store a plurality of pieces of tag verification information for identifying a plurality of wireless IC tags respectively, and
the authentication program comprising the steps of:
wirelessly receiving, from wireless IC tags attached to objects carried by the user, a plurality of pieces of tag certification information for identifying the wireless IC tags attached to the objects respectively;
judging whether or not a level of match between the plurality of pieces of tag verification information and the plurality of pieces of tag certification information satisfies a predetermined condition; and
permitting a use of the function if it is judged in the above step that the level of match satisfies the predetermined condition.

24. A computer-readable recording medium recording therein an authentication program that causes a computer to operate as an authentication apparatus which permits a user to use a function provided by the authentication apparatus if authenticity of the user is certified by authentication,
the authentication apparatus comprising:
a tag verification information storage unit operable to store a plurality of pieces of tag verification information for identifying a plurality of wireless IC tags respectively, and
the authentication program comprising the steps of:
wirelessly receiving, from wireless IC tags attached to objects carried by the user, a plurality of pieces of tag certification information for identifying the wireless IC tags attached to the objects respectively;
judging whether or not a level of match between the plurality of pieces of tag verification information and the plurality of pieces of tag certification information satisfies a predetermined condition; and
permitting a use of the function if it is judged in the above step that the level of match satisfies the predetermined condition.
